(19) United States
(12) Patent Application Publication
(10) Pub. No.: US 2013/0154250 A1
(43) Pub. Date: Jun. 20, 2013

(54) PERSONALIZED SECURITY ARTICLE AND METHODS OF AUTHENTICATING A SECURITY ARTICLE AND VERIFYING A BEARER OF A SECURITY ARTICLE

(71) Applicant: 3M INNOVATIVE PROPERTIES COMPANY, ST. PAUL, MN (US)

(72) Inventors: Douglas S. Dunn, Maplewood, MN (US); Travis L. Potts, Woodbury, MN (US); Christopher K. Haas, St. Paul, MN (US)

(73) Assignee: 3M INNOVATIVE PROPERTIES COMPANY, ST. PAUL, MN (US)

(21) Appl. No.: 13/713,808

(22) Filed: Dec. 13, 2012

Related U.S. Application Data
(60) Provisional application No. 61/576,335, filed on Dec. 15, 2011.

(51) Int. Cl. B42D 15/00

(52) U.S. Cl. CPC B42D 15/00
USPC 283/67; 283/85

(57) ABSTRACT

Security articles and methods of personalizing security articles. Specifically, this disclosure relates to security articles that contain a security feature that is a composite image, where the composite image includes laser-personalized security information.

### CROSS-REFERENCE TO RELATED APPLICATIONS

This application claims priority to U.S. Patent Application Ser. No. 61/576,335, filed Dec. 15, 2011, the entire contents of which is incorporated herein by reference in its entirety.

### TECHNICAL FIELD

The present disclosure relates generally to the field of security articles and methods of personalizing security articles. Specifically, this disclosure relates to security articles that contain a security feature that is a composite image, where the composite image includes laser-personalized security information.

### BACKGROUND OF THE INVENTION

Sheeting materials having a graphic image or other mark have been widely used, particularly as labels for authenticating an article or document. For example, sheetings such as those described in U.S. Pat. Nos. 3,154,872; 3,801,183; 4,082,426; and 4,099,838 have been used as validation stickers for vehicle license plates, and as security films for driver's licenses, government documents, tape cassettes, playing cards, beverage containers, and the like. Other uses include graphics applications for identification purposes such as on police, fire or other emergency vehicles, in advertising and promotional displays and as distinctive labels to provide brand enhancement.

Another form of imaged sheeting is disclosed in U.S. Pat. No. 4,200,875 (Galanos). Galanos discloses the use of a particularly “high-gain retroreflective sheeting of the exposed-lens type,” in which images are formed by laser irradiation of the sheeting through a mask or pattern. That sheeting comprises a plurality of transparent glass microspheres partially embedded in a binder layer and partially exposed above the binder layer, with a metal reflective layer coated on the embedded surface of each of the plurality of microspheres. The binder layer contains carbon black, which is said to minimize any stray light that impinges on the sheeting while it is being imaged. The energy of the laser beam is further concentrated by the focusing effect of the microlenses embedded in the binder layer.

The images formed in the retroreflective sheeting of Galanos can be viewed if, and only if, the sheeting is viewed from the same angle at which the laser irradiation was directed at the sheeting. That means, in different terms, that the image is only viewable over a very limited observation angle. For that and other reasons, there has been a desire to improve certain properties of such a sheeting.

As early as 1908, Gabriel Lippman invented a method for producing a true three-dimensional image of a scene in lenticular media having one or more photosensitive layers. That process, known as integral photography, is also described in De Montebello, “Processing and Display of Three-Dimensional Data II” in Proceedings of SPIE, San Diego, 1984. In Lippman's method, a photographic plate is exposed through an array of lenses (or “lenslets”), so that each lenslet of the array transmits a miniature image of the scene being reproduced, as seen from the perspective of the point of the sheet occupied by that lenslet, to the photosensitive layers on a photographic plate. After the photographic plate has been developed, an observer looking at the composite image on the plate through the lenslet array sees a three-dimensional representation of the scene photographed. The image may be in black and white or in color, depending on the photosensitive materials used.

Because the image formed by the lenslets during exposure of the plate has undergone only a single inversion of each miniature image, the three-dimensional representation produced is pseudoscopic. That is, the perceived depth of the image is inverted so that the object appears “inside out.” This is a major disadvantage, because to correct the image it is necessary to achieve a second optical inversion. These methods are complex, involving multiple exposures with a single camera, or multiple cameras, or multi-lens cameras, to record a plurality of views of the same object, and require extremely accurate registration of multiple images to provide a single three-dimensional image. Further, any method that relies on a conventional camera requires the presence of a real object before the camera. This further renders that method ill-adapted for producing three-dimensional images of a virtual object (meaning an object that exists in effect, but not in fact). A further disadvantage of integral photography is that the composite image must be illuminated from the viewing side to form a real image that may be viewed.

Another form of imaged sheeting is disclosed in U.S. Pat. No. 6,288,842 (Florczak et al.). Florczak et al. discloses microlens sheeting with composite images, in which the composite image floats above or below the sheeting, or both. The composite image may be two-dimensional or three-dimensional. Methods for providing such sheeting, including by the application of radiation to a radiation sensitive material layer adjacent the microlenses, are also disclosed.

Another form of imaged sheeting is also disclosed in U.S. Pat. No. 7,981,499 (Endle et al.) Endle et al. discloses microlens sheetings with composite images, in which the composite image floats above or below the sheeting, or both. The composite image may be two-dimensional or three-dimensional. Methods for providing such an imaged sheeting are also disclosed.

U.S. Pat. No. 5,712,731, “Security Device for Security Documents Such as Bank Notes and Credit Cards,” (Drinkwater et. al.) discloses a security device that includes an array of microimages which, when viewed through a corresponding array of substantially spherical microlenses, generates a magnified image. In some cases, the array of microlenses is bonded to the array of microimages. Other examples of security devices are disclosed in U.S. Patent Publication No. 2009/0034082 A1 (Commander et. al); U.S. Patent Publication No 2007/0177131 A1 (Hansen); U.S. Patent Publication 2009/0122412 A1. (Steenblik et. al); and U.S. Pat. No. 4,765,656 (Becker et al.).

Drinkwater et al., Commander et al., and Hansen each describe imaging processes for security applications, based on “Moiré magnification,” using either high-resolution printing or embossing to produce a microimage array behind a lenslet array. This basic concept has also been demonstrated by Steenblik, et al. to produce images for overt security applications that appear to float above or below a substrate containing a lens array. This technology has been incorporated as an overt security feature into currency by the central banks of such countries as Mexico, Sweden, Denmark, and Paraguay. However, there are certain disadvantages affiliated with images formed with Moiré magnification. Since the images formed with these Moiré magnification-based methods are the result of a projection of an array of identical microimages, they tend to float or sink in only one plane relative to the lens-containing substrate and do not exhibit full motion parallax. They are also typically limited in spatial extent to areas only a few millimeters on a side, as determined by the relative pitch mismatch between the microimage array and the lens array.

PCT Patent Application Publication, WO 03/061983 A1, “Micro-Optics For Article Identification” discloses methods and compositions for identification and counterfeit deterrence using non-holographic micro-optics and microstructures having a surface relief greater than a few microns.

One example of a commercially available security laminate is the 3M™ Confirm™ Security Laminate with Floating Images, which is sold by 3M Company based in St. Paul, Minn.

### SUMMARY OF THE INVENTION

One aspect of the present invention provides a personalized security article. In one embodiment, the personalized security article comprises: a sheeting comprising: at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material; a first indicia; a second indicia; a first composite image, provided by at least one of the individual images, that appears to the unaided eye to float above, below, or in the sheeting, or any combination thereof; and a second composite image, provided by at least one of the individual images, that appears to the unaided eye to float above, below, or in the sheeting, or any combination thereof; wherein the first composite image is viewable at a first angle, and wherein the first composite image is related to the first printed indicia; and wherein the second composite image is viewable at a second angle, and wherein the second composite image is related to the second printed indicia.

Another aspect of the present invention provides an alternative personalized security article. In this embodiment, the personalized security article comprises: a sheeting comprising: at least a partial array of microlenses and a material layer adjacent the partial array of microlenses; a first donor material in contact with the material layer, wherein the donor material forms individual, partially complete images on the material layer associated with each of a plurality of the microlenses, a first printed indicia; a second printed indicia; a first composite image, provided by (at least one of) the individual images, that appears to the unaided eye to float above, below, or in the sheeting, or any combination thereof; and a second composite image, provided by the individual images, that appears to the unaided eye to float above or below the sheeting, or both, wherein the first composite image is viewable at a first angle and is related to the first printed indicia; and wherein the second composite image is viewable at a second angle and is related to the second printed indicia.

The above summary of the present invention is not intended to describe each disclosed embodiment or every implementation of the present invention. The Figures and the detail description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1 is an enlarged cross sectional view of an “exposed lens” microlens sheeting;

FIG. 2 is an enlarged cross sectional view of an “embedded lens” microlens sheeting;

FIG. 3 is an enlarged cross sectional view of a microlens sheeting comprising a plano-convex base sheet;

FIG. 4 is a graphical representation of divergent energy impinging on a microlens sheeting constructed of microspheres;

FIG. 5 is a plan view of a section of a microlens sheeting depicting sample images recorded in the material layer associated with individual microlenses made by the method of the present invention, and further showing that the recorded images range from complete replication to partial replication of the composite image;

FIG. 6 is a top view of a passport including composite images that appear to float above and appear to float below the sheeting;

FIG. 7 is a photomicrograph of a passport including composite images that appear to float above and appear to float below the sheeting;

FIG. 8 is a geometrical optical representation of the formation of a composite image that appears to float above the microlens sheeting;

FIG. 9 is a schematic representation of a sheeting having a composite image that appears to float above the inventive sheeting when the sheeting is viewed in reflected light;

FIG. 10 is a schematic representation of a sheeting having a composite image that appears to float above the inventive sheeting when the sheeting is viewed in transmitted light;

FIG. 11 is a geometrical optical representation of the formation of a composite image that when viewed will appear to float below the microlens sheeting;

FIG. 12 is a schematic representation of a sheeting having a composite image that appears to float below the inventive sheeting when the sheeting is viewed in reflected light;

FIG. 13 is a schematic representation of a sheeting having a composite image that appears to float below the inventive sheeting when the sheeting is viewed in transmitted light;

FIG. 14 is a depiction of an optical train for creating the divergent energy used to form the composite images of this invention;

FIG. 15 is a depiction of a second optical train for creating the divergent energy used to form the composite images of this invention;

FIG. 16 is a depiction of a third optical train for creating the divergent energy used to form the composite images of this invention;

FIG. 17 is an enlarged cross sectional view of an example sheeting that contains a single layer of microlenses;

FIG. 18 is an enlarged cross sectional view of an example sheeting having an array of microlenses on a first side and a retroreflective portion on a second side;

FIG. 19a is a schematic representation of an example sheeting having microlens arrays on both sides of the sheeting, and a composite image that appears to an observer on either side of the sheeting to float above the inventive sheeting;

FIG. 19b is a schematic representation of an example sheeting comprising a first microlens layer, a second microlens layer, and a layer of material disposed between the first and second microlens layers;

FIG. 20 illustrates one embodiment of a sheeting;

FIGS. 21a and 21b illustrate schematic representation of methods useful for creating composite images;

FIG. 22 is an enlarged cross sectional view of a microlens sheeting comprising a plano-convex base sheet;

FIG. 23 is an enlarged cross sectional view of an “exposed lens” microlens sheeting;

FIG. 24 is an enlarged cross sectional view of an “embedded lens” microlens sheeting;

FIGS. 25a and 25b schematically illustrate one embodiment of the method in accordance with the present invention using a first donor sheet;

FIGS. 26a and 26b schematically illustrate another embodiment of the method illustrated in FIG. 25, except using a second donor sheet;

FIG. 27 schematically illustrates an apparatus for use with another embodiment of the methods illustrated in FIGS. 25a, 25b, 26a and 26b;

FIG. 28 is a photograph of a portion of microlens sheeting illustrating at least two composite images that appear to float above or below the sheeting in accordance with the present invention;

FIG. 29 is a photomicrograph of a portion of the backside of the microlens sheeting of FIG. 29 that has been imaged by one embodiment of the method in accordance with the present invention, illustrating individual, partially complete images; which viewed together through the microlenses provide a composite image that appears to float above or below the sheeting in accordance with the present invention;

FIG. 30 is a geometrical optical representation of the formation of a composite image that appears to float above the microlens sheeting;

FIG. 31 is a schematic representation of a sheeting having a composite image that appears to float above the inventive sheeting when the sheeting is viewed in reflected light;

FIG. 32 is a schematic representation of a sheeting having a composite image that appears to float above the inventive sheeting when the sheeting is viewed in transmitted light;

FIG. 33 is a geometrical optical representation of the formation of a composite image that when viewed will appear to float below the microlens sheeting;

FIG. 34 is a schematic representation of a sheeting having a composite image that appears to float below the inventive sheeting when the sheeting is viewed in reflected light;

FIG. 35 is a schematic representation of a sheeting having a composite image that appears to float below the inventive sheeting when the sheeting is viewed in transmitted light; and

FIG. 36 illustrates one embodiment of the sheeting of the present invention attached to a substrate.

FIGS. 37a and 37b illustrate methods of laser engraving and laser imaging the security article of the present invention;

FIGS. 38a and 38b illustrate schematic views of laser engraving and laser imaging the security article of the present invention;

FIG. 39 is a photograph of one example of a floating composite image which appears to the unaided eye to be in the shape of a three-dimensional cube;

FIG. 39a illustrates the direction and approximate location of the microlens sheeting, as it moved horizontally under a microscope to produce micrographs illustrated in FIG. 40a-40d;

FIGS. 40a-40d are optical micrographs of the microlens sheeting including the composite image illustrated in FIG. 39;

FIG. 41 illustrates a top view of one embodiment of the security article of the present invention;

FIG. 42 illustrates a cross-section of the security article of FIG. 41 taken along line 42-42;

FIG. 43 illustrates a schematic side view of the security article of the present invention;

FIG. 44 illustrates a schematic side view of the security article of the present invention;

FIGS. 45a-45c illustrates a first portion of the security article of the present invention tilted at a first, second and third angle, respectively;

FIG. 46 illustrates a cross sectional view of one embodiment of security article of the present invention;

FIGS. 47-50 illustrate varying magnified views of the security article of the present invention; and

FIGS. 51-54 illustrate varying magnified views of a prior art security article.

### DETAILED DESCRIPTION OF THE INVENTION

The present invention provides a personalized security article including at least an indicia and a composite image. Such indicia and composite image, when used together, provide useful ways, described in more detail below, to authenticate the security article as a genuine security article, for example, coming from an authorized source and is not a forgery or a fake. The indicia and composite image may also be used to verify or corroborate that the bearer of the security article of the present invention is indeed the lawful owner of the security article and/or that the bearer is who they purport to be as described in more detail below.

The sheeting of the security article of the present invention and the methods of imaging the same provides a) a composite image, provided by individual partially complete images and/or individual complete images associated with a number of microlenses over at least a portion of the sheeting having microlenses, that appears to be suspended, or to float above, in the plane of, or below the sheeting, or any combination thereof, and b) an laser engraved personalized image in at least a portion of the sheeting without microlenses. The suspended composite images are referred to for convenience as floating images, and they can be located above or below the sheeting (either as two or three-dimensional images), or can be a three-dimensional image that appears above, in the plane of, and below the sheeting. The composite images can be in black or in grey scale or in color, and can appear to move as the viewing angle of the image is varied. Unlike some holographic sheetings, imaged sheeting of the present invention cannot be used to create a replica of itself. Additionally, the floating image(s) can be observed by a viewer with the unaided eye.

The composite images may be personalized composite images. The term “personalized” as used herein, including the claims, means that a composite image includes information that is personal, that is, pertaining to, or coming as from a particular person or individual. For example, there are at least two different broad categories of personal information. One category is often referred to as “biographical information.” Biographical information may include, for example, a person's name, address, social security number, date of birth, or ID number. Another category is often referred to as “biometric information.” Biometric information includes any physiological or behavioral trait that is universal, distinctive, permanent, and collectible. Physiological biometric traits are typically related to the shape of the body, and include but are not limited to: fingerprint, face, DNA, palm print, hand geometry, iris recognition. For example, biometric information may include color of eyes, weight, hair color, or other data attributed to a physiological biometric trait.

If a security article includes a personalized composite image, it makes it more difficult to copy or alter the security article. Security articles are becoming increasingly important. Examples of security articles include identification documents and value documents. The term identification documents is broadly defined and is intended to include, but not be limited to, for example, passports, driver's licenses, national ID cards, social security cards, voter registration and/or identification cards, birth certificates, police ID cards, border crossing cards, security clearance badges, security cards, visas, immigration documentation and cards, gun permits, membership cards, and employee badges. The security articles of this disclosure may be the identification document or may be part of the identification document. Other security articles may be described as value documents, and typically include items of value, such as, for example, currency, bank notes, checks, phone cards, stored value cards, debit cards, credit cards, gift certificates and cards, and stock certificates, where authenticity of the item is important to protect against counterfeiting or fraud.

Some of the desirable features for security articles of this invention are ready authentication and resistance to simulating, altering, copying, counterfeiting and tampering. Ready authentication can be achieved through the use of indicia that are readily apparent and checked, and yet is difficult to copy or falsify. Examples of such indicia include, for example floating images in sheeting where the image appears to be above, below, or in the plane of the sheeting, or some combination thereof. Such images are difficult to counterfeit, simulate or copy, because the image is not readily reproduced by straightforward methods such as photocopying or photography. Examples of such images include, for example, three dimensional floating images present in some state driver's licenses where a series of three dimensional floating images representing the state name or other logo are present across the license card to verify that the card is an official license and not a counterfeit. Such three dimensional floating images are readily seen and verified.

The sheeting's composite image as described may be used in a variety of applications such as securing tamperproof images in passports, ID badges, event passes, affinity cards, product identification formats, currency, and advertising promotions for verification and authenticity, brand enhancement images which provide a floating or sinking or a floating and sinking image of the brand, identification presentation images in graphics applications such as emblems for police, fire or other emergency vehicles; information presentation images in graphics applications such as kiosks, night signs and automotive dashboard displays; and novelty enhancement through the use of composite images on products such as business cards, hang-tags, art, shoes and bottled products.

As tampering and counterfeiting of identification documents, such as passports, driver's licenses, identification cards and badges, and value documents, such as bonds, certificates, and negotiable instruments, increase, there is a need for greater security features and measures. The security article of the present invention provides enhanced security features and measures.

The personalized security article of the present invention having both personalized laser engraved floating composite images and laser engraved personalized images provides enhanced authentification and verification abilities, as well as enhanced resistance to simulating, altering, copying, counterfeiting or tampering. The information engraved into the article in the form of composite floating images or laser engraved indicia or images can be personal to the bearer thereof. The security article of this invention also may be created at the point of issuance to the bearer of the security article which enhances security. The personalized laser engraved composite floating images and personalized laser engraved images can be related, correlate, or be similar to each other, and in fact, the personalized information presented by each type of image, can be the same. All of these qualities provide unique security capabilities in a security article.

To provide a complete description of the security articles of the present invention, methods of creating composite images are provided in Sections I and II. Section III provides exemplary methods of laser-engraving and laser imaging a security article. Section IV provides a detailed review of the characteristics of a composite floating image. Section V provides an overview of security articles of the present invention having both personalized indicia and personalized composite floating images, and the benefits thereof. Section VI provides a comparison of the security feature of composite floating images of the present invention to a security feature commonly referred to as “MLI/CLI.”

### I. Methods of Creating Composite Images

To provide a complete description of exemplary methods of creating composite images, microlens sheetings will be described in Part A below, followed by descriptions of the material layers (preferably radiation sensitive material layers) of such sheetings in Part B, radiation sources in Part C, and the imaging process in Part D.

### A. Microlens Sheeting

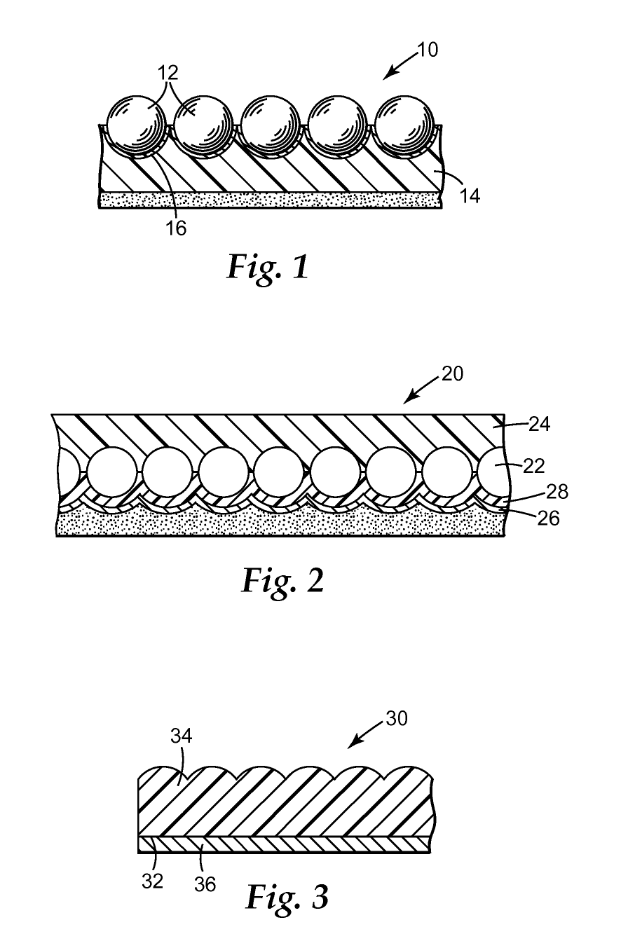

Microlens sheeting in which the images of this invention can be formed comprise one or more discrete layers of microlenses with a layer of material (preferably a radiation-sensitive material or coating, as described below) disposed adjacent to one side of the microlens layer or layers. For example, FIG. 1 shows an “exposed lens” type of microlens sheeting 10 that includes a monolayer of transparent microspheres 12 that are partially embedded in a binder layer 14, which is typically a polymeric material. The microspheres are transparent both to the wavelengths of radiation that may be used to image the layer of material, as well as to the wavelengths of light in which the composite image will be viewed. The layer of material 16 is disposed at the rear surface of each microsphere, and in the illustrated embodiment typically contacts only a portion of the surface of each of the microspheres 12. This type of sheeting is described in greater detail in U.S. Pat. No. 2,326,634 and is presently available from 3M under the designation Scotchlite 8910 series reflective fabric.

FIG. 2 shows another suitable type of microlens sheeting. This microlens sheeting 20 is an “embedded-lens” type of sheeting in which the microsphere lenses 22 are embedded in a transparent protective overcoat 24, which is typically a polymeric material. The layer of material 26 is disposed behind the microspheres at the back of a transparent spacer layer 28, which is also typically a polymeric material. This type of sheeting is described in greater detail in U.S. Pat. No. 3,801,183, and is presently available from 3M under the designation Scotchlite 3290 series Engineer grade retroreflective sheeting. Another suitable type of microlens sheeting is referred to as encapsulated lens sheeting, an example of which is described in U.S. Pat. No. 5,064,272, and presently is available from 3M under the designation Scotchlite 3870 series High Intensity grade retroreflective sheeting.

FIG. 3 shows yet another suitable type of microlens sheeting. This sheeting comprises a transparent plano-convex or aspheric base sheet 30 having first and second broad faces, the second face 32 being substantially planer and the first face having an array of substantially hemi-spheroidal or hemi-aspheroidal microlenses 34. The shape of the microlenses and thickness of the base sheet are selected such that collimated light incident to the array is focused approximately at the second face. The layer of material 36 is provided on the second face. Sheeting of this kind is described in, for example, U.S. Pat. No. 5,254,390, and is presently available from 3M under the designation 2600 series 3M Secure Card receptor.

The microlenses of the sheeting preferably have an image forming refractive surface in order for image formation to occur; generally this is provided by a curved microlens surface. For curved surfaces, the microlens will preferably have a uniform index of refraction. Other useful materials that provide a gradient refractive index (GRIN) will not necessarily need a curved surface to refract light. The microlens surfaces are preferably spherical in nature, but aspherical surfaces are also acceptable. The microlenses may have any symmetry, such as cylindrical or spherical, provided real images are formed by the refraction surfaces. The microlenses themselves can be of discrete form, such as round plano-convex lenslets, round double convex lenslets, rods, microspheres, beads, or cylindrical lenslets. Materials from which the microlenses can be formed include glass, polymers, minerals, crystals, semiconductors and combinations of these and other materials. Non-discrete microlens elements may also be used. Thus, microlenses formed from a replication or embossing process (where the surface of the sheeting is altered in shape to produce a repetitive profile with imaging characteristics) can also be used.

Microlenses with a uniform refractive index of between 1.5 and 3.0 over the visible and infrared wavelengths are most useful. Suitable microlens materials will have minimal absorption of visible light, and in embodiments in which an energy source is used to image a radiation-sensitive layer the materials should exhibit minimal absorption of the energy source as well. The refractive power of the microlens, whether the microlens is discrete or replicated, and regardless of the material from which the microlenses are made, is preferably such that the light incident upon the refracting surface will refract and focus on the opposite side of the microlens. More specifically, the light will be focused either on the back surface of the microlens or on the material adjacent to the microlens. In embodiments in which the material layer is radiation sensitive, the microlenses preferably form a demagnified real image at the appropriate position on that layer. Demagnification of the image by approximately 100 to 800 times is particularly useful for forming images that have good resolution. The construction of the microlens sheeting to provide the necessary focusing conditions so that energy incident upon the front surface of the microlens sheeting is focused upon a material layer that is preferably radiation sensitive is described in the U.S. patents referenced earlier in this section.

Microspheres with diameters ranging from 15 micrometers to 275 micrometers are preferable, though other sized microspheres may be used. Good composite image resolution can be obtained by using microspheres having diameters in the smaller end of the aforementioned range for composite images that are to appear to be spaced apart from the microsphere layer by a relatively short distance, and by using larger microspheres for composite images that are to appear to be spaced apart from the microsphere layer by larger distances. Other microlens, such as plano-convex, cylindrical, spherical or aspherical microlenses having lenslet dimensions comparable to those indicated for the microspheres, can be expected to produce similar optical results.

### B. Layer of Material

As noted above, a layer of material is provided adjacent to the microlenses. The layer of material may be highly reflective as in some of the microlens sheetings described above, or it may have low reflectivity. When the material is highly reflective, the sheeting may have the property of retroreflectivity as described in U.S. Pat. No. 2,326,634. Individual images formed in the material associated with a plurality of microlenses, when viewed by an observer under reflected or transmitted light, provide a composite image that appears to be suspended, or float, above, in the plane of, and/or below the sheeting. Although other methods may be used, the preferred method for providing such images is to provide a radiation sensitive material as the material layer, and to use radiation to alter that material in a desired manner to provide the image. Thus, although the invention is not limited thereby, the remaining discussion of the layer of material adjacent the microlenses will be provided largely in the context of a radiation sensitive material layer.

Radiation sensitive materials useful for this invention include coatings and films of metallic, polymeric and semiconducting materials as well as mixtures of these. As used in reference to the present invention, a material is “radiation sensitive” if upon exposure to a given level of visible or other radiation the appearance of the material exposed changes to provide a contrast with material that was not exposed to that radiation. The image created thereby could thus be the result of a compositional change, a removal or ablation of the material, a phase change, or a polymerization of the radiation sensitive coating. Examples of some radiation sensitive metallic film materials include aluminum, silver, copper, gold, titanium, zinc, tin, chromium, vanadium, tantalum, and alloys of these metals. These metals typically provide a contrast due to the difference between the native color of the metal and a modified color of the metal after exposure to the radiation. The image, as noted above, may also be provided by ablation, or by the radiation heating the material until an image is provided by optical modification of the material. U.S. Pat. No. 4,743,526, for example, describes heating a metal alloy to provide a color change.

In addition to metallic alloys, metallic oxides and metallic suboxides can be used as a radiation sensitive medium. Materials in this class include oxide compounds formed from aluminum, iron, copper, tin and chromium. Non-metallic materials such as zinc sulfide, zinc selenide, silicon dioxide, indium tin oxide, zinc oxide, magnesium fluoride and silicon can also provide a color or contrast that is useful for this invention.

Multiple layers of thin film materials can also be used to provide unique radiation sensitive materials. These multilayer materials can be configured to provide a contrast change by the appearance or removal of a color or contrast agent. Exemplary constructions include optical stacks or tuned cavities that are designed to be imaged (by a change in color, for example) by specific wavelengths of radiation. One specific example is described in U.S. Pat. No. 3,801,183, which discloses the use of cryolite/zinc sulphide (Na₃AlF₆/ZnS) as a dielectric mirror. Another example is an optical stack composed of chromium/polymer (such as plasma polymerized butadiene)/silicon dioxide/aluminum where the thickness of the layers are in the ranges of 4 nm for chromium, between 20 nm and 60 nm for the polymer, between 20 nm and 60 nm for the silicon dioxide, and between 80 nm and 100 nm for the aluminum, and where the individual layer thicknesses are selected to provide specific color reflectivity in the visible spectrum. Thin film tuned cavities could be used with any of the single layer thin films previously discussed. For example, a tuned cavity with an approximately 4 nm thick layer of chromium and the silicon dioxide layer of between about 100 nm and 300 nm, with the thickness of the silicon dioxide layer being adjusted to provide a colored imaged in response to specific wavelengths of radiation.

Radiation sensitive materials useful for this invention also include thermochromic materials. “Thermochromic” describes a material that changes color when exposed to a change in temperature. Examples of thermochromic materials useful in this invention are described in U.S. Pat. No. 4,424,990, and include copper carbonate, copper nitrate with thiourea, and copper carbonate with sulfur containing compounds such as thiols, thioethers, sulfoxides, and sulfones. Examples of other suitable thermochromic compounds are described in U.S. Pat. No. 4,121,011, including hydrated sulfates and nitrides of boron, aluminum, and bismuth, and the oxides and hydrated oxides of boron, iron, and phosphorus.

Naturally, if the material layer is not going to be imaged using a source of radiation, then the material layer can, but is not required to, be radiation sensitive. Radiation sensitive materials are preferred for ease of manufacturing, however, and thus a suitable radiation source is preferably also used.

### C. Radiation Sources

As noted above, a preferred manner of providing the image patterns on the layer of material adjacent the microlenses is to use a radiation source to image a radiation sensitive material. Any energy source providing radiation of the desired intensity and wavelength can be used with the method of the present invention. Devices capable of providing radiation having a wavelength of between 200 nm and 11 micrometers are believed to be particularly preferred. Examples of high peak power radiation sources useful for this invention include excimer flashlamps, passively Q-switched microchip lasers, and Q-switched Neodymium doped-yttrium aluminum garnet (abbreviated Nd:YAG), Neodymium doped-yttrium lithium fluoride (abbreviated Nd:YLF) and Titanium doped-sapphire (abbreviated Ti:sapphire) lasers. These high peak power sources are most useful with radiation sensitive materials that form images through ablation—the removal of material or in multiphoton absorption processes. Other examples of useful radiation sources include devices that give low peak power such as laser diodes, ion lasers, non Q-switched solid state lasers, metal vapor lasers, gas lasers, arc lamps and high power incandescent light sources. These sources are particularly useful when the radiation sensitive medium is imaged by a non-ablative method.

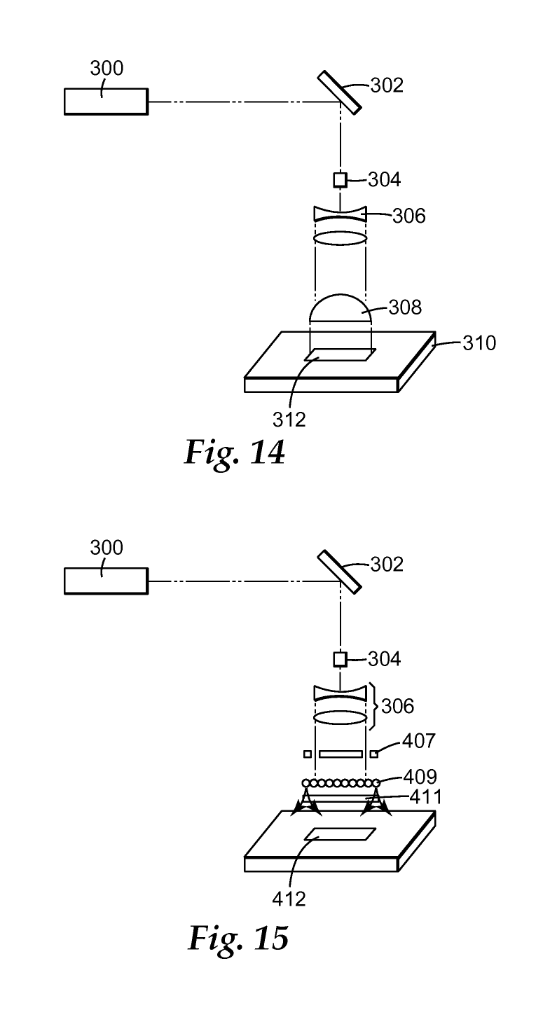

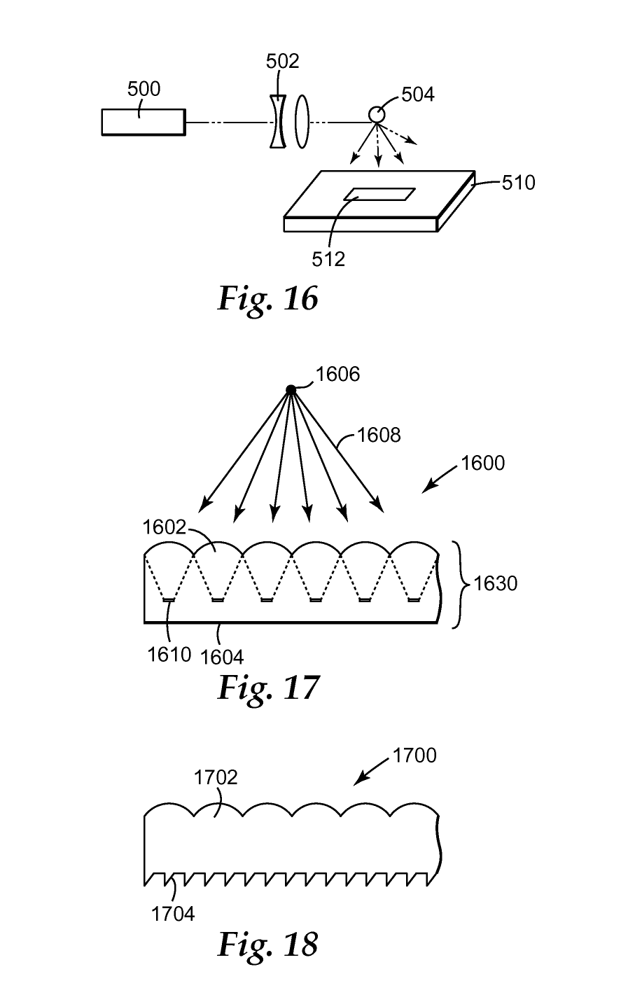

For all useful radiation sources, the energy from the radiation source is directed toward the microlens sheeting material and controlled to give a highly divergent beam of energy. For energy sources in the ultraviolet, visible, and infrared portions of the electromagnetic spectrum, the light is controlled by appropriate optical elements, examples of which are shown in FIGS. 14, 15, and 16 and described in greater detail below. In one embodiment, a requirement of this arrangement of optical elements, commonly referred to as an optical train, is that the optical train direct light toward the sheeting material with appropriate divergence or spread so as to irradiate the microlens and thus the material layer at the desired angles. The composite images of the present invention are preferably obtained by using light spreading devices with numerical apertures (defined as the sine of the half angle of the maximum diverging rays) of greater than or equal to 0.3. Light spreading devices with larger numerical apertures produce composite images having a greater viewing angle, and a greater range of apparent movement of the image.

### D. Imaging Processes

An exemplary imaging process according to this invention consists of directing collimated light from a laser through a lens toward the microlens sheeting. To create a sheeting having a floating image, as described further below, the light is transmitted through a diverging lens with a high numerical aperture (NA) to produce a cone of highly divergent light. A high NA lens is a lens with a NA equal to or greater than 0.3. The radiation sensitive coating side of the microspheres is positioned away from the lens, so that the axis of the cone of light (the optical axis) is perpendicular to the plane of the microlens sheeting.

Because each individual microlens occupies a unique position relative to the optical axis, the light impinging on each microlens will have a unique angle of incidence relative to the light incident on each other microlens. Thus, the light will be transmitted by each microlens to a unique position on the material layer, and produce a unique image. More precisely, a single light pulse produces only a single imaged dot on the material layer, so to provide an image adjacent each microlens, multiple pulses of light are used to create that image out of multiple imaged dots. For each pulse, the optical axis is located at a new position relative to the position of the optical axis during the previous pulse. These successive changes in the position of the optical axis relative to the microlenses results in a corresponding change in the angle of incidence upon each microlens, and accordingly in the position of the imaged dot created in the material layer by that pulse. As a result, the incident light focusing on the backside of the microsphere images a selected pattern in the radiation sensitive layer. Because the position of each microsphere is unique relative to every optical axis, the image formed in the radiation sensitive material for each microsphere will be different from the image associated with every other microsphere.

Another method for forming floating composite images uses a lens array to produce the highly divergent light to image the microlensed material. The lens array consists of multiple small lenses all with high numerical apertures arranged in a planar geometry. When the array is illuminated by a light source, the array will produce multiple cones of highly divergent light, each individual cone being centered upon its corresponding lens in the array. The physical dimensions of the array are chosen to accommodate the largest lateral size of a composite image. By virtue of the size of the array, the individual cones of energy formed by the lenslets will expose the microlensed material as if an individual lens was positioned sequentially at all points of the array while receiving pulses of light. The selection of which lenses receive the incident light occurs by the use of a reflective mask. This mask will have transparent areas corresponding to sections of the composite image that are to be exposed and reflective areas where the image should not be exposed. Due to the lateral extent of the lens array, it is not necessary to use multiple light pulses to trace out the image.

By having the mask fully illuminated by the incident energy, the portions of the mask that allow energy to pass through will form many individual cones of highly divergent light outlining the floating image as if the image was traced out by a single lens. As a result, only a single light pulse is needed to form the entire composite image in the microlens sheeting. Alternatively, in place of a reflective mask, a beam positioning system, such as a galvometric xy scanner, can be used to locally illuminate the lens array and trace the composite image on the array. Since the energy is spatially localized with this technique, only a few lenslets in the array are illuminated at any given time. Those lenslets that are illuminated will provide the cones of highly diverging light needed to expose the microlensed material to form the composite image in the sheetings.

The lens array itself can be fabricated from discrete lenslets or by an etching process to produce a monolithic array of lenses. Materials suitable for the lenses are those that are non-absorbing at the wavelength of the incident energy. The individual lenses in the array preferably have numerical apertures greater than 0.3 and diameters greater than 30 micrometers but less than 10 mm. These arrays may have antireflection coatings to reduce the effects of back reflections that may cause internal damage to the lens material. In addition, single lenses with an effective negative focal length and dimensions equivalent to the lens array may also be used to increase the divergence of the light leaving the array. Shapes of the individual lenslets in a monolithic array are chosen to have a high numerical aperture and provide a large fill factor of approximately greater than 60%.

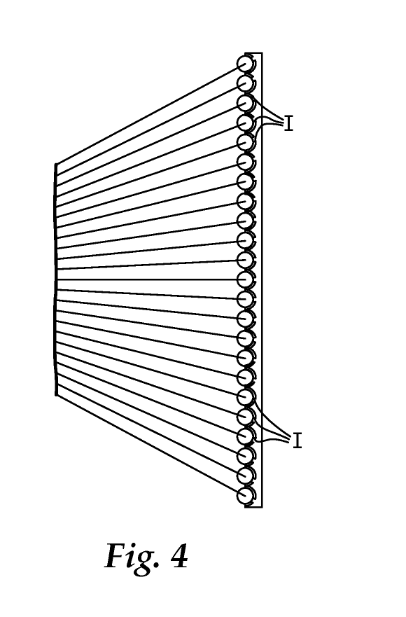

FIG. 4 is a graphical schematic representation of divergent energy impinging on a microlens sheeting. The portion of the material layer on or in which an image I is formed is different for each microlens, because each microlens “sees” the incoming energy from a different perspective. Thus, a unique image is formed in the material layer associated with each microlens.

After imaging, depending upon the size of the extended object, a full or partial image of the object will be present in the radiation sensitive material behind each microsphere. The extent to which the actual object is reproduced as an image behind a microsphere depends on the energy density incident upon the microsphere. Portions of an extended object may be distant enough from a region of microlenses that the energy incident upon those microspheres has an energy density lower than the level of radiation required to modify that material. Moreover, for a spatially extended image, when imaging with a fixed NA lens, not all portions of the sheeting will be exposed to the incident radiation for all parts of the extended object. As a result, those portions of the object will not be modified in the radiation sensitive medium and only a partial image of the object will appear behind the microspheres.

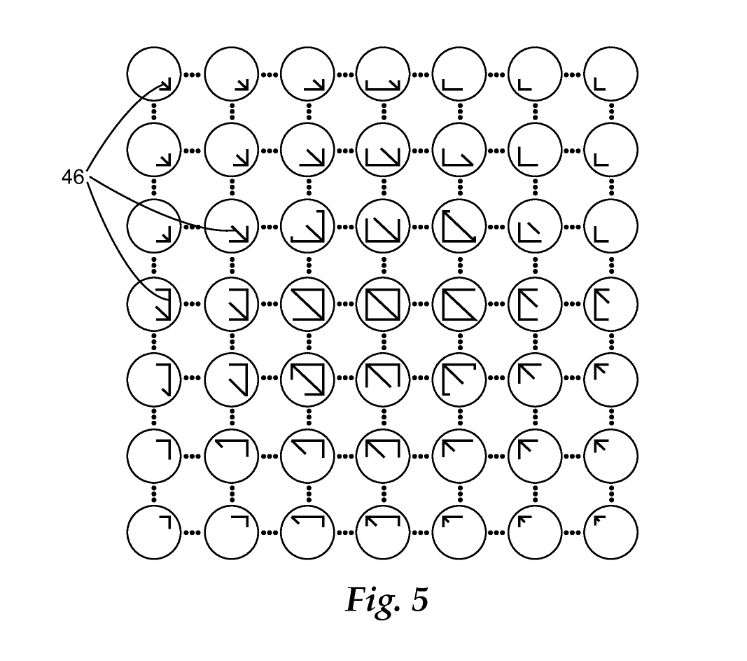

FIG. 5 is a perspective view of a section of a microlens sheeting 10 depicting sample individual, partially complete images 46 formed by on the material layer 14 adjacent to individual microsphere 4 as viewed from the microlensed side of the microlensed sheeting, and further showing that the recorded images range from complete replication to partial replication.

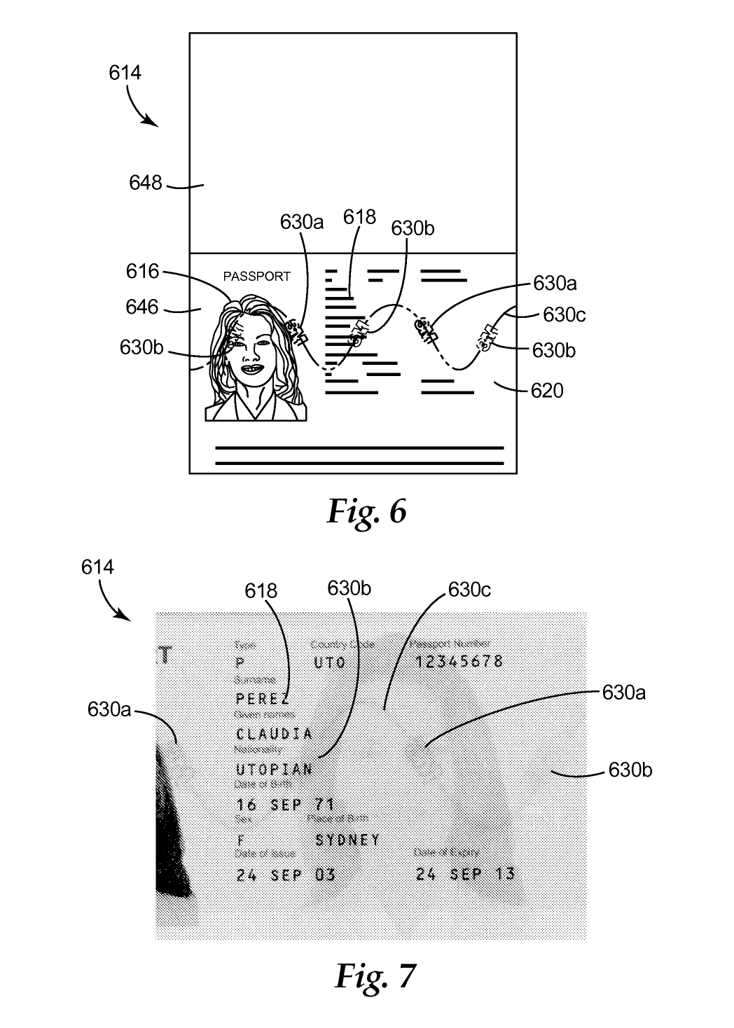

FIG. 6 illustrates one embodiment of a schematic document of value including a floating image. FIG. 7 is a photomicrograph of a close up view of a portion of an actual identification document including floating images. In this embodiment, the identification is a passport booklet 614. The passport 614 is typically a booklet filled with several bound pages. One of the pages usually includes personalized data 618, often presented as printed indicia or images, which can include photographs 616, signatures, personal alphanumeric information, and barcodes, and allows human or electronic verification that the person presenting the document for inspection is the person to whom the passport 614 is assigned. This same page of the passport may have a variety of covert and overt security features, such as those security features described in U.S. patent application Ser. No. 10/193,850, “Tamper-Indicating Printable Sheet for Securing Documents of Value and Methods of Making the Same, (U.S. Pat. No. 7,648,744) filed on Aug. 6, 2004 by the same assignee as the present application. In addition, this same page of the passport 14 includes a laminate of microlens sheeting 620 having composite images 630, which appear to the unaided eye to float either above or below the sheeting 620 or both. This feature is a security feature that is used to verify that the passport is an authentic passport and not a fake passport. One example of suitable microlens sheeting 620 is commercially available from 3M Company based in St. Paul, Minn. as 3M™ Confirm™ Security Laminate with Floating Images.

In this embodiment of the passport 614, the composite images 630 or floating images 630 include three different types of floating images. The first type of floating image 30a is a “3M” that appears to the unaided eye to float above the page in the passport 614. The second type of floating image 630b is a “3M” that appears to the unaided eye to float below the page in the passport 614. The third type of floating image 630c is a sine wave that appears to the unaided eye to float above the page in the passport 614. When the passport 614 is tilted by a user, the floating images 630a, 630b, and 630c may appear to move to the observer. In reality, the floating images 630a, 630b, 630c are optical illusions that appear to the viewer's unaided eye to be floating above or below the sheeting 620 or both. The passport 614 or document of value may include any combination of floating images that float above, below and/or in the plane of the passport 614. The floating images may be any configuration and may include words, symbols, or particular designs that correspond to the document of value. For instance, passports issued by the Australian government include microlens sheeting having floating images in the shape of a kangaroo and boomerangs, two symbols representing the country. The other pages of the passport booklet may contain blank pages for receiving a country's stamp, as the person is processed through customs.

When a passport has been presented to a customs official as the person is being processed through customs to either leave or enter in a country, the customs official would typically look at the passport 614 with his unaided eyes to see if the passport included the appropriate floating images 630 to verify that the passport was authentic.

As shown therein some of the images are complete, and others are partial.

These composite images can also be thought of as the result of the summing together of many images, both partial and complete, all with different perspectives of a real object. The many unique images are formed through an array of miniature lenses, all of which “see” the object or image from a different vantage point. Behind the individual miniature lenses, a perspective of the image is created in the material layer that depends on the shape of the image and the direction from which the imaging energy source was received. However, not everything that the lens sees is recorded in the radiation sensitive material. Only that portion of the image or object seen by the lens that has sufficient energy to modify the radiation sensitive material will be recorded.

The “object” to be imaged is formed through the use of an intense light source by either tracing the outline of the “object” or by the use of a mask. For the image thus recorded to have a composite aspect, the light from the object must radiate over a broad range of angles. When the light radiating from an object is coming from a single point of the object and is radiating over a broad range of angles, all the light rays are carrying information about the object, but only from that single point, though the information is from the perspective of the angle of the light ray. Now consider that in order to have relatively complete information about the object, as carried by the light rays, light must radiate over a broad range of angles from the collection of points that constitute the object. In this invention, the range of angles of the light rays emanating from an object is controlled by optical elements interposed between the object and the microlens material. These optical elements are chosen to give the optimum range of angles necessary to produce a composite image. The best selection of optical elements results in a cone of light whereby the vertex of the cone terminates at the position of the object. Optimum cone angles are greater than about 40 degrees.

The object is demagnified by the miniature lenses and the light from the object is focused onto the energy sensitive coating against the backside of the miniature lens. The actual position of the focused spot or image at the backside of the lens depends upon the direction of the incident light rays originating from the object. Each cone of light emanating from a point on the object illuminates a fraction of the miniature lenses and only those miniature lenses illuminated with sufficient energy will record a permanent image of that point of the object.

Geometrical optics will be used to describe the formation of various composite images according to the present invention. As noted previously, the imaging processes described below are preferred, but not exclusive, embodiments of the invention.

E. Creating a Composite Image that Floats Above the Sheeting

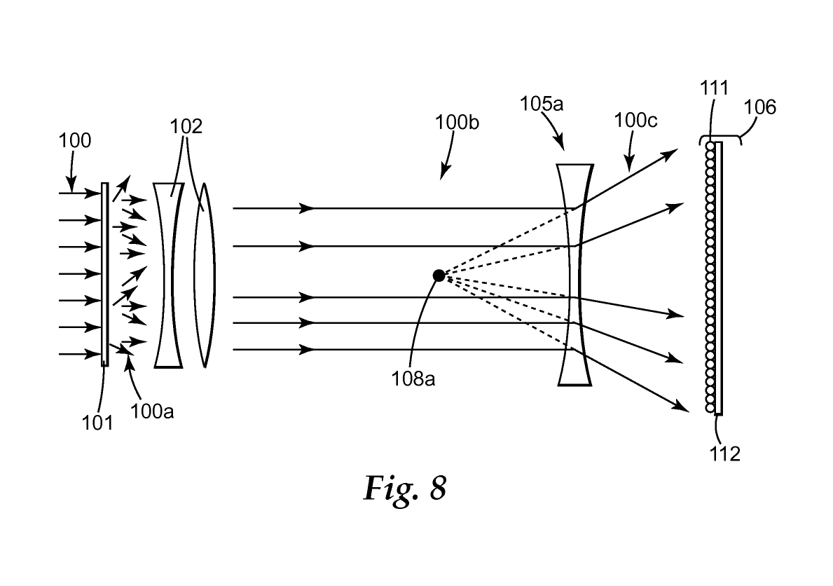

Referring to FIG. 8, incident energy 100 (light, in this example) is directed onto a light diffuser 101 to homogenize any non-uniformities in the light source. The diffusely scattered light 100a is captured and collimated by a light collimator 102 that directs the uniformly distributed light 100b towards a diverging lens 105a. From the diverging lens, the light rays 100c diverge toward the microlens sheeting 106.

The energy of the light rays impinging upon the microlens sheeting 106 is focused by the individual microlenses 111 onto the material layer (a radiation sensitive coating 112, in the illustrated embodiment). This focused energy modifies the radiation sensitive coating 112 to provide an image, the size, shape, and appearance of which depends on the interaction between the light rays and the radiation sensitive coating.

The arrangement shown in FIG. 8 would provide a sheeting having a composite image that appears to an observer to float above the sheeting as described below, because diverging rays 100c, if extended backward through the lens, would intersect at the focal point 108a of the diverging lens. Stated differently, if a hypothetical “image ray” were traced from the material layer through each of the microspheres and back through the diverging lens, they would meet at 108a, which is where the composite image appears.

F. Viewing a Composite Image that Floats Above the Sheeting

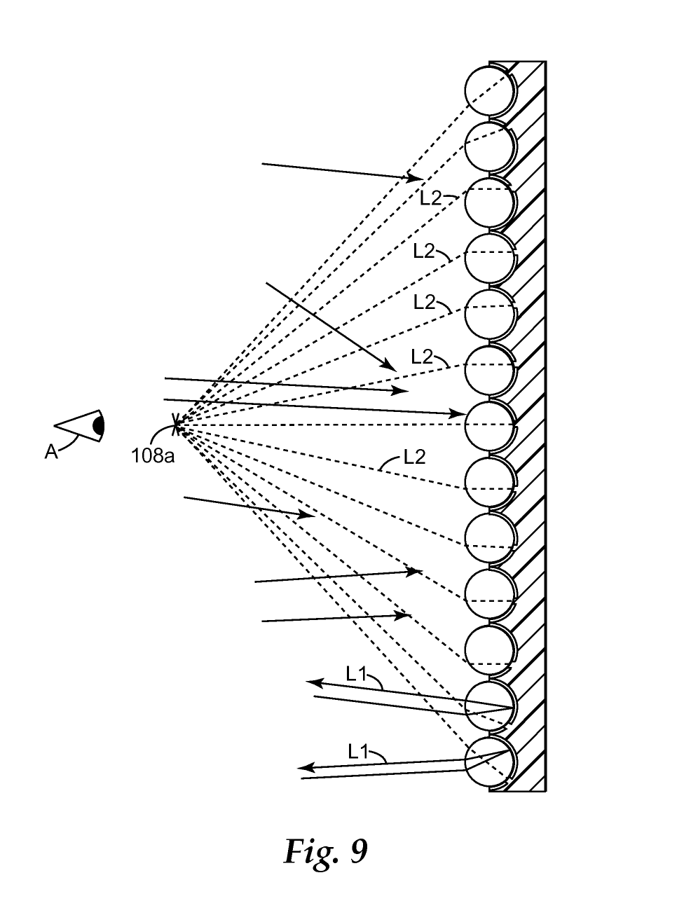

A sheeting that has a composite image may be viewed using light that impinges on the sheeting from the same side as the observer (reflected light), or from the opposite side of the sheeting as the observer (transmitted light), or both. FIG. 9 is a schematic representation of a composite image that appears to the unaided eye of an observer A to float above the sheeting when viewed under reflected light. An unaided eye may be corrected to normal vision, but is not otherwise assisted by, for example, magnification or a special viewer. When the imaged sheeting is illuminated by reflected light, which may be collimated or diffuse, light rays are reflected back from the imaged sheeting in a manner determined by the material layer struck by the light rays. By definition, the images formed in the material layer appear different than the non-imaged portions of the material layer, and thus an image can be perceived.

For example, light L1 may be reflected by the material layer back toward the observer. However, the material layer may not reflect light L2 back toward the observer well, or at all, from the imaged portions thereof. Thus, the observer may detect the absence of light rays at 108a, the summation of which creates a composite image that appears to float above the sheeting at 108a. In short, light may be reflected from the entire sheeting except the imaged portions, which means that a relatively dark composite image will be apparent at 108a.

It is also possible that the nonimaged material would absorb or transmit incident light, and that the imaged material would reflect or partially absorb incident light, respectively, to provide the contrast effect required to provide a composite image. The composite image under those circumstances would appear as a relatively bright composite image in comparison to the remainder of the sheeting, which would appear relatively dark. This composite image may be referred to as a “real image” because it is actual light, and not the absence of light, that creates the image at focal point 108a. Various combinations of these possibilities can be selected as desired.

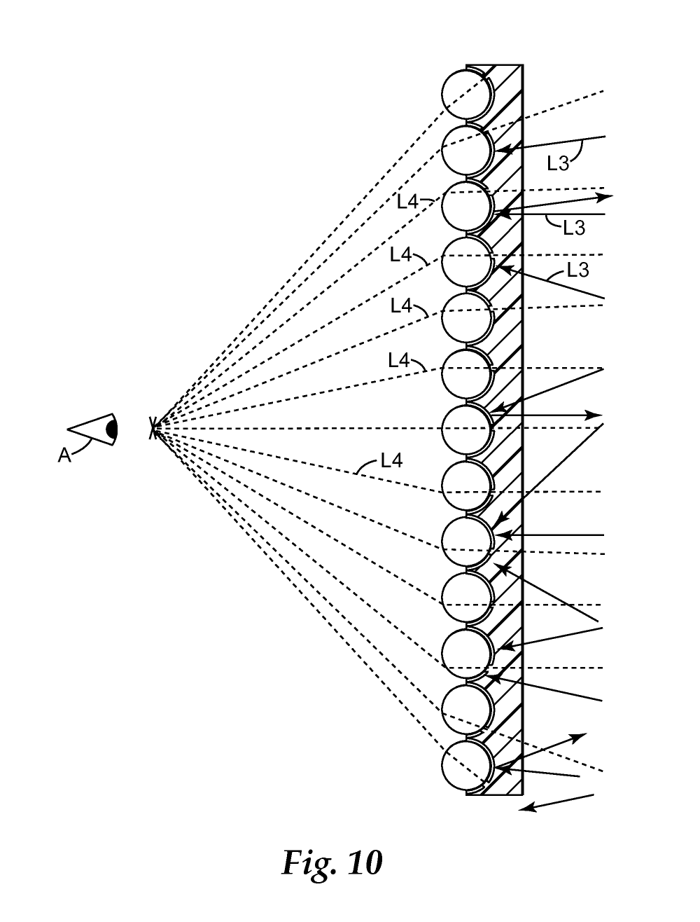

Certain imaged sheetings can also be viewed by transmitted light, as shown in FIG. 10. For example, when the imaged portions of the material layer are translucent and the nonimaged portions are not, then most light L3 will be absorbed or reflected by the material layer, while transmitted light L4 will be passed through the imaged portions of the material layer and directed by the microlenses toward the focal point 108a. The composite image will be apparent at the focal point, where it will in this example appear brighter than the remainder of the sheeting. This composite image may be referred to as a “real image” because it is actual light, and not the absence of light, that creates the image at focal point 108a.

Alternatively, if the imaged portions of the material layer are not translucent but the remainder of the material layer is, then the absence of transmitted light in the areas of the images will provide a composite image that appears darker than the remainder of the sheeting.

G. Creating a Composite Image that Floats Below the Sheeting

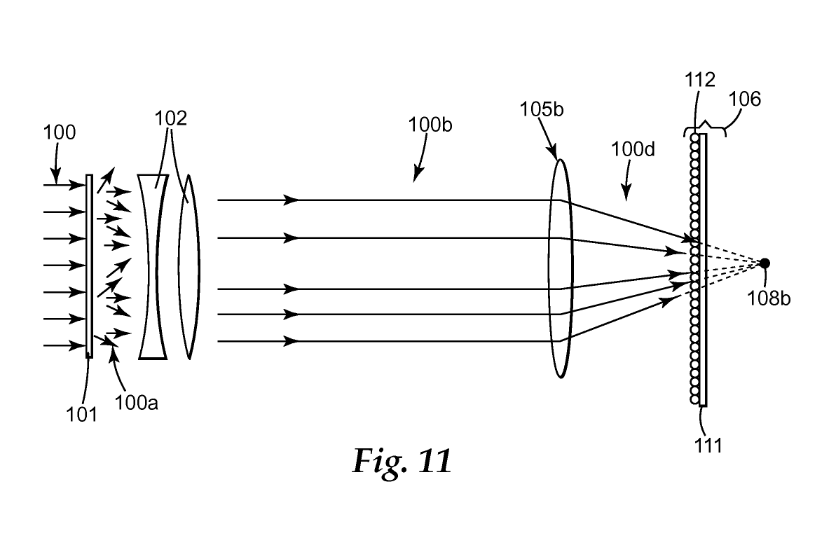

A composite image may also be provided that appears to be suspended on the opposite side of the sheeting from the observer. This floating image that floats below the sheeting can be created by using a converging lens instead of the diverging lens 105 shown in FIG. 8. Referring to FIG. 11, the incident energy 100 (light, in this example) is directed onto a diffuser 101 to homogenize any non-uniformities in the light source. The diffuse light 100a is then collected and collimated in a collimator 102 that directs the light 100b toward a converging lens 105b. From the converging lens, the light rays 100d are incident on the microlens sheeting 106, which is placed between the converging lens and the focal point 108b of the converging lens.

The energy of the light rays impinging upon the microlens sheeting 106 is focused by the individual microlenses 111 onto the material layer (a radiation sensitive coating 112, in the illustrated embodiment). This focused energy modifies the radiation sensitive coating 112 to provide an image, the size, shape, and appearance of which depends on the interaction between the light rays and the radiation sensitive coating. The arrangement shown in FIG. 11 would provide a sheeting having a composite image that appears to an observer to float below the sheeting as described below, because converging rays 100d, if extended through the sheeting, would intersect at the focal point 108b of the diverging lens. Stated differently, if a hypothetical “image ray” were traced from the converging lens 105b through each of the microspheres and through the images in the material layer associated with each microlens, they would meet at 108b, which is where the composite image appears.

H. Viewing a Composite Image that Floats Below the Sheeting

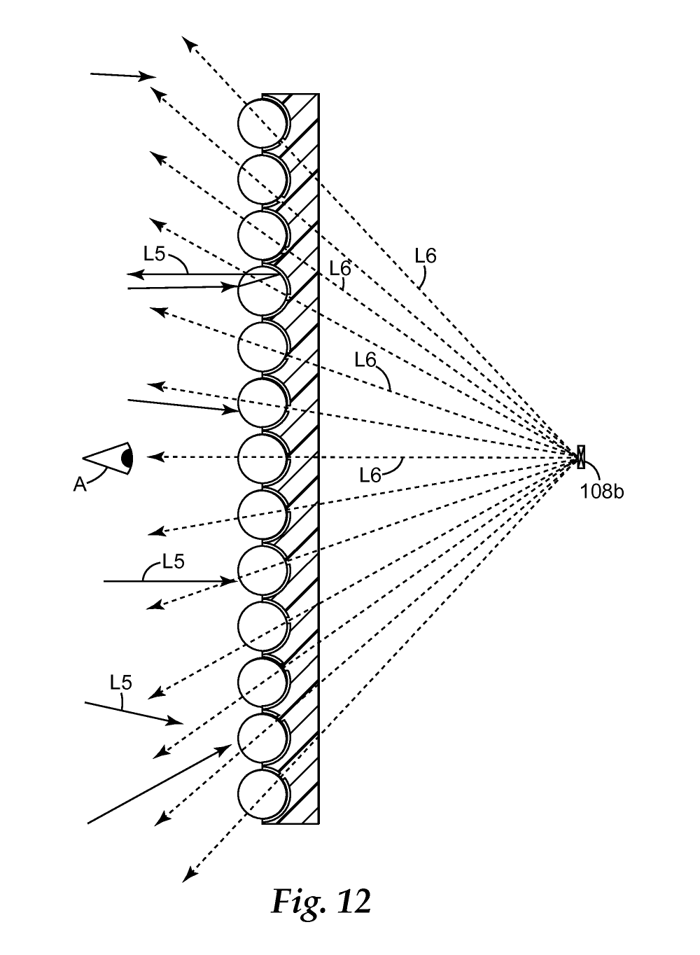

Sheeting having a composite image that appears to float below the sheeting can also be viewed in reflected light, transmitted light, or both. FIG. 12 is a schematic representation of a composite image that appears to float below the sheeting when viewed under reflected light. For example, light L5 may be reflected by the material layer back toward the observer. However, the material layer may not reflect light L6 back toward the observer well, or at all, from the imaged portions thereof. Thus, the observer may detect the absence of light rays at 108b, the summation of which creates a composite image that appears to float below the sheeting at 108b. In short, light may be reflected from the entire sheeting except the imaged portions, which means that a relatively dark composite image will be apparent at 108b.

It is also possible that the nonimaged material would absorb or transmit incident light, and that the imaged material would reflect or partially absorb incident light, respectively, to provide the contrast effect required to provide a composite image. The composite image under those circumstances would appear as a relatively bright composite image in comparison to the remainder of the sheeting, which would appear relatively dark. Various combinations of these possibilities can be selected as desired.

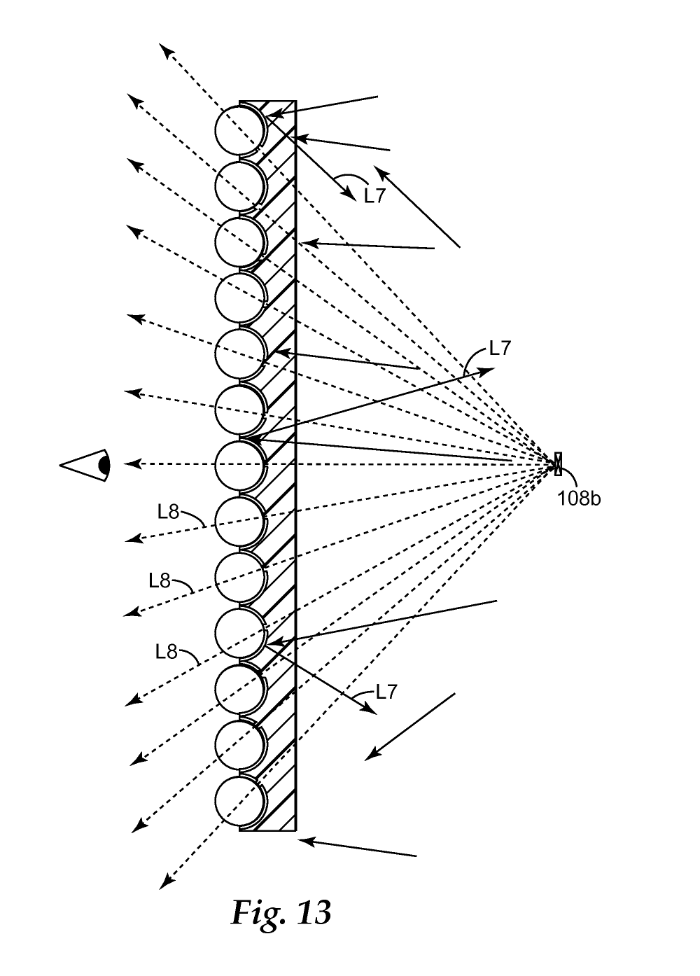

Certain imaged sheetings can also be viewed by transmitted light, as shown in FIG. 13. For example, when the imaged portions of the material layer are translucent and the nonimaged portions are not, then most light L7 will be absorbed or reflected by the material layer, while transmitted light L8 will be passed through the imaged portions of the material layer. The extension of those rays, referred to herein as “image rays,” back in the direction of the incident light results in the formation of a composite image at 108b. The composite image will be apparent at the focal point, where it will in this example appear brighter than the remainder of the sheeting.

Alternatively, if the imaged portions of the material layer are not translucent but the remainder of the material layer is, then the absence of transmitted light in the areas of the images will provide a composite image that appears darker than the remainder of the sheeting.

### I. Complex Images

Composite images made in accordance with the principles of the present invention may appear to be either two-dimensional, meaning that they have a length and width, and appear either below, or in the plane of, or above the sheeting, or three-dimensional, meaning that they have a length, width, and height. Three-dimensional composite images may appear below or above the sheeting only, or in any combination of below, in the plane of, and above the sheeting, as desired. The term “in the plane of the sheeting” refers only generally to the plane of the sheeting when the sheeting is laid flat. That is, sheeting that isn't flat can also have composite images that appear to be at least in part “in the plane of the sheeting” as that phrase is used herein.

Three-dimensional composite images do not appear at a single focal point, but rather as a composite of images having a continuum of focal points, with the focal points ranging from one side of the sheeting to or through the sheeting to a point on the other side. This is preferably achieved by sequentially moving either the sheeting or the energy source relative to the other (rather than by providing multiple different lenses) so as to image the material layer at multiple focal points. The resulting spatially complex image essentially consists of many individual dots. This image can have a spatial extent in any of the three cartesian coordinates relative to the plane of the sheeting.

In another type of effect, a composite image can be made to move into a region of the microlensed sheeting where it disappears. This type of image is fabricated in a fashion similar to the levitation examples with the addition of placing an opaque mask in contact with the microlensed materials to partially block the imaging light for part of the microlensed material. When viewing such an image, the image can be made to move into the region where the imaging light was either reduced or eliminated by the contact mask. The image seems to “disappear” in that region.

The composite images formed according to the present invention can have very wide viewing angles, meaning that an observer can see the composite image across a wide range of angles between the plane of the sheeting and the viewing axis. Composite images formed in microlens sheeting comprised of a monolayer of glass microspheres having an average diameter of approximately 70-80 micrometers and, when using an aspheric lens with a numerical aperture of 0.64, are visible within a conical field of view whose central axis is determined by the optical axis of the incident energy. Under ambient lighting, the composite image so formed is viewable across a cone of about 80-90 degrees full angle. Utilizing an imaging lens with less divergence or lower NA can form smaller half angle cones.

Images formed by the process of this invention can also be constructed that have a restricted viewing angle. In other words, the image would only be seen if viewed from a particular direction, or minor angular variations of that direction. Such images are formed similar to the method described in Example One below, except that light incident on the final aspheric lens is adjusted so that only a portion of the lens is illuminated by the laser radiation. The partial filling of the lens with incident energy results in a restricted cone of divergent light incident upon the microlensed sheeting. For aluminum coated microlens sheeting, the composite image appears only within a restricted viewing cone as a dark gray image on a light gray background. The image appears to be floating relative to the microlens sheeting.

When the imaged sheeting was viewed under ambient light, a floating globe pattern was observed as a dark gray image against a light gray background, floating 1 cm above the sheeting. By varying the viewing angle, the “globe” moved into or out of the region that was masked by the translucent tape. When the globe moved into the masked region, the portion of the globe in that region disappears. When the globe moved out of the masked region, the portion of the globe in that region reappeared. The composite image did not merely fade gradually away as it passed into the masked region, but rather completely disappeared exactly when it passed into that region.

Imaged sheeting containing the composite images of this invention are distinctive and impossible to duplicate with ordinary equipment. The composite images can be formed in sheeting that is specifically dedicated to applications such as passports, identification badges, banknotes, identification graphics, and affinity cards. Documents requiring verification can have these images formed on the laminated sheeting for identification, authenticity, and enhancement. Conventional bonding means such as lamination, with or without adhesives, may be used. Providers of items of value, such as boxed electronic products, compact discs, driver's licenses, title documents, passports or branded products, may simply apply the multilayer film of this invention to their products and instruct their customers only to accept as authentic items of value so labeled. For products requiring these protections, their appeal may be enhanced by the inclusion of sheeting containing composite images into their construction or by adhering such sheeting to the products. The composite images may be used as display materials for advertising, for license plates, and for numerous other applications in which the visual depiction of a unique image is desirable. Advertising or information on large objects, such as signs, billboards, or semitrailers, would draw increased attention when the composite images were included as part of the design.

Sheeting with the composite images has a very striking visual effect, whether in ambient light, transmitted light, or retroreflected light in the case of retroreflective sheeting. This visual effect can be used as a decoration to enhance the appearance of articles to which the imaged sheeting is attached. Such an attachment could convey a heightened sense of fashion or style and could present a designer logo or brand in a very dramatic way. Envisioned uses of the sheeting for decoration include applications to apparel, such as everyday clothing, sports clothing, designer clothing, outerwear, footwear, caps, hats, gloves and the like. Similarly, fashion accessories could utilize imaged sheeting for decoration, appearance, or brand identity. Such accessories could include purses, wallets, briefcases, backpacks, fanny packs, computer cases, luggage, notebooks and the like. Further decorative uses of the imaged sheeting could extend to a variety of objects that are commonly embellished with a decorative image, brand, or logo. Examples include books, appliances, electronics, hardware, vehicles, sports equipment, collectibles, objects of art and the like.

When the decorative imaged sheeting is retroreflective, fashion or brand awareness can be combined with safety and personal protection. Retroreflective attachments to apparel and accessories are well known and enhance the visibility and conspicuity of the wearer in low-light conditions. When such retroreflective attachments incorporate the composite imaged sheeting, a striking visual effect can be achieved in ambient, transmitted, or retroreflected light. Envisioned applications in the area of safety and protective apparel and accessories include occupational safety apparel, such as vests, uniforms, firefighter's apparel, footwear, belts and hardhats; sports equipment and clothing, such as running gear, footwear, life jackets, protective helmets, and uniforms; safety clothing for children; and the like.

Attachment of the imaged sheeting to the aforementioned articles can be accomplished by well known techniques, as taught in U.S. Pat. Nos. 5,691,846 (Benson, Jr. et al.), 5,738,746 (Billingsley et al.), 5,770,124 (Marecki et al.), and 5,837,347 (Marecki), the choice of which depends on the nature of the substrate material. In the case of a fabric substrate, the sheeting could be die cut or plotter cut and attached by sewing, hot-melt adhesive, mechanical fasteners, radio frequency welding or ultrasonic welding. In the case of hardgoods, a pressure-sensitive adhesive may be a preferred attachment technique.

In some cases, the image may be best formed after the sheeting is attached to a substrate or article. This would be especially useful when a custom or unique image was desired. For example, artwork, drawings, abstract designs, photographs, or the like could be computer generated or digitally transferred to a computer and imaged on the sheeting, the unimaged sheeting having been previously attached to the substrate or article. The computer would then direct the image generation equipment as described above. Multiple composite images may be formed on the same sheeting, and those composite images may be the same or different. Composite images may also be used along with other conventional images such as printed images, holograms, isograms, diffraction gratings, kinegrams, photographs, and the like. The image may be formed in the sheeting before or after the sheeting is applied to an article or object.

### J. Translucent and Transparent Laminates

In certain embodiments, a sheeting may utilize one or more layers of translucent or transparent laminates as materials or combinations of materials into which a floating image may be formed. For convenience, the invention will be described with respect to translucent materials; however, a range of materials may be used for the sheeting, including translucent materials, semi-translucent materials, and transparent materials. The sheeting may form a construction that maintains a complete or semi-translucent property, i.e., that allows light to pass through the construction to some extent.

Translucent laminates may be combined with other functional materials. For example, a finished construction may be adhesively or mechanically applied to an article. The overall combined article may be translucent, opaque, or a combination thereof. Translucent laminates may be constructed from a variety of single- or multi-layer materials or combinations of these materials. For example, such materials may include dyed or pigmented colored films, multilayer optical films, and interference films. Such a translucent laminate may include a single layer of clear, dyed, or pigmented polyethylene terephthalate (PET), silicone, acrylate, polyurethane or other such material, with a layer of radiation sensitive material, disposed adjacent the first layer, into which an image is formed. Another example is a layer of material, having optical elements (e.g., lenses) formed on a surface of the layer, onto which a second material is transferred by a laser material transfer process or other printing-like process.

In some embodiments, the floating images of the invention may be formed within a single layer of a translucent laminate itself, formed due to microlenses on a surface of the single layer without requiring an adjacent layer of material. FIG. 17 is an enlarged cross sectional view of a sheeting 1600 that contains a single layer 1630 of material having microlenses 1602 formed on a surface thereof. That is, layer 1630 may be formed as a single layer of material, having a surface of microlenses, and may have a thickness sufficient to be self-supporting, making an additional substrate unnecessary.

In the illustrated embodiment of FIG. 17, sheeting 1600 comprises a transparent plano-convex or aspheric sheeting having first and second sides, the second side 1604 being substantially planar and the first side having an array of substantially hemi-spheroidal or hemi-aspheroidal microlenses 1602 formed thereon. The shape of the microlenses 1602 and the thickness of the layer 1630 are selected such that collimated light 1608 incident to the array is focused at regions 1610 within the single layer 1630. The thickness of layer 1630 depends at least in part on the characteristics of the microlenses 1602, such as the distance at which the microlenses focus light. For example, microlenses may be used that focus light at a distance of 60 μm from the front of the lens. In some embodiments, the thickness of layer 1630 may be between 20-100 μm. Microlenses 1602 may be formed of clear or colored PET, silicone, acrylate, polyurethane, polypropylene or other material, by a process such as embossing or microreplication.

Incident energy, such as light 1608 from energy source 1606, is directed towards sheeting 1600. The energy of the light rays impinging upon sheeting 1600 is focused by the individual microlenses 1602 to regions 1610 within layer 1630. This focused energy modifies layer 1630 at regions 1610 to provide an image, the size, shape, and appearance of which depends on the interaction between the light rays 1608 and microlenses 1602. For example, light rays 1608 may form respective partial images, associated with each of the microlenses, at respective damage sites within layer 1630 as a result of photodegradation, charring, or other localized damage to layer 1630. Regions 1610 may in some examples be referred to as “photodegradation portions.” The individual images may be formed of black lines caused by the damage. The individual images formed in the material, when viewed by an observer under reflected or transmitted light, provide a composite image that appears to be suspended, or float, above, in the plane of, and/or below the sheeting.

A radiation source, as described above with respect to Part III, may be used to form the individual images at regions 1610 within layer 1630 of sheeting 1600. For example, a high peak power radiation source may be used. One example of a radiation source that may be used to image the sheeting is a regeneratively amplified titanium:sapphire laser. For example, a titanium:sapphire laser operating at a wavelength of 800 nm with a pulse duration of approximately 150 femtoseconds and a pulse rate of 250 Hz may be used to form the images within the sheeting.

In some embodiments, the described sheeting may possess optical microstructures on both sides. FIG. 18 is an enlarged cross sectional view of an exemplary sheeting 1700 having an array of substantially hemi-spheroidal or hemi-aspheroidal microlenses 1702 on a first side and a retroreflective portion 1704 on a second side. As shown in FIG. 18, retroreflective portion 1704 may be an array of corner cubes. However, other types of retroreflective surfaces or non-retroreflective optical structures may be formed on the surface of the second side of sheeting 1700 opposite microlenses 1702.

For example, the second side of sheeting 1700 may contain diffractive elements, e.g., a diffractive grating, to provide a color-shifting capability or other optical functions. As another example, the second side may be comprised of partial corner cubes, lenticular lens arrays, additional lenslet arrays, compound optical layers, or other optical elements formed within the surface of the second side of sheeting 1700. Moreover, the optical microstructures on the second side of sheeting 1700 may be uniform or variable in location, period, dimension, or angle, to provide a variety of optical effects. The optical microstructures may also be coated with a semi-transparent layer of metal. As a result of these variations, sheeting 1700 may provide an image on a color-shifting background or may provide added optical functionality.

In another embodiment, microlenses 1702 may be formed within only a portion of the first side of sheeting 1700, while retroreflective portion 1704 covers substantially all of the second side of sheeting 1700. In this manner, an observer viewing sheeting 1700 from the first side may see both a floating image and areas that appear retroreflective. Sheeting 1700 could be used as a security feature by checking retroreflectivity of the sheeting. In certain embodiments, retroreflective portion 1704 may contain corner cubes, and corners of those corner cubes may be bent so as to give a “sparkly” appearance in the portion not covered by microlenses 1702.

Individual images associated with each of the plurality of microlenses 1702 may be formed within sheeting 1700 as described above with respect to FIG. 17. In one embodiment, sheeting 1700 may be a two-sided microstructure in which microlenses 1702 and retroreflective portion 1704 are constructed on opposite surfaces a single layer of material. In another embodiment, microlenses 1702 and retroreflective portion 1704 may be two separate layers of material affixed together, such as by lamination. In this case, the individual images may be formed at locations between the layer associated with microlenses 1702 and the layer associated with retroreflective portion 1704. Alternatively, a layer of radiation-sensitive material may exist between the layer associated with microlenses 1702 and the layer associated with retroreflective portion 1704, on which the individual images are formed.

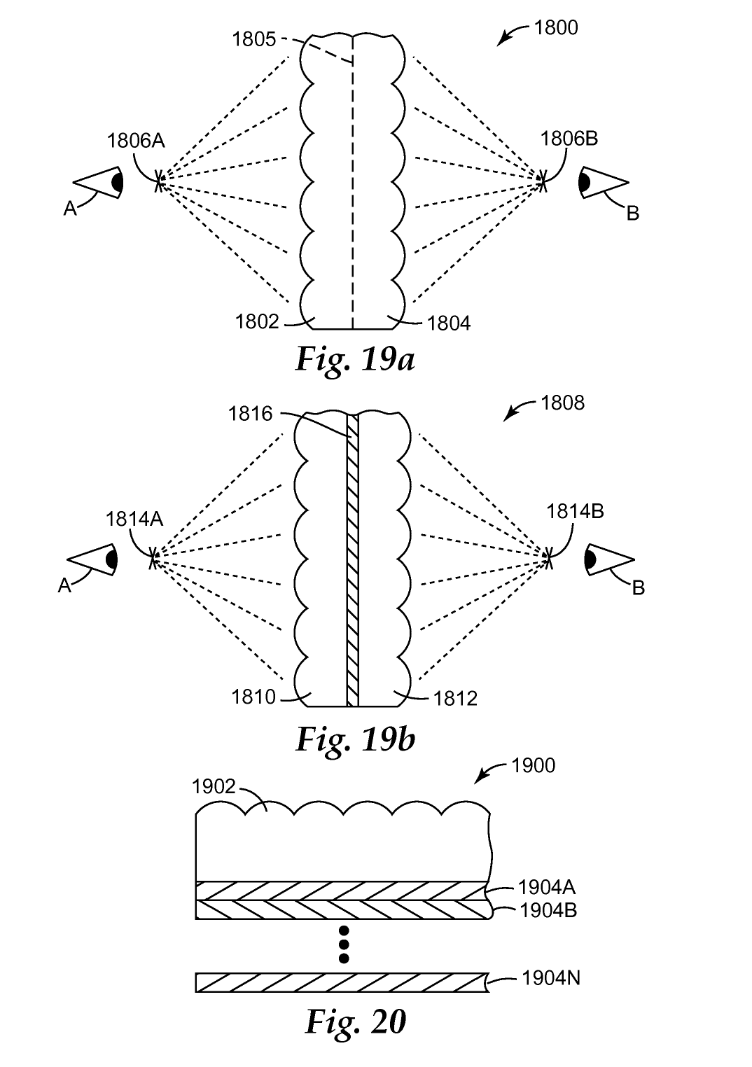

A two-sided, single-layer sheeting with microstructures on both sides and having a composite image may be viewed under reflected light or transmitted light, or both. FIG. 19a is a schematic representation of a sheeting 1800 having a first side 1802 and a second side 1804, each of the first and second sides having an array of substantially hemi-spheroidal or hemi-aspheroidal microlenses. Sheeting 800 presents composite images 1806A and 1806B (“composite images 1806”) based on the viewing position of an observer. For example, composite images 1806A, 1806B appear to an observer A on the first side of sheeting 1800 and an observer B on the second side of sheeting 1800, respectively, to float above (i.e., in front of) the sheeting 1800 when viewed under reflected light. Composite images 1806 are formed by the sum of individual images formed in sheeting 1800 in a manner similar to that described above with respect to images formed within a layer of material adjacent a layer of microlenses.

Individual images may be formed at regions 1805 in sheeting 1800. For example, individual images may be formed as above by incident energy from an energy source that modifies sheeting 1800 at regions 1805. Each of regions 1805 may correspond to a respective microlens formed on first side 1802, or to a respective microlens formed on second side 1804, or both. In one embodiment, the microlenses formed on first side 1802 may be selected to focus light rays incident to first side 1802 to a region 1805 substantially in the middle of sheeting 1800. As a result, composite images 1806 produced by the individual images formed at regions 1805 may be viewed by observer A on the first side 1802 of sheeting 1800, or by observer B on the second side 1804 of sheeting 1800. In one embodiment, the microlenses formed on first side 1802 and second side 1804 line up laterally and are substantially equal in terms of thickness and focal length so as to allow the composite image within sheeting 1800 to be visible from either side of the sheeting 1800.

The composite image 1806A seen by observer A may be different in some ways from the composite image 1806B seen by observer B. For example, where the composite images 1806 include features having visual depth, the apparent depth of the features may be reversed. In other words, features appearing closest to observer A may appear farthest to observer B. Although not illustrated, in other embodiments a composite image formed by individual images at regions 1805 may float in the plane of the sheeting, below the sheeting, and/or be viewable under transmitted light.

FIG. 19b is a schematic representation of a multi-layer sheeting 1808 comprising a first layer 1810 having microlenses formed on a surface thereof, a second layer 1812 similarly having microlenses formed on a surface thereof, and a layer of material 1816 disposed between the first and second microlens layers. The outer surfaces of layers 1810, 1812 may include an array of substantially hemi-spheroidal or hemi-aspheroidal microlenses. Layer of material 1816 may be a transparent material.

As described above with respect to FIG. 19a, sheeting 1808 presents composite images 1814A and 1814B (“composite images 1814”). Composite images 1814 appear to an observer A on the first side of sheeting 1808 and an observer B on the second side of sheeting 1808, respectively, to float above the sheeting 1808 when viewed under reflected light. Composite images 1814 are produced by the sum of individual images formed in the layer of material 1816, as described above. Layer of material 1816 may be a radiation sensitive material as described above in Part II. As another example, layer of material 816 may be a transparent laser-markable material, such as a doped polycarbonate layer on which a laser beam forms black marks. In one embodiment, layers 1810, 1812 may be attached by lamination. Layer of material 1816 may comprise coatings, films, or other types of layers. For example, layer of material 1816 may be a metallic spacer, a dielectric spacer, a corner-cube spacer, a diffraction grating spacer, a multilayer optical film (MOF), or a compound optical spacer. Multiple layers of material of different kinds or colors may be provided in place of layer of material 1816. In some embodiments, different images may be formed within layer of material 1816 from each side, and as a result, different floating images may be visible to observers A and B. In another embodiment, images may be formed at regions within one of first layer 1810 and second layer 1812.

FIGS. 19a and 19b illustrate sheetings having a composite image that appears to an observer on either side of the sheeting to float above the sheeting. In some embodiments, the sheeting may provide a two-dimensional or three-dimensional composite image that appears on both sides of the sheeting. Such a sheeting may find application as an enhanced security feature, and also provide brand enhancement, brand authentication, and eye-catching appeal.

FIG. 20 is an enlarged cross-sectional view of a sheeting 1900 including a layer 1902 having microlenses formed in a surface thereof and a plurality of additional translucent layers 1904A-1904N (“translucent layers 1904”). Layer 1902 may be substantially similar to layer 1630 of FIG. 17. That is, as described above, layer 1902 may constitute a single layer of sufficient thickness so that individual images may be formed within layer 1902. Additional translucent layers 1904 may be added to sheeting 1900 to produce added visual appearance (e.g., color, contrast, color-shift) and function. Translucent layers 1904 may be layers having optical structures, e.g., lenses, corner cubes, lenticular lens arrays, positioned within the optical stack to add effects such as color shifting and function. For example, a diffractive grating may add color shifting effects, while lenses may provide imaging functionality. Sheeting 1900 may be used to provide a high contrast white floating image on a continuously variable color background. The individual images formed in the material, when viewed by an observer under reflected or transmitted light, provide a composite image that appears to be suspended, or float, above, in the plane of, and/or below the sheeting.

As discussed above, a number of configurations are possible for translucent microlens sheetings. For example, a sheeting may include a spacer that results in images misaligned with respect to the lens array. This may produce movement of the image orthogonal to the movement of the observer relative to the substrate. As another example, a single layer of microlenses may be formed from energy-absorption-appropriate materials. A protective topcoat may be added to a sheeting to add durability. Such a topcoat may be colored or transparent, and may enhance image appearance and provide a mechanism with which to produce a uniform background color. The layer having microlenses on a surface or the additional translucent layers may be dyed or pigmented. The pigment colors may be customized.

The sheeting may provide an enhanced contrast floating image on a semi-transparent substrate, or a translucent color image on a translucent substrate. The sheeting may provide multi-sided color shifting floating images with tunable color shifting and tunable optical effects as a function of viewing angle or incident lighting angle. The sheeting may provide the ability to selectively form images within substrates via wavelengths. The microreplicated optical structures of a sheeting may be band-pass microreplicated optical structures, such as colored glass band-pass or interference band-pass microreplicated optical structures. Such structures may be capable of single or multi-wavelength image formation, or may allow for secure image formation with unique wavelengths. Creating a band-pass substrate may provide both security and visual utility. Security value may be added by increasing the number of laser systems needed to reproduce a multi-colored floating image.

The microlens sheeting may be an “embedded-lens” type of sheeting in which the microsphere lenses are embedded in a transparent protective overcoat, which is typically a polymeric material. Clear or colored glass or polymer beads may be substituted for the microreplicated lens optics in the embodiments described above. For example, beads may be bonded on multilayer optical films (MOF) on both sides, with the MOF and bead size additionally being varied. As another example, beads may be bonded on a dielectric spacer on both sides. The beads may be bonded to both sides of a diffraction grating spacer, with the diffraction grating blaze and periodic structure being varied. The beads may be metal-coated beads bonded to both sides of a diffraction grating spacer. The grating may be varied from 2D to 3D grating. Periodic structures may be added to the gratings to influence diffractive orders, viewing angles, and the like. The above features may also be selectively combined to achieve a sheeting having a desired effect.

The translucent laminates described above may be incorporated in backlit applications, or may be applied in constructions that incorporate colored, white, or variable lighting elements, variable intensity lighting, light guides, fiber-delivered light, color filters, fluorescent or phosphorescent materials. These lighting conditions may be designed to change the appearance of the image or the overall substrate in time, via user interaction, or via environmental conditions. In this manner, the construction provides a dynamically varying floating image with variably visible information content.

The single and multi-layer sheetings using translucent layers, as described above, may be used in a number of applications, including security documents and consumer decorative applications. For example, the floating image of the sheeting may be used for a floating watermark as a translucent overlay, providing a secure feature through which printed information is visible. The sheeting may be made very thin (<1 mm), which may enable integration of the sheeting into security documents, passports, drivers licenses, currency, banknotes, identification cards, titles, personnel badges, proofs of purchase, authenticity certificates, corporate cards, financial transaction cards (e.g. credit cards), certificates, brand and asset protection labels, registration tags, tax stamps, gaming chips, license plates, validation stickers, or other items.

The sheetings may also be incorporated into materials used by creative designers. As another example, the sheeting may be incorporated into computer cases, keyboards, numeric key pads, or computer displays.

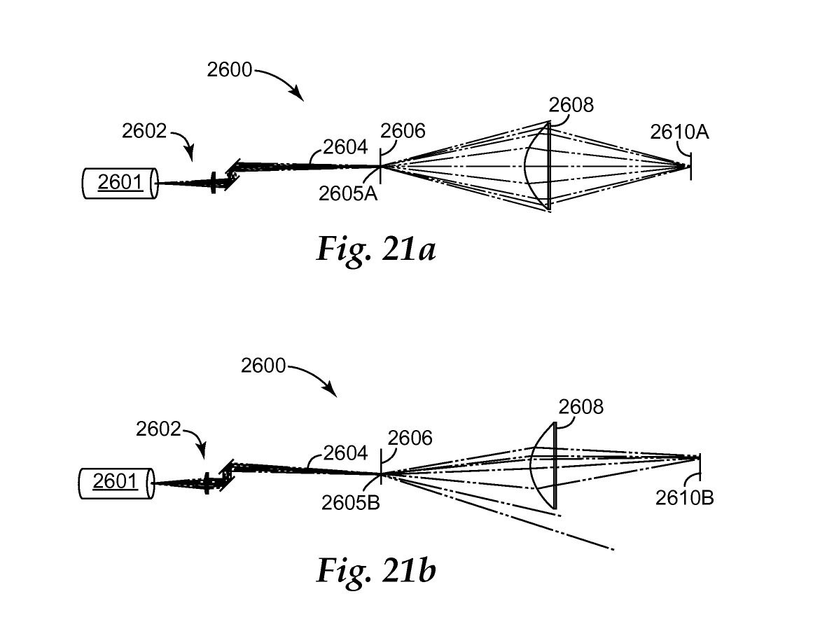

The following description sets forth a technique that may be applied to image a microlens sheeting and control the viewing angle ranges of any composite images formed thereby. FIGS. 21a and 21b are block diagrams illustrating an example optical train 2600 for forming a floating image within a microlens sheeting (not shown) so that the floating image is written with high numerical aperture (NA) lenses by a galvanometer scanner.

FIGS. 21a and 21b show the optical train imaging the sheeting at a first position at a first point in time and a second position at a second point in time, respectively. For example, FIGS. 21a and 21b may represent two points in time while optical train 2600 images the microlens sheeting to produce a single floating image. That is, FIG. 21a shows a beam of energy 2604 striking lens array 2606 at a first position 2605A, while FIG. 21b shows beam of energy 2604 striking lens array 2606 at a second position 2605B.

A technique referred to herein as relay imaging uses a galvanometer scanner 2602 to write floating images at a high linear rate, such as greater than 200 mm/sec. Galvanometer scanner 2602 may receive a beam of energy from a fixed radiation source 2601 (e.g., a laser), which is directed to a set of high-speed moving mirrors to write the images at high rate. Writing floating images at a high rate may be preferred, because unwanted overexposure of the sheeting may occur at slower rates. Relay imaging may be used to write floating images that contain features that appear to float above and/or sink beneath the plane of the microlens sheeting (not shown in FIGS. 21a, 21b). Relay imaging may also be used to write floating images that have regions containing features that exhibit a continuous change in float height above, below, or both above and below the plane of the microlens sheeting.

The relay imaging method uses an intense radiation source 2601, such as a laser, with galvanometer scanner 2602 to illuminate an area of high numerical aperture (NA) lenses (lenslets) in a lens array 2606. A high NA lens is a lens with a NA equal to or greater than 0.3. The radiation source may, for example, be any of the radiation sources described above. As another example, the radiation source may be a neodymium doped laser, such as neodymium-doped glass (Nd:Glass), neodymium-doped yttrium orthovanadate (Nd:YVO₄), neodymium-doped gadolinium orthovandadate, or other neodymium doped lasers.

As shown in FIGS. 21a and 21b, the illuminated lenslets within lens array 2606 focus the light to form an array of cones of highly divergent light, each cone being centered on its corresponding lenslet in the array. The divergent cones of light from the lens array are collected by a system of adaptable relay optics that includes objective 2608, and refocused at a controlled distance from a lensed substrate, i.e., a microlens sheeting (not shown). In this manner, the apparent location of the divergent light cones formed by lens array 2606 illuminated by the radiation source appears to be at the focal position 2610A (FIG. 21a), 2610B (FIG. 21b) of the adaptable relay optics. As discussed herein, optical train 600 may be configured to locate focal position 2610A in front, behind, or in the same plane as the microlens sheeting. The divergent light is used to write a floating image in the microlens sheeting. The phrase “to write a floating image” is used synonymously herein with the term “to form a floating image.”

The pattern of the floating image written by this process is determined by which lenses in lens array 2606 are illuminated by the incident light. For example, galvanometer scanner 2602 may be used to move a laser beam 2604 around a surface of lens array 2606 to locally illuminate desired lenses in lens array 2606 by tracing a pattern that corresponds to the resulting floating image, i.e., composite image. In this approach, only a few lenses in lens array 2606 are illuminated at a given time. FIG. 21a shows galvanometer scanner 2601 positioning laser beam 2604 to illuminate a first portion of lens array 2606 such that the divergent light cones focus at a first focal position 2610A. FIG. 21b shows galvanometer scanner 2601 positioning laser beam 2604 to illuminate a second portion of lens array 2606 such that the divergent light cones focus at a second focal position 2610B. The illuminated lenses provide the cone or cones of divergent light to be imaged by the relay optics to form each pixel of the floating image. In some cases, the microlens sheeting may be positioned between objective 2608 and focal position 2610A, 2610B. In other examples, the microlens sheeting may be positioned beyond focal position 2610A, 2610B. The energy of the light rays impinging upon the microlens sheeting is focused by the individual microlenses to a position within the sheeting, such as to a radiation-sensitive material layer disposed adjacent the layer of microlenses, or to a position within the layer of microlenses itself. The portion of the sheeting on or in which an image is formed is different for each microlens, because each microlens “sees” the incoming energy from a different perspective. Thus, a unique image is formed in the material layer associated with each microlens, and each unique image may represent a different partial or substantially complete image of the virtual image.

During this scanning process, a control system may be used to synchronously change the location of the focal point of the adaptive relay optics train relative to the microlens sheeting as a function of position in the plane of the microlens sheeting, to produce one or more composite images that contain features with a continuous variation in float height or sink depth.

In another example, as described above, determining which lenses in the lens array are to be illuminated by the incident light may alternatively be done by way of a mask placed on the lens array. The mask may contain transparent areas that correspond to sections of the microlens sheeting that are to be exposed to the light source, and reflective areas that correspond to sections of the microlens sheeting that should not be exposed. The floating image is formed in the microlens sheeting by illuminating the lens array having the mask with light from the high-intensity light source. The image of the divergent light cones formed by the lens array, corresponding to the pattern of transparent areas in the mask, is transferred by the relay optics to the desired floating depth position relative to the microlens sheeting for writing the floating image.

In yet another example, the microlens sheeting may be placed between lens array 2606 and objective 2608. In this case, the lenses in lens array 2606 may be high NA lenses, and are illuminated by laser beam 2604, as described above. The illuminated lenses of lens array 2606 create the cone or cones of divergent light to image the microlens sheeting to form the different partial or substantially complete images of the virtual image. During this scanning process, a control system may be used to synchronously change the location of the focal point of the lenses in the lens array relative to the microlens sheeting as a function of position in the plane of the microlens sheeting, to produce one or more composite images that contain features with a continuous variation in float height.

### II. Other Exemplary Methods of Creating Composite Images

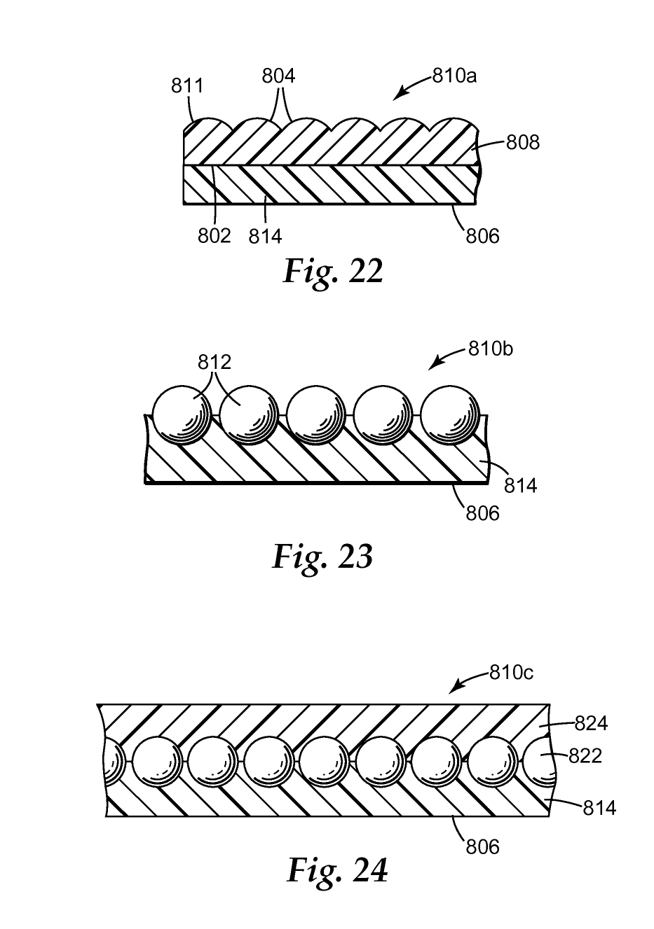

Microlens sheeting in which the images of this invention can be formed comprise one or more discrete layers of microlenses with a layer of material adjacent to one side of the microlens layer or layers. For example, FIG. 22 illustrates one embodiment of a suitable type of microlens sheeting 810a. This sheeting comprises a transparent base sheet 808 having first and second broad faces, the second face 802 being substantially planer and the first face 811 having an array of substantially spherical or aspherical microlenses 804. A layer of material 814 is optionally provided on the second face 802 of the base sheet 808. The layer of material 814 includes a first side 806 for receiving donor material as described in more detail below. FIG. 23 illustrates another embodiment of a suitable type of microlens sheeting 810b. The shape of the microlenses and thickness of the base sheet and their variability are selected such that light appropriate for viewing the sheeting is focused approximately at the first face 806. In this embodiment, the microlens sheeting is an “exposed lens” type of microlens sheeting 810b that includes a monolayer of transparent microspheres 812 that are partially embedded in a material layer 814, which is also typically a bead binder layer, such as a polymeric material. The layer of material 814 includes a first side 806 for receiving donor material as described in more detail below. The microspheres 812 are transparent both to the wavelengths of radiation that may be used to image the donor substrate material (explained in more detail below), as well as to the wavelengths of light in which the composite image will be viewed. This type of sheeting is described in greater detail in U.S. Pat. No. 3,801,183, except where the bead bond layer is very thin, for instance, to the extent where the bead bond layer is only between the beads, or occupying the interstitial spaces between the beads. Alternatively, this type of sheeting can be made by using microspheres of an appropriate optical index for focusing radiation approximately on the first side 806 of the layer of material 814 when the bead bond is of the thickness taught in U.S. Pat. No. 3,801,183. Such microspheres include polymethyl methylacrylate beads, which are commercially available from Esprix Technologies based in Sarasota, Fla.

FIG. 24 illustrates another embodiment of a suitable type of microlens sheeting 810c. In this embodiment, the microlens sheeting is an “embedded-lens” type of sheeting 810c in which the microsphere lenses 822 are embedded between a transparent protective overcoat 824, which is typically a polymeric material, and a material layer 814, which is also typically a bead binder layer, such as a polymeric material. The layer of material 814 includes a first side 806 for receiving donor material as described in more detail below. This type of sheeting is described in greater detail in U.S. Pat. No. 3,801,183, except that the reflective layer and adhesive would be removed, and the spacing layer 814 is reformulated so as to be less conformal to the curvature of the microspheres.

The microlenses of the sheeting 810 preferably have image forming refractive elements in order for image formation (described in more detail below) to occur; this is generally provided by forming spherically or aspherically shaped features. Other useful materials that provide a gradient refractive index (GRIN) will not necessarily need a curved surface to refract light. The microlenses may have any symmetry, such as cylindrical or spherical, provided real images are formed by the refraction surfaces. The microlenses themselves can be of discrete form, such as round plano-convex lenslets, round double convex lenslets, Fresnel lenslets, diffractive lenslets, rods, microspheres, beads, or cylindrical lenslets. Materials from which the microlenses can be formed include glass, polymers, minerals, crystals, semiconductors and combinations of these and other materials. Non-discrete microlens elements may also be used. Thus, microlenses formed from a replication or embossing process (where the surface of the sheeting is altered in shape to produce a repetitive profile with imaging characteristics) can also be used.

Microlenses with a uniform refractive index of between 1.4 and 3.0 over the visible and infrared wavelengths are preferred and more preferably, between 1.4 and 2.5, although not required. The refractive power of the microlenses, whether the individual microlenses are discrete or replicated, and regardless of the material from which the microlenses are made, is preferably such that the light incident upon the optical elements will focus on or near the first side 806 of the material layer 814. In certain embodiments, the microlenses preferably form a demagnified real image at the appropriate position on that layer. The construction of the microlens sheeting provides the necessary focusing conditions so that energy incident upon the front surface of the microlens sheeting is approximately focused upon a separate donor layer that is preferably radiation sensitive, which is described in more detail below.

Microlenses with diameters ranging from 15 micrometers to 275 micrometers are preferable, though other sized microlenses may be used. Good composite image resolution can be obtained by using microlenses having diameters in the smaller end of the aforementioned range for composite images that are to appear to be spaced apart from the microlens layer by a relatively short distance, and by using larger microlenses for composite images that are to appear to be spaced apart from the microlens layer by larger distances. Other microlenses, such as plano-convex, spherical or aspherical microlenses having lenslet dimensions comparable to those indicated for the microlenses, can be expected to produce similar optical results. Cylindrical lenses having lenslet dimensions comparable to those indicated for the microlenses can be expected to produce similar optical results, although different or alternative imaging optics train may be required.

As noted above, a layer of material 814 in FIGS. 22, 23 and 24 may be provided adjacent to the microlenses in the microlens sheeting 810. Suitable materials for the material layer 814 in the sheeting 810 include silicone, polyester, polyurethane, polycarbonate, polypropylene, or any other polymer capable of being made into sheeting or being supported by the base sheet 808. In one embodiment, the sheeting 810 may include a microlens layer and a material layer that are made from different materials. For example, the microlens layer may include acrylates, and the material layer may include polyester. In other embodiments, the sheeting 810 may include a microlens layer and a material layer that are made from the same materials. For example, the microlens and material layer of the sheeting 810 may be made of silicone, polyester, polyurethane, polycarbonate, polypropylene, or any other polymer capable of being made into sheeting, and may be formed by methods of mechanical embossing, replication or molding.

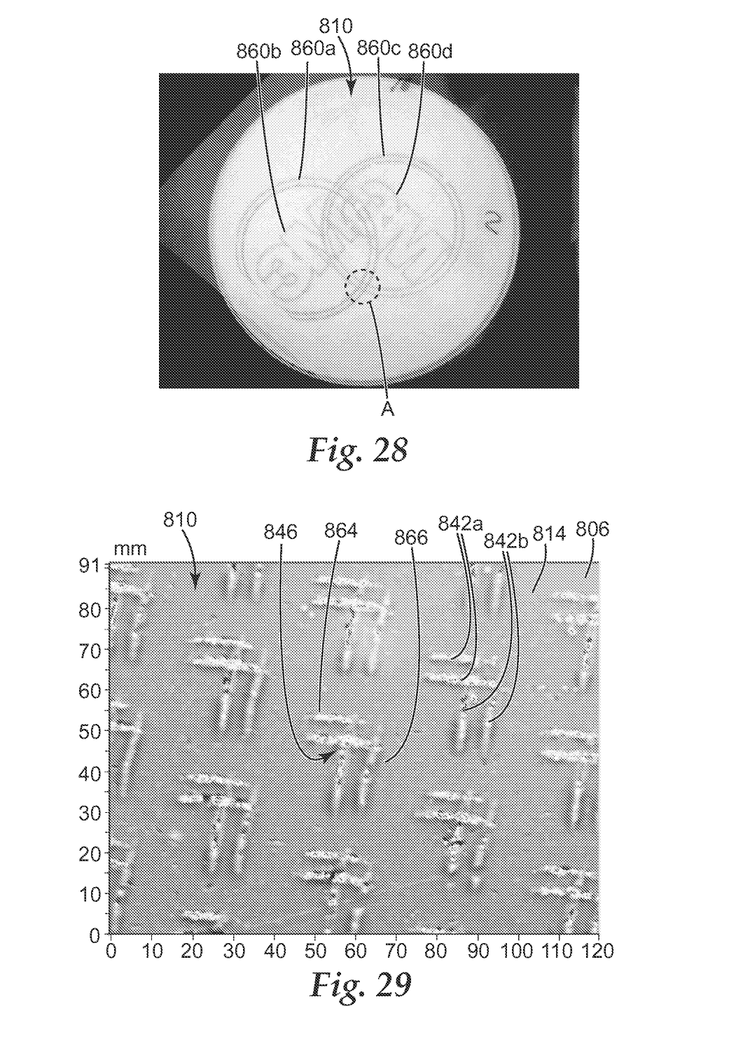

As described in more detail in reference to FIGS. 28 and 29 below, individual, partially complete images are formed on the material layer 814 associated with a plurality of microlenses using a donor substrate material, which, when viewed by an observer in front of said microlenses under reflected or transmitted light, provides a composite image that appears to be suspended, or float, above, in the plane of, and/or below the sheeting. Although other methods may be used, the preferred method for providing such images is to provide a radiation sensitive donor material, and to use radiation to transfer that donor material in a desired manner to provide the individual, partially complete images on the first side of the layer of material. This transfer process could include meltstick, sublimation, additive ablation (material transfer to a substrate by ablating a donor), diffusion and/or other physical material transfer processes.

Suitable radiation sensitive donor material substrates useful for this invention include substrates coated with colorants in a binder, with or without additional radiation sensitive materials. The donor materials could be provided in bulk form or in roll form. As used in reference to the present invention, donor substrate material is “radiation sensitive” if, upon exposure to a given level of radiation, a portion of the donor material exposed transfers or preferentially adheres to a different location. The individual, partially complete images (illustrated in FIGS. 28 and 29) are created as a result of an at least partial or complete removal of the radiation sensitive donor substrate material or colorant material from the donor substrate and the subsequent transfer of the donor substrate material or colorant material to the material layer of the microlens sheeting 810.

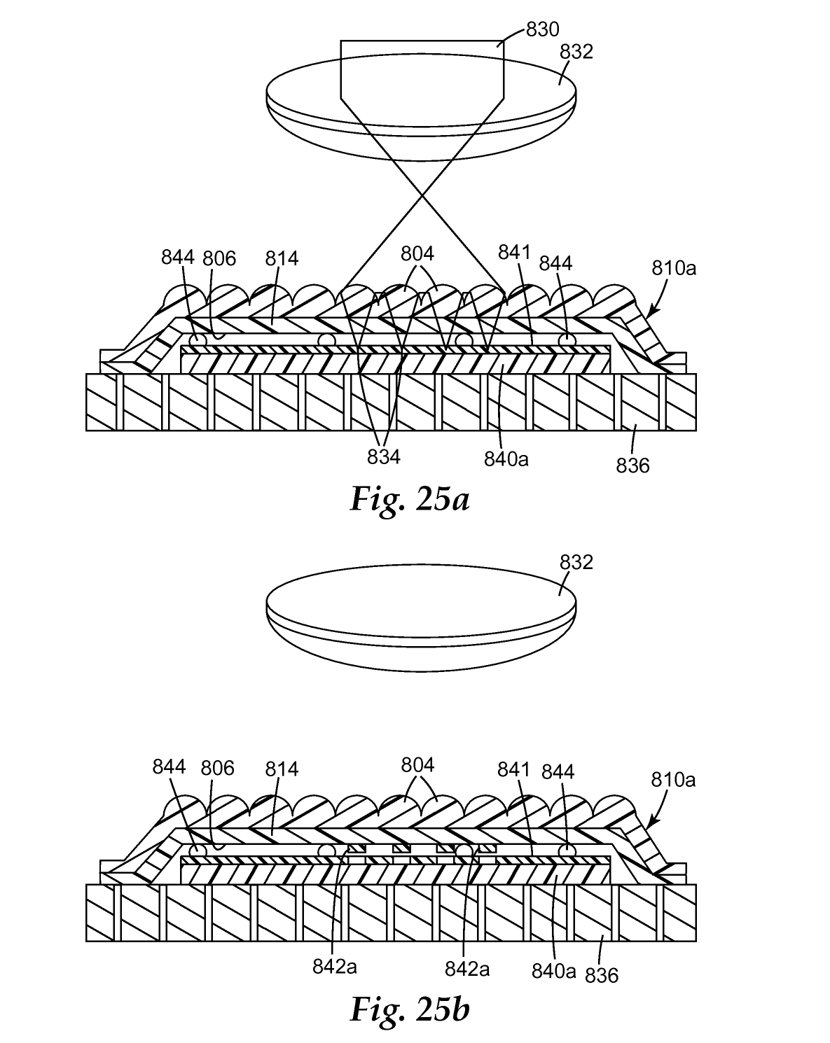

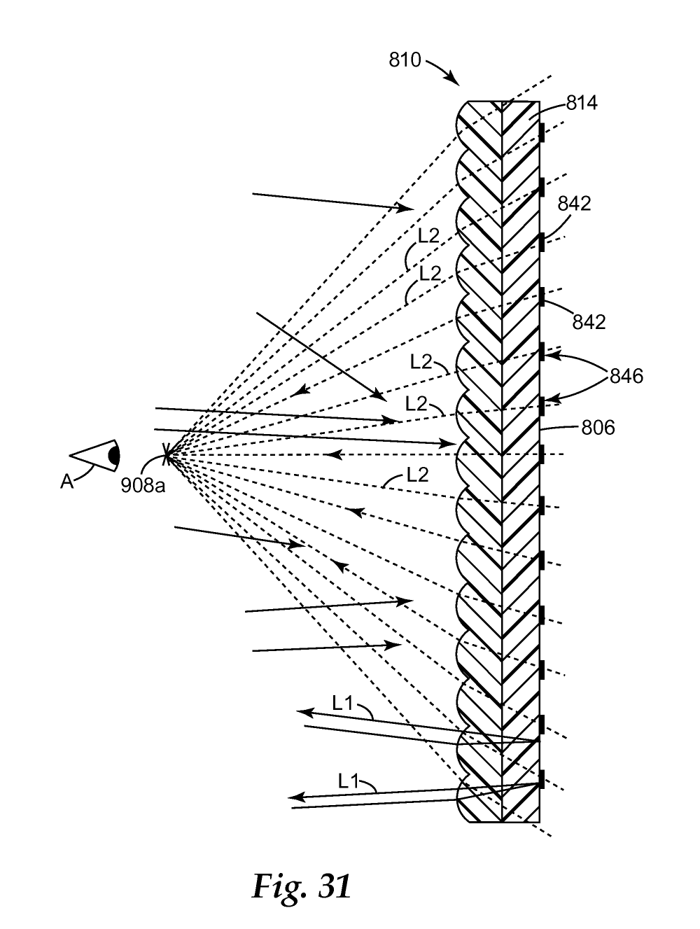

In one embodiment, the donor substrate includes colorants providing color within the visible spectrum, such as pigments, dyes, inks, or a combination of any or all of these to provide color composite floating images. The pigments or dyes may be phosphorescent or fluorescent. Alternatively, the colorants in the donor materials may also appear metallic. The color of the resulting floating image is generally similar to the color of the colorant in the donor substrate, if the transferred donor substrate components are thermally stable and only small chemical or compositional changes occur upon transfer. In addition, the color of the resulting composite floating image may be the same as the color of the colorant in the donor substrate. In yet another embodiment, the donor substrates may include macroscopic patterns of different colorants, such as stripes or zones of different colors throughout the substrate or multicolored substrates. In alternative embodiments, the donor substrate is not required to include colorants providing color in the visible spectrum, and instead, the resulting composite floating images would appear colorless. Such donor substrates could contain colorless fluorescing dyes or phosphorescent materials, creating composite images visible only during or after exposure to specific wavelengths, or in the case of phosphorescent materials, during and for a duration after exposure to the wavelengths. Alternatively, such donor substrates may contain colorless materials that may or may not have a refractive index different than the material layer 814. A composite image formed from such donor materials may be only slightly visible when viewed in ambient lighting as in FIG. 31; however, it may appear to shine brighter than the reflections off of the nonimaged area of surface 806 when viewed with light substantially perpendicular to surface 806. All donor substrates may optionally include additives that increase the substrate sensitivity to imaging radiation and ultimately aid in the transfer of the material, or said substrates may include a reflective and/or absorbing layer underneath at least the colorant to increase absorption of the radiation. FIG. 25a schematically illustrates one embodiment of the method of forming a composite image on the microlens sheeting 810 in accordance with the present invention. The method includes using a radiation source 830. Any energy source providing radiation of the desired intensity and wavelength may be used as radiation source 830 with the method of the present invention. In one embodiment, radiation devices capable of providing radiation having a wavelength of between 200 nanometers and 11 micrometers are preferred, and more preferably, between 270 nanometers and 1.5 micrometers. Examples of high peak power radiation sources useful for this invention include passively Q-switched microchip lasers, and the family of Q-switched Neodymium doped lasers, and their frequency doubled, tripled, and quadrupled versions of any of these lasers, and Titanium doped-sapphire (abbreviated Ti:sapphire) lasers. Other examples of useful radiation sources include devices that give low peak power such as laser diodes, ion lasers, non Q-switched solid state lasers, metal vapor lasers, gas lasers, arc lamps and high power incandescent light sources.

For all useful radiation sources, the energy from the radiation source 830 is directed toward the microlens sheeting material 810 and controlled to give a highly divergent beam of energy. For energy sources in the ultraviolet, visible, and infrared portions of the electromagnetic spectrum, the light is controlled by appropriate optical elements, known to those skilled in the art. In one embodiment, a requirement of this arrangement of optical elements, commonly referred to as an optical train, is that the optical train direct light toward the sheeting material with appropriate divergence or spread so as to produce a “cone” of radiation irradiating the microlenses at the desired angles, thus irradiating the donor material aligned to said microlenses. The composite images of the present invention are preferably obtained by using radiation spreading devices with numerical apertures (defined as the sine of the half angle of the maximum diverging rays) of greater than or equal to 0.3, although smaller numerical aperture illumination may be used. Radiation spreading devices with larger numerical apertures produce composite images having a greater viewing angle, and a greater range of apparent movement of the image. In alternative embodiments, the optical train may additionally contain elements to prevent radiation in an angular portion or portions of the cone of radiation. The resulting composite image(s) are only viewable over angles corresponding to the unblocked angular sections of the modified cone. Multiple composite images may be created at separate angular sections of the modified cone if desired. Using the modified cone and its inverse, one can produce a composite image that changes from one color to another as the sample is tilted. Alternatively, multiple composite images can be produced in the same area causing the individual images to appear and disappear as the sample is tilted.

An exemplary imaging process according to the present invention includes the following steps, as illustrated in FIGS. 25a and 25b. FIG. 25a illustrates the imaging process by the radiation source, and FIG. 25b illustrates the resulting sheeting 810 after the imaging process. First, a microlens sheeting 810 is provided, such as the microlens sheeting 810a, 810b, 810c illustrated in FIGS. 22-24. FIG. 25a illustrates the use of microlens sheeting 810a, however, microlens sheeting 810b or 810c may be used in the process. Next, a first donor substrate 840a is provided, such as the donor substrates described above. Next, the microlens sheeting 810 is positioned adjacent or orientated next to the donor substrate 840a, such that the microlens sheeting 810 is between the radiation source 830 and the donor substrate 840a. In one embodiment, the microlens sheeting 810 and donor substrate 840a are in close proximity to each other. In another embodiment, the microlens sheeting 810 and donor substrate 840a are in contact with one another or pressed against each other, for instance by gravity, mechanical means, or pressure gradients produced by a vacuum source 836, as illustrated in FIG. 25a. In yet another embodiment, microstructures 844 are between the microlens sheeting 810 and donor substrate 840a to provide a generally uniform gap or space between the microlens sheeting 810 and the donor substrate 840a. The microstructures 844 may be independent microstructures that are positioned between the microlens sheeting 810 and the donor substrate 840a. Examples of such independent microstructures 844 include polymethylmethacrylate spheres, polystyrene spheres, and silica spheres, all of which are commercially available from Esprix Technologies based in Sarasota, Fla. Alternatively, the microstructures 844 may extend from either the donor substrate 840a towards the microlens sheeting 810 or from the first side 806 of the layer of material 814 in the sheeting 810. Examples of suitable donor substrates 840 including such microstructures 844 include Kodak™ Approval media and Matchprint Digital Halftone media, commercially available from Kodak Polychrome Graphics located in Norwalk, Conn. Suitable microlens sheeting including such microstructures 844 are readily made, such as by replication, by those skilled in the art. Regardless, there is preferably a generally uniform spacing distance or gap between the microlens sheeting 810 and the donor substrate 840a which is determined and controlled by the size, spacing, arrangement and area coverage of microstructures 844. This generally uniform gap provides generally uniform registration between the top surface 841 of the donor substrate 840a and the focal points of the microlens optics 834.

Next, the method includes the step of transferring portions of donor material from the first donor material substrate 840a to the first side 806 of the layer of material 814 of the sheeting 810 to form individual, partially complete images on the first side 806 of material layer 814, as illustrated in FIG. 25b. In one embodiment of the inventive method illustrated in FIGS. 25a and 25b, this transfer is obtained by directing collimated light from a radiation source 830 through a lens 832 toward the microlens sheeting 810. The radiation source 830 is focused through the lens 832, through the microlens sheeting 810 and to the donor substrate 840a. The focal point 834 of the microlens 804 is approximately at the interface between the donor substrate 840a and the first side 806 of material layer 814 in the microlens sheeting 810 as illustrated in FIG. 25a. The donor material of substrate 840a absorbs incident radiation near the focal point 834 of the microlenses 804 on sheeting 810a. The absorption of the radiation induces the donor material of donor substrate 840a to transfer to the first side 806 of material layer 814 on sheeting 810a creating image pixels of donor material 842a that comprise the partially complete images corresponding to microlenses 804 of sheeting 810a as illustrated in FIG. 25b. In alternative embodiments of this process where the first side 806 of material layer 814 on sheeting 810a is in close proximity to the donor material 840a or adhered to the donor material 840a, transfer mechanisms such as radiation-induced diffusion and preferential adhesion (melt-stick process) producing image pixels of donor material 842a that comprise the partially complete images corresponding to microlenses 804 of sheeting 810a are also possible. The transferred donor material 842a may have experienced a change in its chemical or composition or component concentrations. These individual, partially complete images made from the donor material 842a together provide the composite floating image, which appears to the unaided eye to float above or below the sheeting 810 or both, as described further below.

Because each individual microlens 804 occupies a unique position relative to the optical axis, the radiation impinging on each microlens 804 will have a unique angle of incidence relative to the radiation incident on each other microlens. Thus, the light will be transmitted by each microlens 804 to a unique position relative to its specific microlens 804 on the donor substrate 840a close to focal point 834, and produces a unique image pixel of a partially complete image of donor materials 842a on the first side 806 of the layer of material 814 corresponding to each microlens 804. More precisely, a single light pulse produces only a single imaged dot of donor material 842a behind each properly exposed microlens 804, so to provide a partially complete image adjacent each microlens on the first side 806 of the material layer 814 of the sheeting 810. Multiple radiation pulses, or a quickly traversing, continuously illuminating, radiation beam may be used to create the image. For each pulse, the focal point of lens 832 is located at a new position relative to the position of the focal point 834 during the previous pulse relative to the microlensed sheeting. These successive changes in the position of the focal point 832 of the lens 832 relative to the microlenses 804 results in a corresponding change in the angle of incidence upon each microlens 804, and accordingly, in the position of the imaged pixel of the partially complete image of donor material 842a created on the material layer 814 of the sheeting 810 with the donor material 842 by that pulse. As a result, the radiation incident on the donor substrate 840a near focal point 834 causes transfer of a selected pattern of the radiation sensitive donor material 842a. Because the position of each microlens 804 is unique relative to every optical axis, the partially complete image formed by the transferred radiation sensitive donor material 842a for each microlens will be different from the image associated with every other microlens, because each microlens “sees” the incoming radiation from a different position. Thus, a unique image is formed associated with each microlens with the donor material 842a from the donor substrate on the material layer 814.

Another method for forming floating composite images uses a divergence creating target such as a lens array to produce the highly divergent light to image the microlensed material. For example, the lens array could consist of multiple small lenses all with high numerical apertures arranged in a planar geometry. When the array is illuminated by a light source, the array will produce multiple cones of highly divergent light, each individual cone being centered upon its corresponding lens in the array. The physical dimensions of the array are chosen to accommodate the largest lateral size of a composite image. By virtue of the size of the array, the individual cones of energy formed by the lenslets will expose the microlensed material as if an individual lens was positioned sequentially at all points of the array while receiving pulses of light. The selection of which lenses receive the incident light may occur by the use of a reflective mask, diffractive pattern generator, or by individually illuminating specific locations of the target with a low numerical aperture radiation beam. This mask will have transparent areas corresponding to sections of the composite image that are to be exposed and reflective areas where the image should not be exposed. Due to the lateral extent of the lens array, it may not be necessary to use multiple light pulses to trace out the image.

By having the mask fully illuminated by the incident energy, the portions of the mask that allow energy to pass through will form many individual cones of highly divergent light outlining the floating image as if the image was traced out by a single lens. As a result, only a single light pulse is needed to form the entire composite image in the microlens sheeting. Alternatively, in place of a reflective mask, a beam positioning system, such as a galvanometric xy scanner, can be used to locally illuminate the lens array and trace the composite image on the array. Since the energy is spatially localized with this technique, only a few lenslets in the array are illuminated at any given time. Those lenslets that are illuminated will provide the cones of highly diverging light needed to expose the microlensed material to form the composite image in the sheetings.

After imaging, depending upon the desirable viewable size of the composite image, a full or partially complete image will be present on the first side 806 of material layer 814 of the sheeting 810 behind each sufficiently exposed microlens formed from the donor material 842a. The extent to which an image is formed behind each microlens 4 on the material layer 814 depends on the energy incident upon that microlens. Portions of an intended image may be distant enough from a region of microlenses that the radiation incident upon those microlenses has an energy density lower than the level of radiation required to transfer corresponding donor material 842. Moreover, for a spatially extended image, when imaging with a fixed NA lens, not all portions of the sheeting will be exposed to the incident radiation for all parts of the intended image. As a result, portions of the intended image will not result in transferred radiation sensitive material, and only a partial image of the intended image will appear behind those microlenses on the material layer 814.

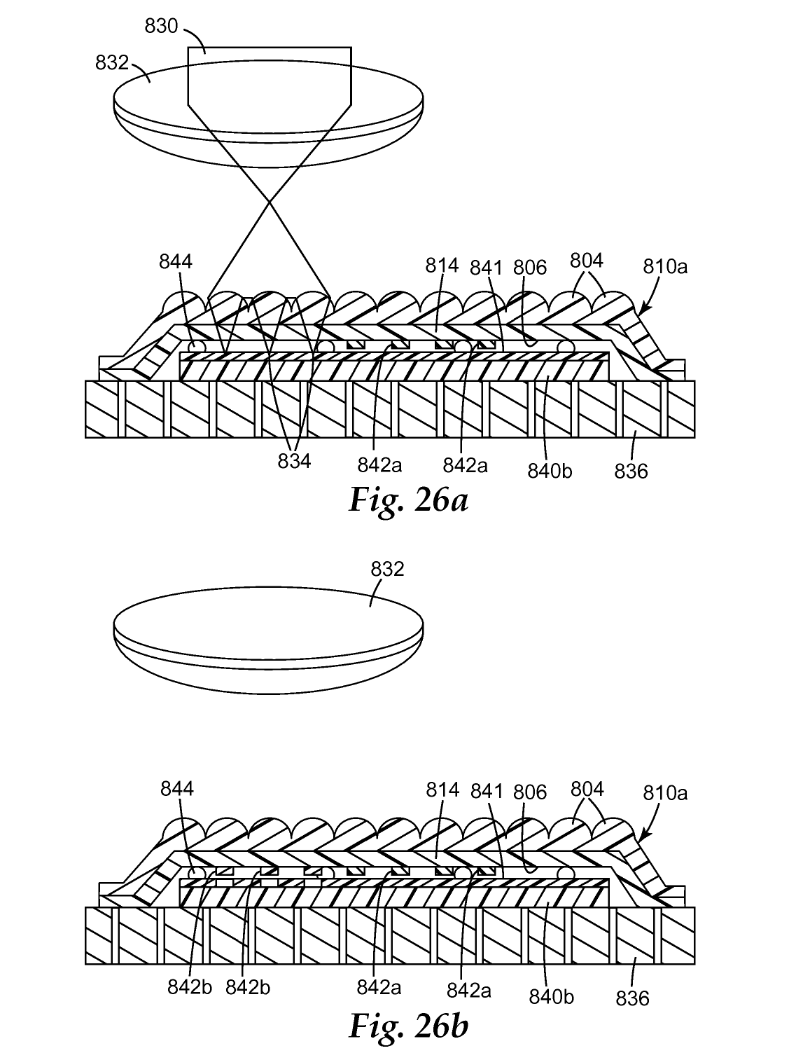

In FIG. 25b, a first donor substrate 840a is used to create individual partially complete images of donor material 842a on the sheeting 810. After the sheeting 810 has been imaged using the first donor substrate 840a, the first donor substrate 840a may be removed, and replaced with a second donor substrate 840b, as illustrated in FIG. 26a. The method described above and illustrated in FIGS. 25a and 25b is then repeated as illustrated in FIGS. 26a and 26b, respectively. The second donor substrate 840b is used to create images of donor material 842b on the sheeting 810. In one embodiment, the second donor substrate 840b includes a colorant that is different from the colorant in the first donor substrate 840a. This allows a user to form a composite image that consists of two different colors. That is, the composite image is multicolored, or has portions that are one color and portions that are a different color. Alternatively, the first and second donor substrates 840a, 840b, could be used to form two separate differently colored composite floating images, for example, as illustrated in FIG. 28. Alternatively, the colorants from the first and second donor substrates 840a, 840b may result in a composite image formed from the mixture of the two colorants. In another embodiment, the colorants in the first and second donor substrates 840a, 840b could include the same colorant. Any number of donor substrates 840 may be used to image the microlens sheeting 810 to form any number of floating composite images in a variety of different color combinations on a single sheeting 810.

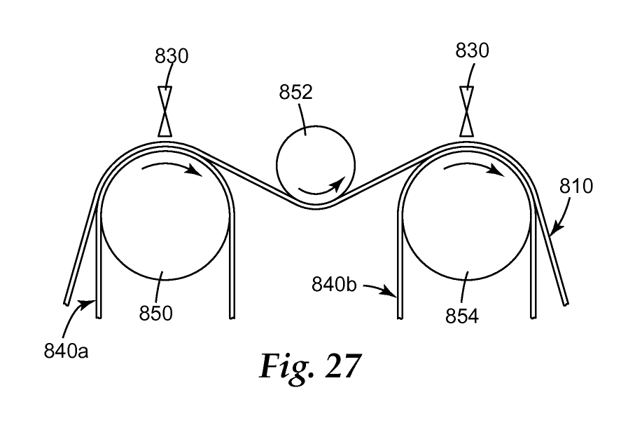

FIG. 27 illustrates one embodiment of a roll-to-roll apparatus, which is convenient for imaging the microlens sheeting 810 with a first donor substrate 840a and then imaging the microlens sheeting 810 with a second donor substrate 840b. The apparatus includes a first roll 850, a second roll 854, and an idle roll 852. Stationed above each roll 850, 854 is a radiation source 830 with an appropriate optical train, as described above. The first donor material 840a wraps around the first roll 850, and the second donor material 840b wraps around the second roll 854. As the microlens sheeting 810 moves through the apparatus, it first is pressed against the first donor substrate 840a and roll 850, as it is imaged by the radiation source 830 in the same manner as described above in reference to FIGS. 25a and 25b. Next, the sheeting 810 moves from the first roll 850 and consequently, away from the first donor material 840a. Next, the microlens sheeting 810 continues moving around the idle roll 852 and is pressed against the second donor substrate 840b and roll 854, as it is imaged by the radiation source 830 in the same manner as described above in reference to FIGS. 26a and 26b. The microlens sheeting 810 is pulled from the second roll 854 and consequently, away from the second donor material 840b. The resulting microlens sheeting 810 will have donor materials from both the first and second donor substrates 840a, 840b imaged onto the first side 806 of the layer of material 814 of the microlens sheeting 810. The apparatus may include any number of rolls and radiation sources for depositing donor material from multiple donor substrates 840 onto the microlens sheeting 810 to form multiple composite floating images on the sheeting 810.

FIGS. 28 and 29 show a microlens sheeting 810 imaged according to one embodiment of the method of this invention, using two radiation sensitive donor substrates 840 to create multiple composite images of different colors. FIG. 29 is a magnified optical profile of the first side 806 of material layer 814 on sheeting 810 shown in 28. The sheeting 810 includes a first composite image 860a that floats below the sheeting that appears as a double circle in the color of black and a second composite image 860b of a “3M” outline, also in the same color of black located inside the double circle, that floats above the sheeting. The sheeting 810 also includes a third composite image 860c that floats below the sheeting that appears as a double circle in the color of purple and a fourth composite image 860d of a “3M” outline, also in the same color of purple located inside the double circle, that floats above the sheeting. The sheeting 810 was imaged with a first donor substrate having colorants of black. The sheeting 810 was then imaged with a second donor substrate having colorants of purple.

A portion of the section A that is indicated in FIG. 28 corresponds to the bottom view of sheeting 810 (i.e., first side 806 of material layer 814) in FIG. 29. Specifically, FIG. 29 illustrates a magnified view of the individual, partially complete images 846 that together provide the intersection of the black and purple double circles of composite images 860a and 860c that appear to float below the sheeting in accordance with the present invention; (indicated in section A of FIG. 28).

The image 846 has two portions, a first portion 864 of black donor material 842a, and a second portion 866 of purple donor material 842b. Each image 846 corresponds generally to an individual microlens. The images 846 in FIG. 29 range in size from 24.5 to 27 um, however a range of other sizes are possible. FIG. 29 is convenient for illustrating the elevation of the donor materials above the surface of the material layer 814, as well as the impact upon the elevation level of the material layer 814 immediately adjacent the transferred donor material 842. The dark portions around the portions 864, 866 of the donor materials 842a, 842b indicate that the material layer 814 around those portions has been melted or its temperature was raised past its glass transition temperature, and as a result, its associated elevation is 0.1-0.2 um below the plane of the first side 806 of material layer 814. These “divots” are created around the donor materials 842a, 842b as a result of the method of making, and possibly may serve to help enhance the image 860. The overall height of the donor material 842a, 842b ranges from approximately 0.1 to 0.75 um above the plane of the first side 806 of material 814 of the sheeting 810, however a range of other heights are possible.

These composite floating images 860 can also be thought of as the result of the summing together of many images 846, all with different perspectives of a real object. The many unique images are formed through an array of miniature lenses, all of which “see” the object or image from a different vantage point. Behind the individual miniature lenses, a perspective of the image is created by the donor material on the material layer that depends on the shape of the image and the direction from which the imaging energy source was received. In some embodiments of the method of the present invention, only that portion of the image or object seen by the lens that has sufficient energy to result in the transfer of some of the radiation sensitive donor material will be recorded. Portions of the image or object that correlate to the lens being exposed to a correspondingly greater energy level may generally result in a greater amount of donor material being transferred, i.e. may result in images 846 that have a greater elevation above the first side 806 of the material layer 814 of the sheeting 810.

The “object” to be imaged is formed through the use of an intense light source by either tracing the outline of the “object” or by the use of a mask. For the image thus recorded to have a composite aspect, the light from the object must radiate over a broad range of angles. When the radiation from an object is coming from a single point of the object and is radiating over a broad range of angles, all the radiation rays are carrying information about the object, but only from that single point, though the information is from the perspective of the angle of the radiation ray. Now consider that in order to have relatively complete information about the object, as carried by the radiation rays, light must radiate over a broad range of angles from the collection of points that constitute the object. In this invention, the range of angles of the radiation rays emanating from an object is controlled by optical elements interposed between the radiation source and the microlens sheeting. These optical elements are chosen to give the optimum range of angles necessary to produce a composite image. The best selection of optical elements results in a cone of radiation whereby the vertex of the cone terminates at the position of the object.

Geometric optics will be used to describe the formation of various composite images according to the present invention. As noted previously, the imaging processes described below are preferred, but not exclusive, embodiments of the invention.

As noted above, a preferred manner of providing the image patterns on the layer of material adjacent the microlenses is to use a radiation source to transfer a radiation sensitive donor material which is placed adjacent the material layer of the microlens sheeting to form an image on the material layer.

A. Creating a Composite Image that Floats Above the Sheeting

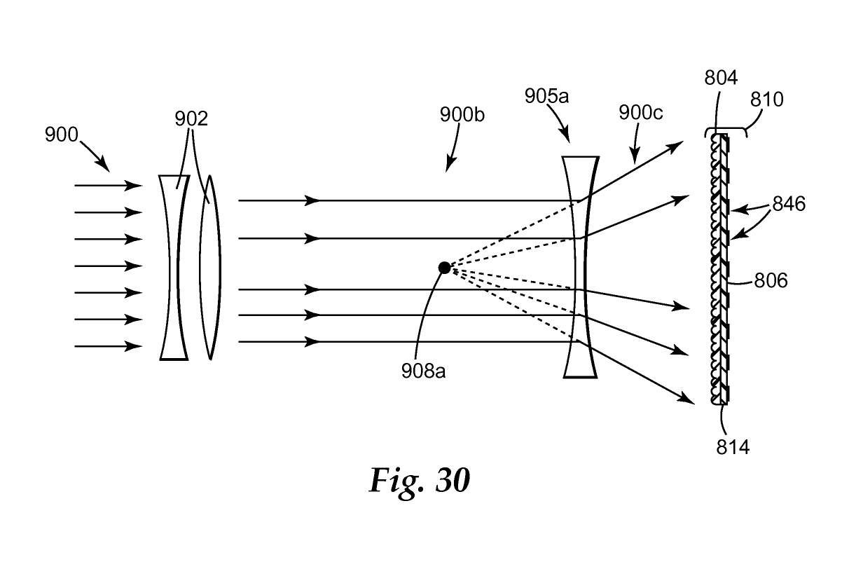

Referring to FIG. 30, incident radiation 900 (light, in this example) is directed and collimated by optics 902 that directs the light 900b towards a diverging lens 905a. From the diverging lens, the light rays 900c diverge toward the microlens sheeting 810.

The energy of the light rays impinging upon the microlens sheeting 810 is focused by the individual microlenses 804 approximately at the interface between the material layer 14 and a donor substrate (not shown). This focused radiation results in the transfer of at least a portion of the radiation sensitive material and/or the colorant in the donor substrate to provide images 846 on the surface 806 of material layer 814, the size, shape, and appearance of which depends on the interaction between the light rays, the microlenses, and the radiation sensitive donor substrate.

The arrangement shown in FIG. 31 would provide a sheeting having a composite image that appears to an observer to float above the sheeting as described below, because diverging rays 900c, if extended backward through the lens, would intersect at the focal point 908a of the diverging lens. Stated differently, if a hypothetical “image ray” were traced from the material layer through each of the microlenses and back through the diverging lens, they would meet at 908a, which is where a portion of the composite image appears.

B. Viewing a Composite Image that Floats Above the Sheeting

A sheeting that has a composite image may be viewed using light that impinges on the sheeting from the same side as the observer (reflected light), or from the opposite side of the sheeting as the observer (transmitted light), or both. FIG. 31 is a schematic representation of a composite image that appears to the unaided eye of an observer A to float above the sheeting when viewed under reflected light. An unaided eye may be corrected to normal vision, but is not otherwise assisted by, for example, magnification or a special viewer. When the imaged sheeting is illuminated by reflected light, which may be collimated or diffuse, light rays are reflected back from the imaged sheeting in a manner determined by the donor material 842 in the individual images 846 struck by the light rays. By definition, the images formed by the donor material 842 appear different than the non-imaged portions of the material layer 814 where no donor material 842 is present, and thus an image can be perceived.

For example, portions (e.g. a specific wavelength range) of the light L1 may be reflected by the donor material 842 back toward the observer, the summation of which creates a colored composite image that appears to float above the sheeting, a portion of which is shown at 908a. In short, specific portions of the visible electromagnetic spectrum can be reflected from the imaged portions 846 or reflected from a laminate substrate such as a passport (not shown) and absorbed or scattered by imaged portions 846, which means that a portion of a colored composite image will be apparent at 908a. However, the donor material 842 may not reflect light L2 back toward the observer well, or at all, or it may significantly absorb light reflected from a laminate surface and subsequently transmitted through the donor material 842. Thus, the observer may detect the absence of light rays at 908a, the summation of which creates a black composite image that appears to float above the sheeting, a portion of which appears at 908a. In short, light may be partially reflected from the entire sheeting or highly reflected from a laminate behind the sheeting except the imaged portions 846, which means that a relatively dark composite image will be apparent at 908a.

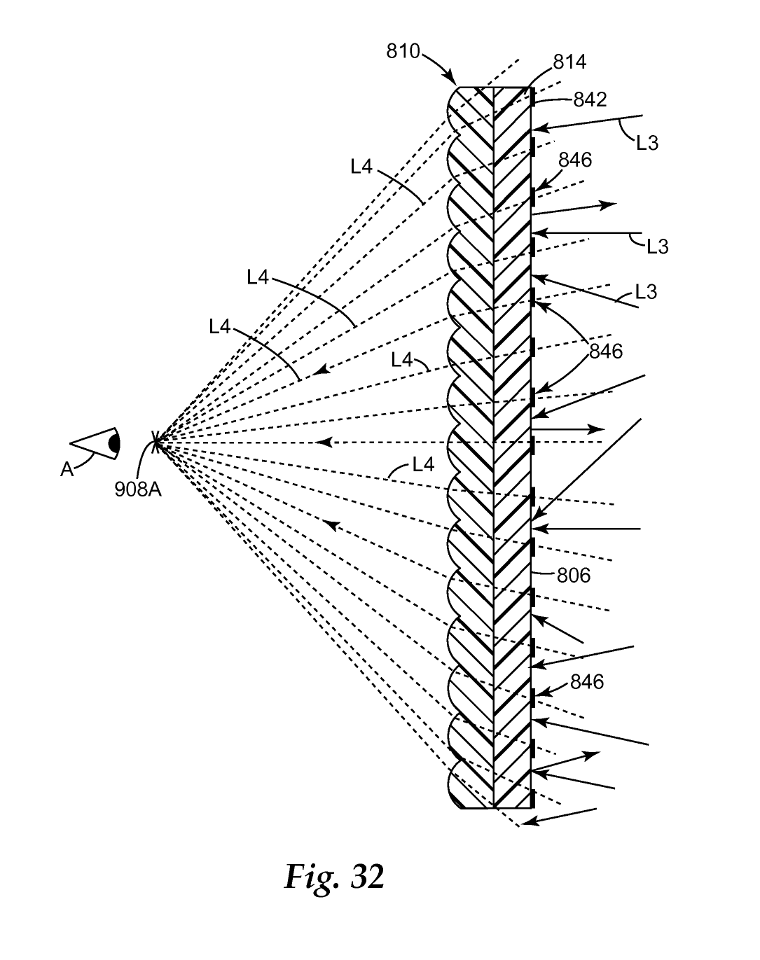

It is also possible that the imaged material 842 would reflect or partially absorb incident light, and a dark laminate (not shown) placed adjacent to the imaged portions 846 would absorb the light to provide the contrast effect required to provide a composite image. The composite image under those circumstances would appear as a relatively bright composite image in comparison to the remainder of the sheeting with laminate (not shown), which would appear relatively dark. Various combinations of these possibilities can be selected as desired. Certain imaged sheetings can also be viewed by transmitted light, as shown in FIG. 32.

For example, when the imaged portions of the donor material 842 on the material layer 814 are translucent and absorb portions of the visible spectrum, and the nonimaged portions are transparent or translucent, but highly transmissive, then some light L3 will be selectively absorbed or reflected by the donor material 842, and directed by the microlenses toward the focal point 908a. The composite image will be apparent at the focal point, where it will, in this example, appear darker and colored compared to the remainder of the sheeting.

C. Creating a Composite Image that Floats Below the Sheeting

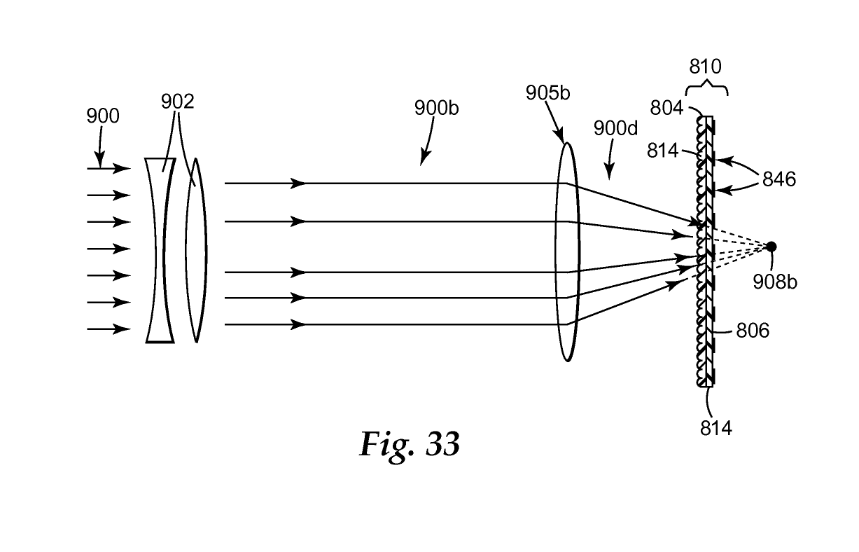

A composite image may also be provided that appears to be suspended on the opposite side of the sheeting from the observer. This floating image that floats below the sheeting can be created by using a converging lens instead of the diverging lens 905 shown in FIG. 30. Referring to FIG. 33, the incident energy 900 (light, in this example) is directed and collimated in a collimator 902 that directs the light 900b toward a converging lens 905b. From the converging lens, the light rays 900d are incident on the microlens sheeting 810, which is placed between the converging lens and the focal point 908b of the converging lens.

The energy of the light rays impinging upon the microlens sheeting 810 is focused by the individual microlenses 804 approximately into the interface area between the material layer 814 and a radiation sensitive donor substrate (not shown). This focused radiation transfers a portion of the radiation sensitive material in the donor substrate to provide images 846 made from the donor material 842, the size, shape, and appearance of which depends on the interaction between the light rays, the microlens sheeting, and the donor substrate. The arrangement shown in FIG. 33 would provide a sheeting 810 having a composite image that appears to an observer to float below the sheeting as described below, because converging rays 900d, if extended through the sheeting, would intersect at the focal point 908b of the diverging lens. Stated differently, if a hypothetical “image ray” were traced from the converging lens 905b through each of the microlens and through the images on the material layer formed from the donor material 842 associated with each microlens, they would meet at 908b, which is where a portion of the composite image appears.

D. Viewing a Composite Image that Floats Below the Sheeting

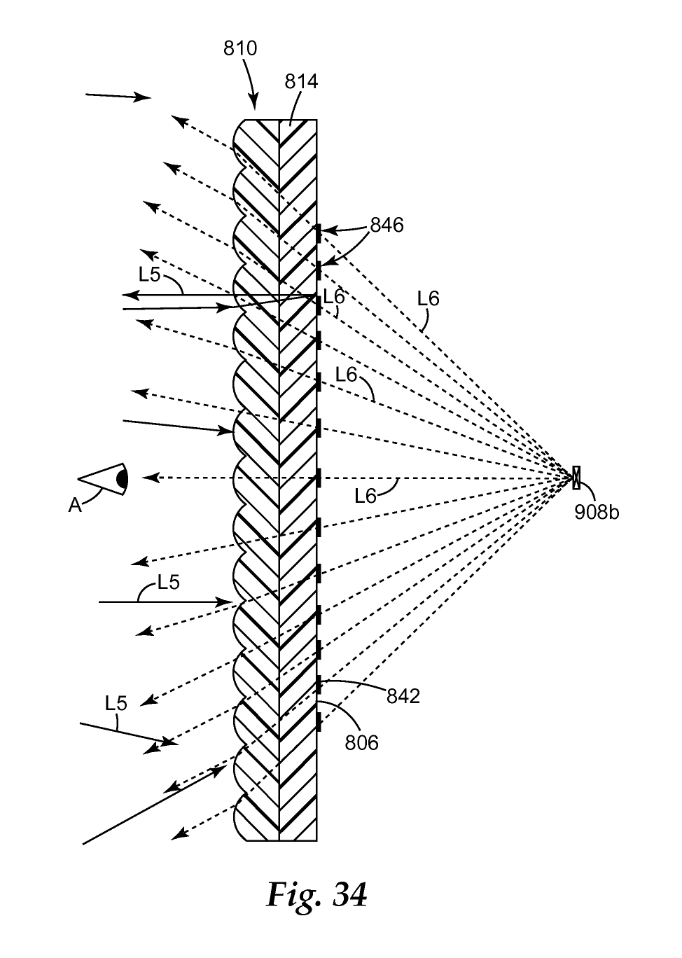

Sheeting having a composite image that appears to float below the sheeting can also be viewed in reflected light, transmitted light, or both. FIG. 34 is a schematic representation of a composite image that appears to float below the sheeting when viewed under reflected light. For example, portions of the visible spectrum of light L5 may be reflected by the donor material 842 on the material layer 814 back toward the observer. Thus, the observer may detect the presence of colored light rays which appear to originate from 908b, the summation of which creates a colored composite image that appears to float below the sheeting, a portion of which appears at 908b. In short, light may be reflected primarily from the imaged portions 846, which means that a darker colored composite image will be apparent at 908b. Alternatively, the incident light may be reflected by a laminate behind the material layer, portions of which are subsequently absorbed or scattered by the donor material 842, and travel back toward the observer. Thus, the observer may detect the presence of colored light rays which appear to originate from 908b, the summation of which creates a colored composite image. In short, light may be reflected from a laminate behind the material layer and absorbed by imaged portions 846, which means that a darker colored composite image will be apparent at 908b.

It is also possible that the laminate behind the material layer would absorb incident light, and that the donor material 842 would reflect or partially absorb incident light, respectively, to provide the contrast effect required to provide a composite image. The composite image under those circumstances would appear as a relatively bright composite image in comparison to the remainder of the sheeting, which would appear relatively dark. Various combinations of these possibilities can be selected as desired.

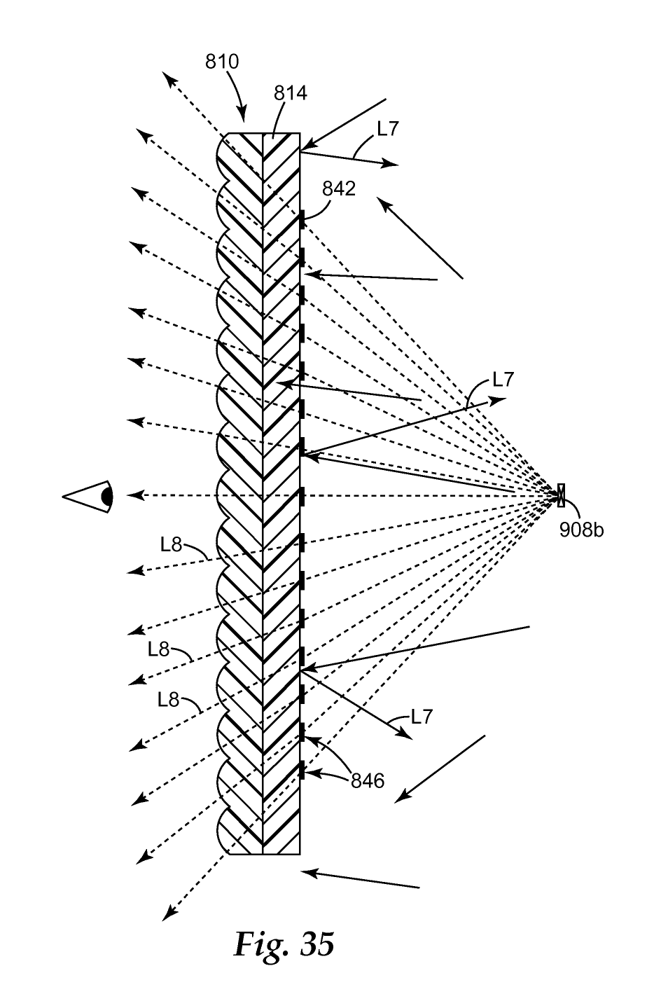

Certain imaged sheetings can also be viewed by transmitted light, as shown in FIG. 35. For example, when the imaged portions on the material layer 814 of donor material 842 are translucent and color absorbing and the nonimaged portions where no donor material 842 is present are transparent, then specific portions of the visible spectrum of light L7 will be absorbed or reflected by the donor material 842, while transmitted light L8 will be passed through the remaining portions on the material layer. The extension of those rays, referred to herein as “image rays,” back in the direction of the incident light results in the formation of a composite image, a portion of which appears at 908b. The composite image will be apparent at the focal point, where, it will, in this example, appear darker and colored while the sheeting appears transparent.

Alternatively, if the imaged portions of donor material 842 on the material layer 814 are not translucent but the remainder of the material layer 814 is, then the absence of transmitted light in the areas of the images will provide a composite image that appears darker than the remainder of the sheeting.

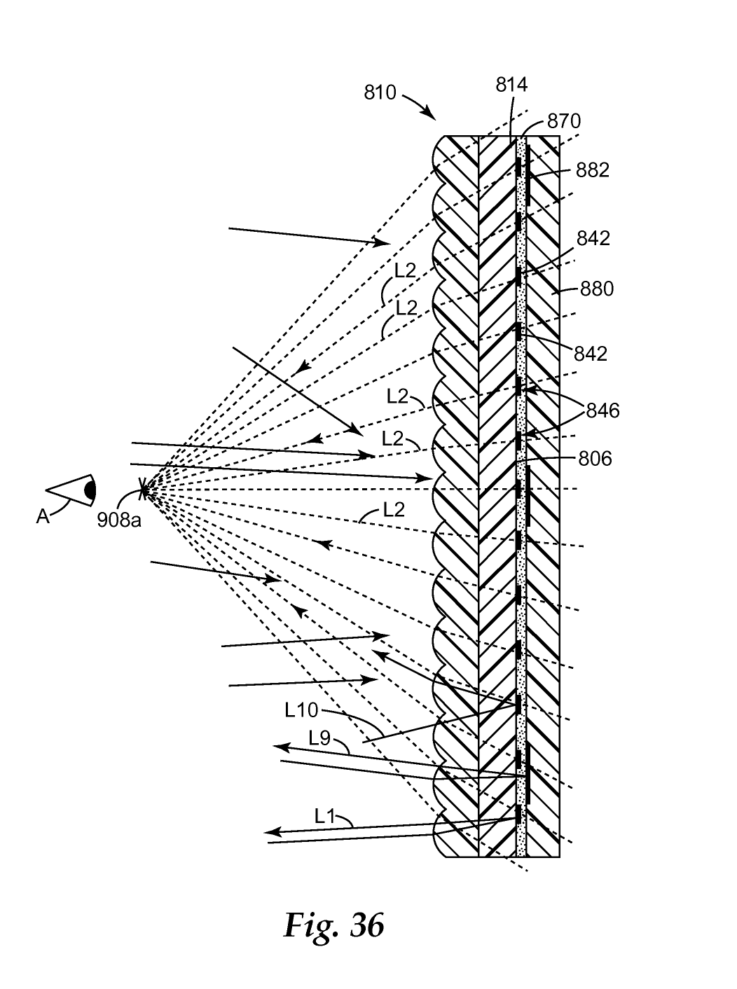

FIG. 36 illustrates the sheeting 810 of FIG. 31 adhered to a substrate or laminate 880. The sheeting 810 may be attached to substrate 880 by a layer of adhesive 870, as illustrated. Alternatively, the sheeting 810 may be integrally formed or embedded into substrate 880. The substrate 880 could be a document, a sign, an identification card, a container, currency, a display, a credit card, or any other form of substrates. The sheeting 810 attached to the substrate 880 could be used for advertising, decoration, authentication, identification purposes, or for any other intended purpose. The substrate 880 may include additional information 882, which may be printed on the substrate 880, which may also be viewable by an observer in addition to the composite image 908a. For example, portions (e.g. a specific wavelength range) of the light L9 may be reflected by the substrate 880 back toward the observer. Light L10 may be reflected off the transferred donor material 842 making the composite image visible to the viewer, along with the embedded or covered graphics 882.

The substrate 880 may be translucent, transparent, or opaque, or any combination thereof. In another embodiment, the microlens sheeting 810 may include portions with microlenses 804 and portions without microlenses. The portion of the sheeting without microlenses may be used for viewing other portions of the microlens sheeting 810 or for viewing portions of a substrate that the microlens sheeting is attached to. Alternatively, a window could include microlenses and the portion around the microlenses, such as a border, may not include microlenses. For example, in one embodiment, the substrate window may be where the substrate is translucent or transparent.

Composite images made in accordance with the principles of the present invention may appear to be either two-dimensional, meaning that they have a length and width, and appear either below, or in the plane of, or above the sheeting, or three-dimensional, meaning that they have a length, width, and height. Three-dimensional composite images may appear below or above the sheeting only, or in any combination of below, in the plane of, and above the sheeting, as desired. The term “in the plane of the sheeting” refers only generally to the plane of the sheeting when the sheeting is laid flat. That is, sheeting that isn't flat can also have composite images that appear to be at least in part “in the plane of the sheeting” as that phrase is used herein.

Three-dimensional composite images do not appear at a single focal point, but rather as a composite of images having a continuum of, or discrete focal points, with the focal points ranging from one side of the sheeting to or through the sheeting to a point on the other side. This is preferably achieved by sequentially moving either the sheeting or the radiation source relative to the other (rather than by providing multiple different lenses) so as to transfer the donor material adjacent the material layer at multiple focal points to produce images 846 on the surface 806 of material layer 814. The resulting spatially complex image essentially consists of many individual dots. This image can have a spatial extent in any of the three cartesian coordinates relative to the plane of the sheeting.

In another type of effect, a composite image can be made to move into a region of the microlensed sheeting where it disappears. This type of image is fabricated in a fashion analogous to the floating image examples with the addition of placing an opaque mask in front of the microlensed materials to partially block the imaging light for part of the microlensed material. When viewing such an image, the image can be made to move into the region where the imaging light was either reduced or eliminated by the contact mask. The image seems to “disappear” in that region.

In another type of effect, a composite image can be made to change color as viewing angle is changed. This type of image is fabricated in one of several ways, such as blocking an angular portion of the imaging radiation cone for the first donor. The same virtual image is then re-imaged with a second donor with a different colorant, blocking only the portion of the previously unblocked cone.

Images formed by the process of this invention can also be constructed that have a restricted viewing angle. In other words, the image would only be seen if viewed from a particular direction, or minor angular variations of that direction.

### III. Exemplary Methods of Laser-Engraving and Laser Imaging a Security Article

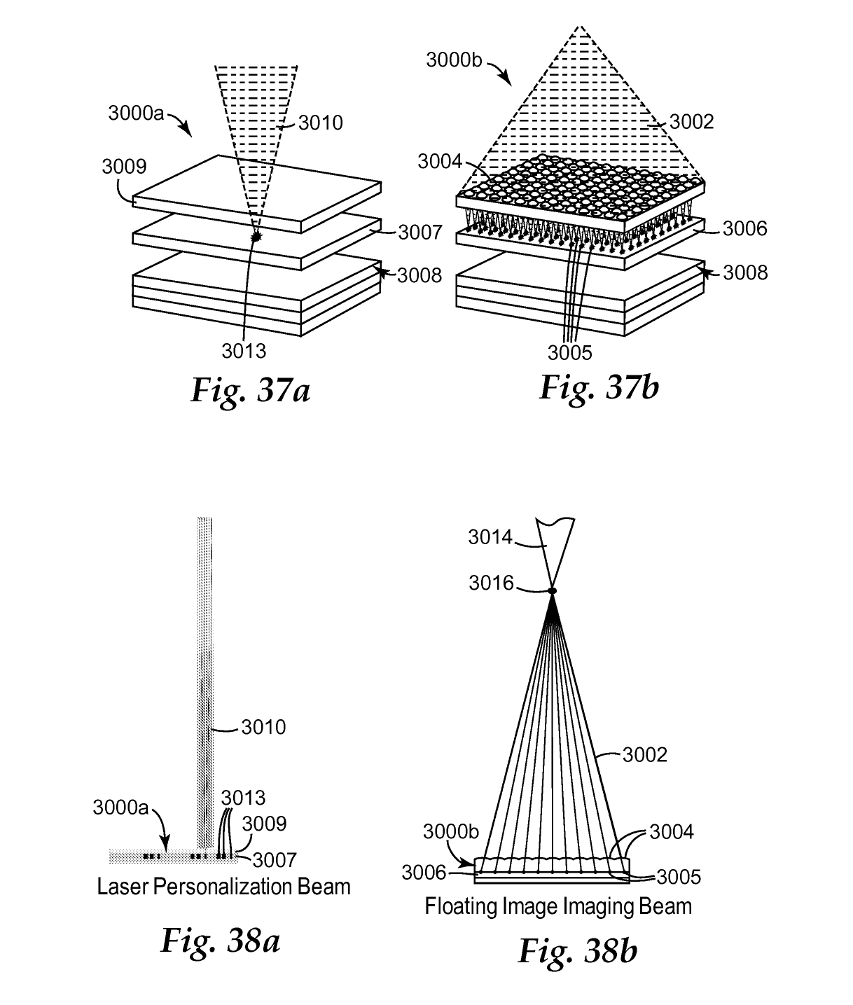

FIGS. 37a-b and 38a-b are convenient for generally illustrating exemplary methods of laser engraving and laser imaging the security article of the present invention. FIGS. 37a and 38a illustrate the method of laser engraving an indicia 3013 into a first section or portion 3000a of a laminated article 3000. FIGS. 37b and 38b illustrate the method of laser imaging a partially complete image 3005 into a second section or portion 3000b of laminated article 3000. First section 3000a and second section 3000b may be different portions of security article 3000, as illustrated in FIG. 42. FIG. 37a is an enlarged view of the laser beam 3010 and section 3008 of FIG. 38a. FIG. 37b is a close up view showing the interaction of the laser beam 3002 and section 3000b with the microlenses 3004 of FIG. 38b. In FIGS. 37a and 37b, some of the layers of laminate 3000 are shown separated for illustration purposes.

FIGS. 37a and 37b are convenient for illustrating the various layers in a laminated article 3000, such as a security article.

In section 3000a of the security article, the security article may include a protective top layer 3009, a laser engravable layer 3007, and an article core 3008. One suitable example of the laser engravable layer includes laser engravable polycarbonate (PC), such as polycarbonate security films commercially available from 3M Company located in St. Paul Minn. However, other commercially available laser engravable polycarbonate from other sources may also be suitable, or other laser engravable polycarbonate known to those skilled in the art. Laser engravable polycarbonate usually includes an additive that absorbs laser energy and converts that energy to heat which chars the polycarbonate immediately surrounding the additive, as discussed below relative to FIGS. 37a and 38a. The layers illustrated in FIGS. 37a and 38a are laminated together as described herein, and may be laminated by other methods known to those skilled in the art.

In section 3000b of the security article, the security article may include a layer of microlenses 3004, a layer of material 3006, and an article core 3008. Detailed information about the microlenses 3004 and layer of material 3006 are provided above in sections I and II. As one example, the layer of material 3006 may be a radiation sensitive layer 3006. If the article 3000 is an identification card, for example, then the core is an identification card core 3008. The security article may include other layers not illustrated.

As illustrated in FIGS. 37a and 38a, the laser personalization process for laminated security articles, such as passports or identification cards, includes absorption of a slowly focused laser beam 3010 by an absorbing laser engraveable layer 3007, such as a polymer layer, which is incorporated as one of the interior layers of a first section 3000a of the laminated article 3000. Deposition of energy from the laser beam 3010 results in decomposition of the polymer 3007 in an extended volume around the laser focal point to produce a charred, darkened or blackened spot of polycarbonate, which provides a laser engraved spot with the desired contrast compared to the colorless, unexposed polymer around it. A set of personal information to be included on the identification card, i.e. name, address, hair color, eye color, birth date, or a digital photograph, is “written” by moving the laser beam 3010 in the appropriate pattern around the identification card, usually using a galvanometer-based scanner.

FIG. 38a illustrates one exemplary method for laser engraving indicia into security article section 3000a. As mentioned above, the laser light ray 3010 impinges on a lens-free surface of article section 3000a, such that its focus is approximately located at the surface of the laser engraveable layer 3007 of the article section 3000a. The light ray 3010 is moved across the surface of the article typically using a galvanometer scanner, delivering light energy to the area of the article that the laser light is then impinging, such that indicia 3013 are burned or charred into the article. If different levels of light energy are used within a laser-engraved indicia, different darkness levels may result, which may produce a gray-scale indicia. The laser-engraved indicia may include personalization data such as date of birth, address, or a digital picture of the bearer of the article, or article-specific data such as country of origin, issuer, or currency denomination.

Security articles such as polycarbonate data pages in passports and identification cards are made by laminating together several layers of film, where some layers may contain various security features, at least one example being a laser-engravable polycarbonate film. As is known to those skilled in the art, this lamination process is typically done at temperatures of 150-175 C and at pressures up to 350 N/cm². These conditions result in the solid-state interdiffusion of the polymer chains in the constituent films to produce a molecular level bond between card layers. To say it another way, the conditions result in the fusion of the layers to form a single monolith. One of the benefits of this aspect is that the cards are therefore difficult to disassemble without producing noticeable damage. The location of the laser written indicia information, in one of the interior layers of this monolith, is the reason that laser engraved personalization is often considered to be forgery proof by those skilled in the art. Often, as is known to one skilled in the art, the lamination process may include the use of customized lamination plates on either side of the security articles as they are fused together. If the customized lamination plates contain surface impressions of the appropriate dimension and shape, and the surface of the security article is heated above its softening point during the lamination process, it is possible that the negative of the surface impression can be embossed into the surface of the security article. In this way, lenses can be formed on the surface of the article during the lamination process. This aspect is discussed in more detail in above sections.

FIG. 37b illustrates one exemplary method for creating a laser engraved composite image. Light ray 3002 impinges on laminated article 3000b such that microlenses 3004 of the sheeting focus light ray 3002 to a position within radiation sensitive layer 3006 to form partially complete images 3005. In one embodiment, the focal length of the lenses 3004 on the sheeting should be no longer than the thickness of the lens sheeting 3004. In another embodiment, the focal length of the lenses 3004 of the sheeting should be such that the focal point is at the surface of or within the radiation sensitive layer 3006. More detailed information regarding the methods of creating the composite images is provided above in sections I and II.

FIG. 38a illustrates one embodiment of laser engraving indicia into security article section 3000a. As mentioned above, FIG. 38b illustrates the formation of partially complete images 3005 using laser imaging into article section 3000b. A laser beam 3014 is focused by an optical lens, such that it passes through a focal point 3016 and produces a highly divergent laser light beam 3002 that impinges on the microlenses 3004 of article section 3000b. The lenses 3004 then re-focus the highly divergent laser light beam 3002 to produce hundreds or thousands of unique micro-images or partially complete images 3005 within article section 3000b at the focal length of the microlenses. The highly divergent laser light beam 3002 is moved across the surface of the article section 3000b typically using a galvanometer scanner, thus resulting in the delivery of light energy to different portions of article section 3000b, such that the micro-images or partially completed images 3005 that form the complete composite image are formed into the article. As discussed in Section I above, the partially complete images 3005 are created as a result of a compositional change, a removal or ablation of the material, a phase change, or a polymerization of the radiation sensitive layer 3006 adjacent to one side of the microlens layer 3004 or layers. As discussed in Section II above, the partially complete images 3005 may be formed using donor material. Alternatively, if a laser engraveable polycarbonate film is used as the imaging layer, black partially complete images can be formed by the laser charring the polycarbonate. If different levels of light energy are used within a laser-imaged composite image, different darkness levels may result, which may produce a gray-scale composite image. The laser-engraved composite image may include personalization data such as date of birth, address, or a digital picture of the bearer of the article, or article-specific data such as country of origin, issuing company, or currency denomination.

As mentioned above, when a security article, such as a polycarbonate identification card is laser personalized, the laser beam is moved around the card to record the desired information using a galvanometer scanner. These scanners are electromagnetic devices that move mirrors, mounted on the end of rotary shafts, to reflect the laser beam in the pattern required to write the desired text and portrait of the cardholder. For laser writing in an x, y-plane, two orthogonal rotatable mirrors are required. In order to maintain focus of the laser beam, a multi-element f-theta scan lens is used to focus the laser light. These lenses are typically designed to produce very slowly focused beams (numerical aperture ˜0.03) that result in a spot size at the laser absorbing layer in the card of approximately 60 microns (400 dpi).

In contrast to this optical configuration illustrated in FIG. 38a, when a floating image is laser imaged, a highly divergent writing laser beam is required to produce thousands of microimages recorded in the material 3006 behind the microlenses 3004, as shown in FIG. 38b. It is the projection of these microimages by the microlenses along the original exposure direction during viewing of the floating image that provides the depth cues used by the human visual system for ascribing three-dimensional extent to the composite image. As described above, one of these depth cues is motion parallax, which is the appearance of continuous change in the composite image as the viewing angle changes. This change with viewing angle is a result of different areas of the image plane behind each microlens being projected in different directions during the viewing process. These projection directions are determined by the direction from which the features in that part of the microimage plane were produced during the laser writing process. In general, the higher the divergence in the laser writing beam, the larger the range of directions used to record the information in the microimage plane, and the larger the amount of motion parallax in a floating image. As described above, laser beams with a numerical aperture of 0.3 result in floating images with a sufficient amount of motion parallax. A laser beam with a numerical aperture of this value used to write a floating image with a float height of 10 mm would have a “spot size” of approximately 7.3 mm at the microlens substrate, over 100× larger than the spot size used for laser personalization. The laser beam divergence for writing floating images is, therefore, quite different from that typically used for standard, two-dimensional laser personalization of identification documents, and, in fact, quite different from that used during most types of scanner-based laser marking. Initial methods for producing laser-written floating images, moved the laser focal point along its predetermined path relative to the microlens layer 3004 by translating the microlenses and the final high numerical aperture focusing lens using linear translation stages. Image writing time was proportional to the number of points in the desired image and the time required to physically move the laser beam focusing lens to all the points. With the use of high speed linear translation stages the focusing lens can be moved at a speed enabling image writing velocities of up to 100 mm/sec in the x, y, and z-directions. These speeds are, however, roughly an order of magnitude smaller than the 1-2 msec writing velocities characteristic of scanner-based laser personalization processes.

An alternative, higher speed method has been identified, however, for producing the relative movement between the microlens layer 3004 and the laser focal point required for writing a floating composite image. This method keeps the focusing optics and the microlens layer stationary and uses a standard low numerical aperture laser beam from a galvoscanner and a second lens array to produce the divergent laser beam required. The additional lens array consists of multiple small lenses (lens diameter typically 200-300 microns), all with the required high numerical aperture, i.e. ˜0.3, arranged in a planar geometry. When the array is illuminated by the very slowly focused laser beam from the galvoscanner, it produces multiple cones of highly divergent light, each individual cone being centered on its corresponding lens in the array. These individual cones of light from the lens array are then “relayed” to the microlens sheeting by a set of adaptive lenses to enable the production of floating pixels in the final image. When the light from the adaptive relay lenses is focused in front of the microlens layer, the pixels float, and when the light from the relay lenses is focused behind the microlens layer, the pixels sink. By virtue of the size of the array, the individual cones of light formed by the microlenses in the intermediate array will expose the microlens sheeting as if a single larger lens was positioned sequentially at all the points required to trace out the desired floating image. Therefore, floating/sinking pixels near the center of the composite image are written with the laser beam positioned near the center of the lens array, while floating/sinking pixels near the edge of the composite image require the laser beam to be positioned near the edge of the lens array. The selection of which lenses in the lens array receive the incident light is determined by the beam deflection of the standard galvometric scanner. With this imaging method it was shown that floating images could be written with scan velocities of greater than 1 msec, compatible with the scan velocities used for ID card personalization.

A challenge with the method described above is that to produce acceptably narrow line widths in the final floating image, the scanned laser beam at the intermediate lens array should be focused to a spot size of approximately the diameter of one microlens. This is desirable to produce a well defined image for the relay lenses to project at the desired float height relative to the microlens layer. As described above, at the numerical aperture values that result in desirable levels of three-dimensional content in floating composite images, the relayed image ultimately illuminates an area of tens of square millimeters at the microlens layer and therefore must contain sufficient laser energy to produce thousands of microimages. A result of this high energy requirement for the output of the intermediate lens array is that the incident power density at the lens array (10¹⁰-10¹¹ w/m²) is high enough that the lifetime of the intermediate lens array can be shortened due to the lenses becoming rough and scattering an increasing amount of light due to ablation and/or melting of the microlens material. Fortunately, this can be managed with the appropriate choice of microlens materials and process conditions by one skilled in the art.

### IV. Review of the Characteristics of a Composite Floating Image

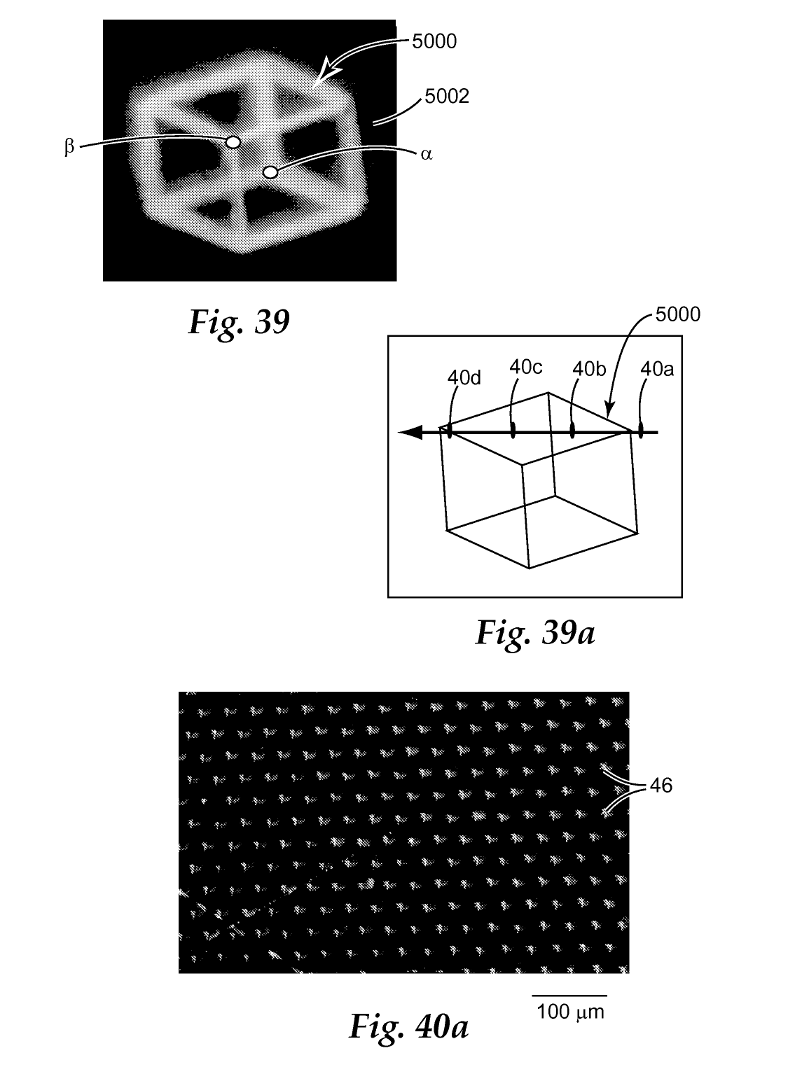

FIGS. 39, 39a, and 40a-40d are convenient for illustrating one exemplary example of a composite image 5000 and a microlens sheeting 5002 having such composite image. FIG. 39 is a photograph of a composite floating image 5000 that appears to an unaided eye to be in the shape of a three dimensional cube. FIG. 39a is convenient for showing the direction of the different views of the individual microlenses illustrated in FIG. 40a-40d, as the sheeting is moved horizontally under the view of a microscope. FIGS. 40a-40d are successive micrographs of the microlens sheeting taken by moving the floating cube image of FIG. 39 horizontally under the view of a microscope in the direction of the arrow illustrated in FIG. 39a.

Composite image 5000 of FIG. 39 was produced in microlens-containing sheeting 5002 using the imaging processes described above in sections I and III. For this particular image, the microlens sheeting 5002 contained 40 micron diameter planoconvex microlenses with a back focal length of 50 microns laid out in a close packed, hexagonal pattern. As illustrated in FIG. 39, the composite image 5000 consists of a wire frame cube. This cube is a well-known example of an ambiguous line drawing, which the human visual system will see in two different, yet consistent orientations. The laser imaging or writing process used to produce the composite cube image 5000 located the vertex of the composite image marked with dot a near the microlensed substrate 5002, while the vertex of the composite image marked with dot β was located approximately 16 mm in front of the lensed substrate, i.e. the dot a vertex is closer to the substrate, the dot β vertex is farther from the substrate.

FIGS. 40a-40d illustrate different portions of the microimage plane that produces the composite cube image 5000. As illustrated, the partially complete images 46 under the microlenses vary. This occurs because each microlens “sees” a different view of the laser focal point as it is moved along its path in front of or behind the lens array during the image writing process. This variation in the resulting microimages, recorded in the microlens substrate, results in different partially complete images 46. This also results in a floating composite image that exhibits very pronounced motion parallax. As an observer changes their vantage point relative to the microlens plane, they see microimages projected by different sets of microlenses. As a result, the observer sees an image whose appearance changes continuously as the observation position changes. For this cube image, it seems as if the viewer is able to actually look inside the cube as the vantage point is moved from right to left. Furthermore, this change in appearance is continuous with the change in viewing angle. Because the lens-containing substrate used for this image is comprised of spherical microlenses, this motion parallax also occurs when the viewer's vantage point is changed along the orthogonal direction.

As illustrated in FIG. 40a, the partially complete images 46 form the corner of the floating image of the cube located near 40a of FIG. 39a. As illustrated in FIG. 40b, the partially complete images 46 form the corner and upper right portion of the cube surface of the floating image of the cube located near 40b of FIG. 39a. As illustrated in FIG. 40c, the partially complete images 46 form the corner and upper left portion of the cube surface of the floating image of the cube located near 40c of FIG. 39a. As illustrated in FIG. 40d, the partially complete images 46 form the corner of the floating image of the cube located near 40d of FIG. 39a.

Lenticular imaging is a prior art method known by those skilled in the art. In sharp contrast to the composite images of the security article of the present invention produced with the laser imaging processes described herein, the lenticular images only exhibit motion parallax along one direction. In addition, the parallax is not continuous since lenticular images are typically constructed from a finite number of scenes. Moiré magnification imaging is also a prior art method known by those skilled in the art. However, this Moiré magnification uses a microlens array to image a microprint array where all the microprint features are identical. It relies on a stable pitch mismatch between the microlenses and the microprint elements. With this spatial arrangement, adjacent microlenses in the microlens array image adjacent portions of the microprint array. If the pitch of the microprint array is larger than the pitch of the microlens array the resulting composite image floats. If the pitch of the microprint array is smaller than the pitch of the microlens array the resulting composite image sinks. Since the images produced by Moiré magnification are constructed from identical microprint elements, unlike the microimage plane shown in FIGS. 40a-40d, the production of different float heights/sink depths requires a separate array of identical microprint elements for each float height desired, with each array interlaced with the other arrays. It would be very difficult using Moiré magnification to produce the floating cube composite image shown in FIG. 39. In addition, the use of the Moiré magnification phenomenon limits the spatial extent of the composite images because a lateral translation of a distance of a few hundred microlenses results in a complete cycle of the relative pitch mismatch between the microprint and microlens arrays and the start of a new floating or sinking feature. This limits the size of Moiré magnified images to approximately 5-10 mm, and results in a “wallpaper” appearance for large areas containing these images. In sharp contrast, the composite images of the security article of the present invention comprise a collection of partially complete images located such that when viewed through the microstructured surface, the collection of partial images forms the composite image.

### V. Overview of Security Articles of the Present Invention Having Both Personalized Indicia and Personalized Composite Floating Images and Benefits Thereof

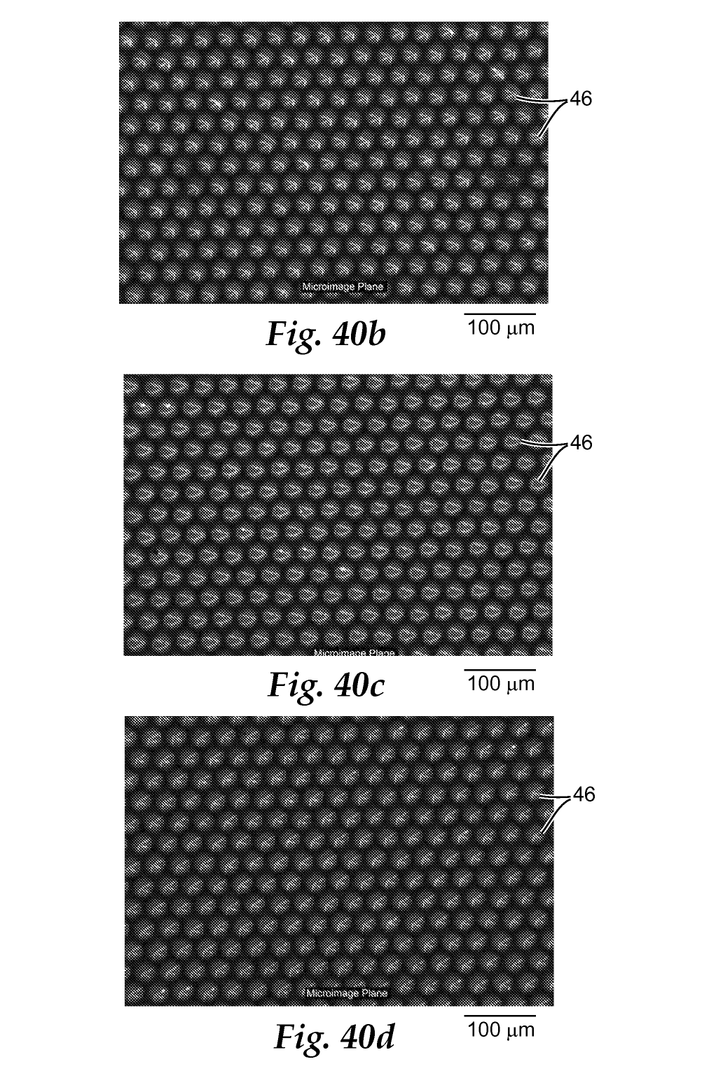

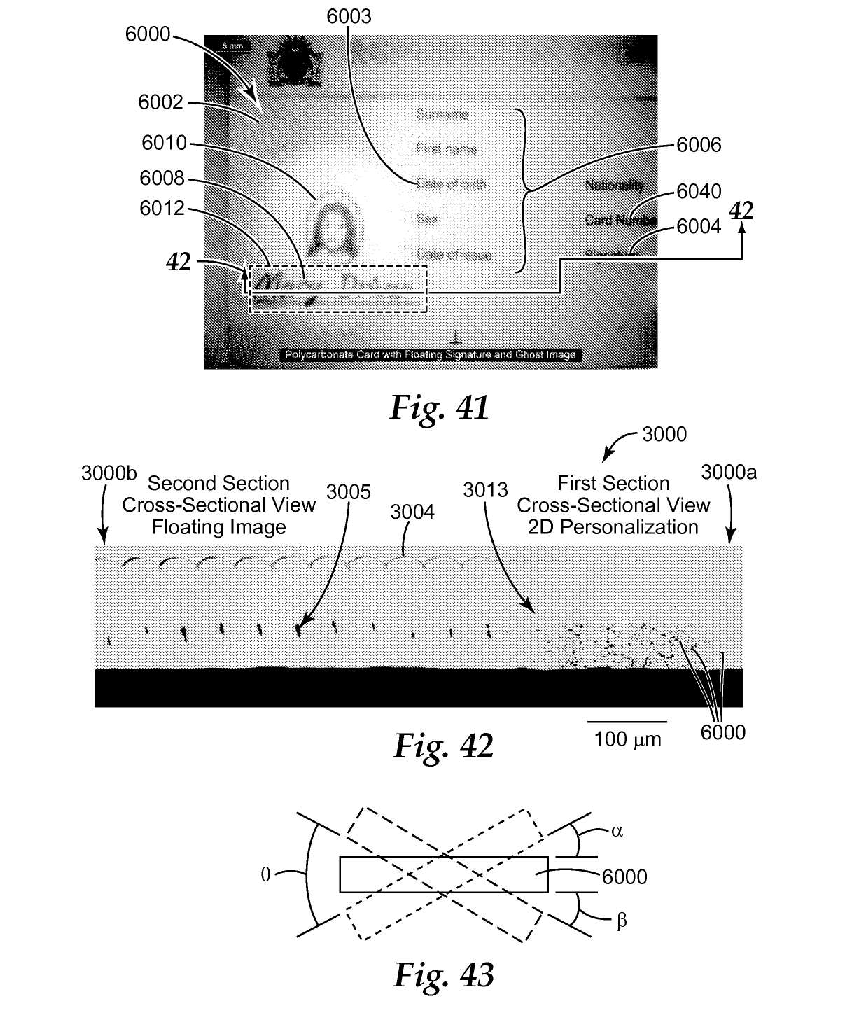

FIG. 41 illustrates a top view of one exemplary security article 6000 of the present invention. In this embodiment, the security article 6000 is an identification document, such as a driver's license. The security article 6000 includes a sheeting 6002. Sheeting 6002 includes at least one layer of microlenses, the layer having first and second sides and a layer of material disposed adjacent the first side of the layer of microlenses. For example, sheeting 6002 is similar to the sheetings 10, 20 and 30 of FIGS. 1, 2, and 3, respectively. The sheeting 6002 also includes a variety of indicia. Indicia 6003 may be printed on sheeting 6002 by methods known by those skilled in the art or laser engraved in the sheeting 6002. In the illustrated embodiment, indicia is laser engraved by the processes described above relative to FIGS. 37a and 38a. In the illustrated embodiment, indicia includes personalized information 6006 about the lawful owner of the security article 6000. For example, the personalized information includes the owner's surname, first name, date of birth, and sex. Personalized information could include the owner's signature 6004. Security article 6000 also includes a floating composite image 6008, in the form of Mary Driver's signature. Security article 6000 includes another floating composite image 6010, in the form of a picture of Mary Driver herself and a ring around the picture. In this embodiment, composite image 6008 appears to the unaided eye to float above the security article 6000, the picture portion of composite image 6010 appears to float above the security article 6010 and the circle portion of composite image 6010 appears to float below the security article 6010.

A representation of Mary Driver's actual signature may be laser engraved into the sheeting 6002, as described above relative to FIGS. 37a and 38a, and such represents an exemplary first indicia. Mary Driver's actual signature may then be laser imaged as composite image 6008, as described above relative to FIGS. 37b and 38b and sections I and II, and as such represents an exemplary first composite image. In one embodiment of the present invention, the first indicia and the first composite image are related to one other. In another embodiment, the first indicia and first composite image are similar to one another. In another embodiment, the first indicia and first composite image match one another. In any of these embodiments, the indicia and composite image may be personalized to include information that is personal to the lawful owner of the security article. For example, the first composite image may be a first personalized composite image, and the first indicia may be a personalized indicia. The security article may have a variety of personalized composite images and a variety of personalized indicias, as illustrated in FIG. 41.

In one embodiment, if the first indicia correlates with the first composite image, this is an indication that the security article is genuine. In another embodiment, if the first indicia is similar to the first composite image, this is an indication that the security article is genuine. In yet another embodiment, if the first indicia matches with the first composite image, this is an indication that the security article is genuine. As used herein, correlates, similar, and matching are different degrees of relative likeness.

In another embodiment, the security article may be authenticated by a customs official, for example, by comparing the first personalized indicia and the first personalized composite image. In another embodiment, the bearer of the security article may be verified by a customs official, for example, by comparing the first personalized indicia and the first personalized composite image. If the first personalized indicia and the first personalize image are related, correlated, are similar or match each other, then the security article is considered to be genuine and/or the bearer of the security article is verified. If the security article has multiple personalized composite images and multiple personalized indicia and such are related, correlate, are similar or match each other, they may be used to provide additional authentication of the security article and verification of the bearer of the security article.

FIG. 42 is a cross-sectional view of an article 3000 containing lenses 3004 on a surface and over a portion thereof, depicting the effect upon the radiation sensitive layer produced by laser imaging the article to form partial complete images 3005 and laser engraving indicia 3013 by forming charred areas 6000 in a laser engravable layer, such as a polycarbonate layer. As the partially complete image 3005 is imaged through the lenses 3004 of the second section 3000b, the partially complete image, when viewed through the lenses, may be floating or sinking or both floating and sinking. The laser engraved indicia 3013 of the first section 3000a has the same appearance to an observer as that of conventionally laser-engraved articles, as described in section III.

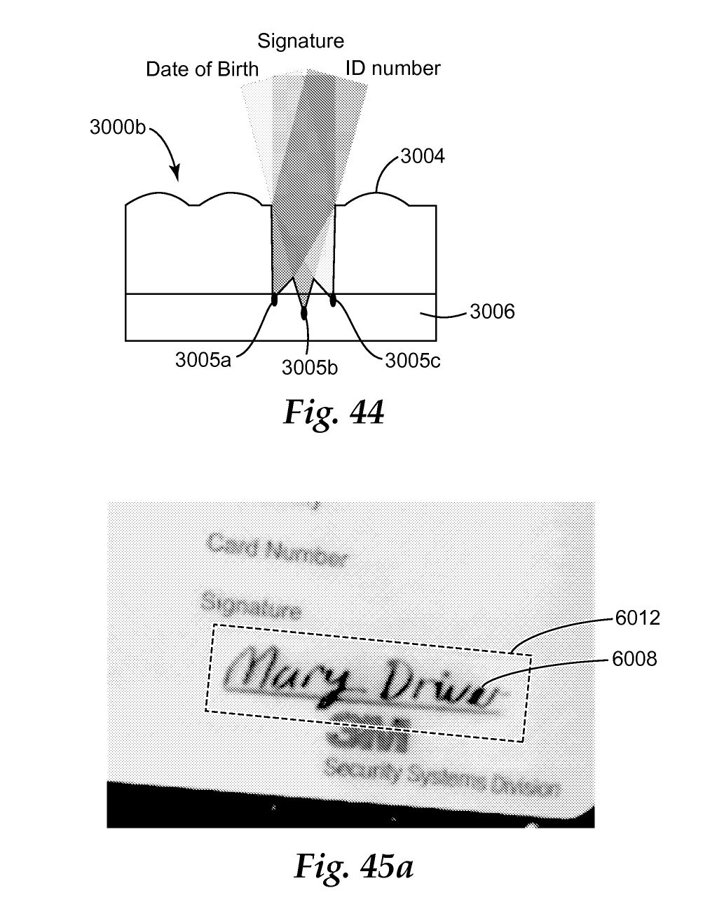

FIG. 43 is a side view illustrating that the security article may be tilted at different angles to view different composite images. For example, a first composite image may be viewable at angle α. A second composite image may be viewable at angle β. A third composite image may be viewable when the security article is horizontal. For example, as illustrated in FIG. 44 the first composite image may be the bearer's date of birth (DOB). The second composite image may be the bearer's address. The third composite image may be the bearer's signature. To a user of the security article 6000, the composite images “appear to be switching” to different composite images, as the security article 6000 is positioned at different angles. For instance, the security article 6000 may be rotated around any axis. For example, the security article may be rotated as about two different orthogonal axes, or may be rotated about an axis perpendicular to the plane of security article 6000 of FIG. 43, or may be rotated about an axis in the plane of security article 6000 of FIG. 43. Regardless of the rotation, to the user's unaided eye, the composite image switches to a different image, depending on the relative position of the security article.

FIG. 44 is useful for illustrating one exemplary embodiment of the “switching” aspect of the present invention. The security article 3000 includes three different laser imaged composite images, i.e. a date of birth (DOB), a signature and an identification number—each viewable at a different angle of observation—located in the same portion of article section 3000b. Under each microlens 3004, there are three partially complete images 3005, respectively, where when summed up together with other corresponding partially complete images under other microlenses form the composite images of DOB, signature, and address, respectively. FIG. 44 illustrates the location of the recorded image in the radiation sensitive layer 3006 of article section 3000b. The effective focal length of the lens sheeting 3004 is essentially the same for all three composite images. Thus, a composite image viewable essentially at an angle normal to the sheeting is imaged at a depth greater than the recorded depth of composite images at some viewing angle to either side of a viewing position normal to the sheeting.

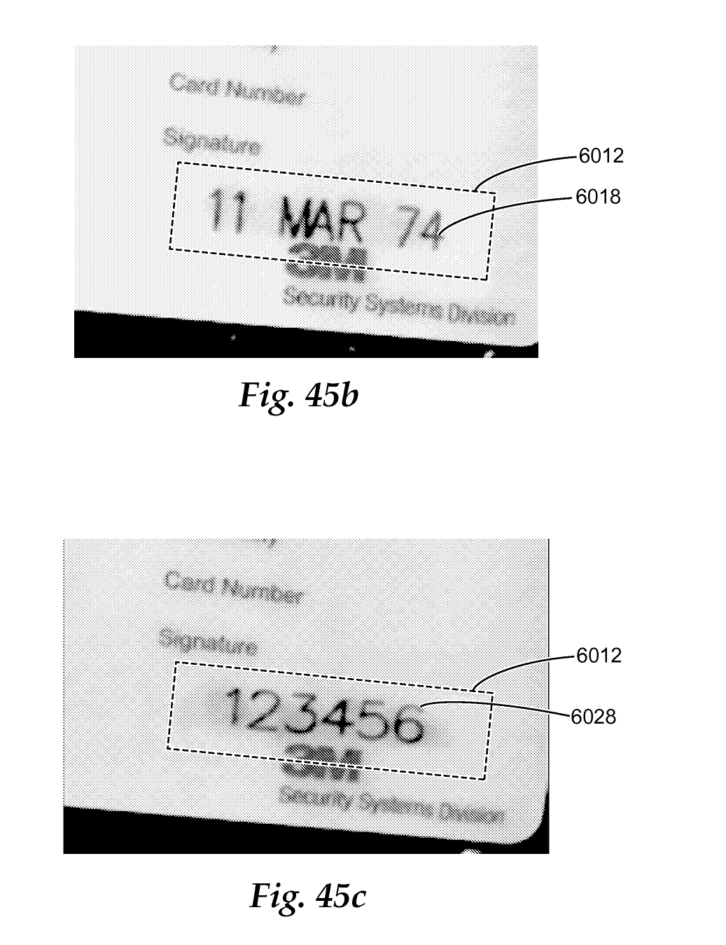

FIGS. 45a-45c illustrate another embodiment where the composite images appear to switch on and off in the same portion 6012 of the security article. The sheeting is illustrated as having a first portion 6012. The first composite image 6008 of Mary Driver's signature is viewable at a first angle at the first portion, as illustrated in FIG. 45a. The second composite 6018 of Mary Driver's date of birth is viewable at a second angle at the first portion, as illustrated in FIG. 45b. A third composite image 6028 of Mary Driver's driver's license's ID number is viewable at a third angle at the first portion 6012, as illustrated in FIG. 45c.

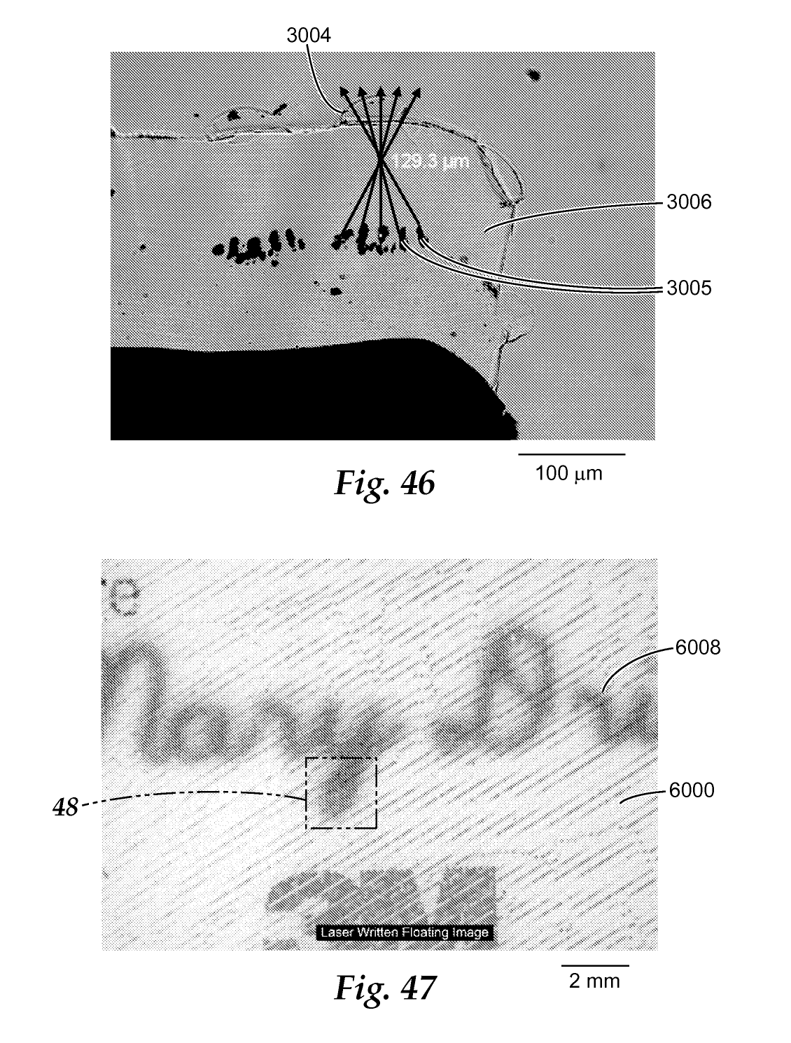

FIG. 46 is useful for illustrating how multiple composite images may be created in first portion 6012, and provides this “switching effect” described relative to FIGS. 45a-45c. Located below each microlens 3004, various partially complete images 3005 are imaged into the radiation sensitive layer 3006. Each partially complete image 3005 may contribute to a different personalized composite image, such as a signature, date of birth or ID number, as discussed relative to FIGS. 45a-c.

As discussed in above sections, there are enhanced benefits to having a security article of the present invention with the two primary features described herein, the laser imaged composite image and the laser engraved indicia, particularly where the two features are related to each other in the security article. Each feature provides its own independent barriers to counterfeiters, as discussed above in more detail, and having the combination of the two features in one security article creates a combination of barriers to counterfeiters. Moreover, as discussed above, a security article containing a personalized laser imaged composite image and a personalized laser engraved indicia provides an enhanced security article with complex security features, thus providing even more barriers to counterfeiters. Lastly, as the number of security features that can be incorporated in a security article are often limited by the size or surface area of the security article, this limitation is reduced by the security article of the present invention in that it provides multiple composite images viewable at the same relative location on the security article but at different relative angles.

### VI. Comparison of Composite Floating Images to Prior Art Feature Commonly Referred to as “MLI/CLI”

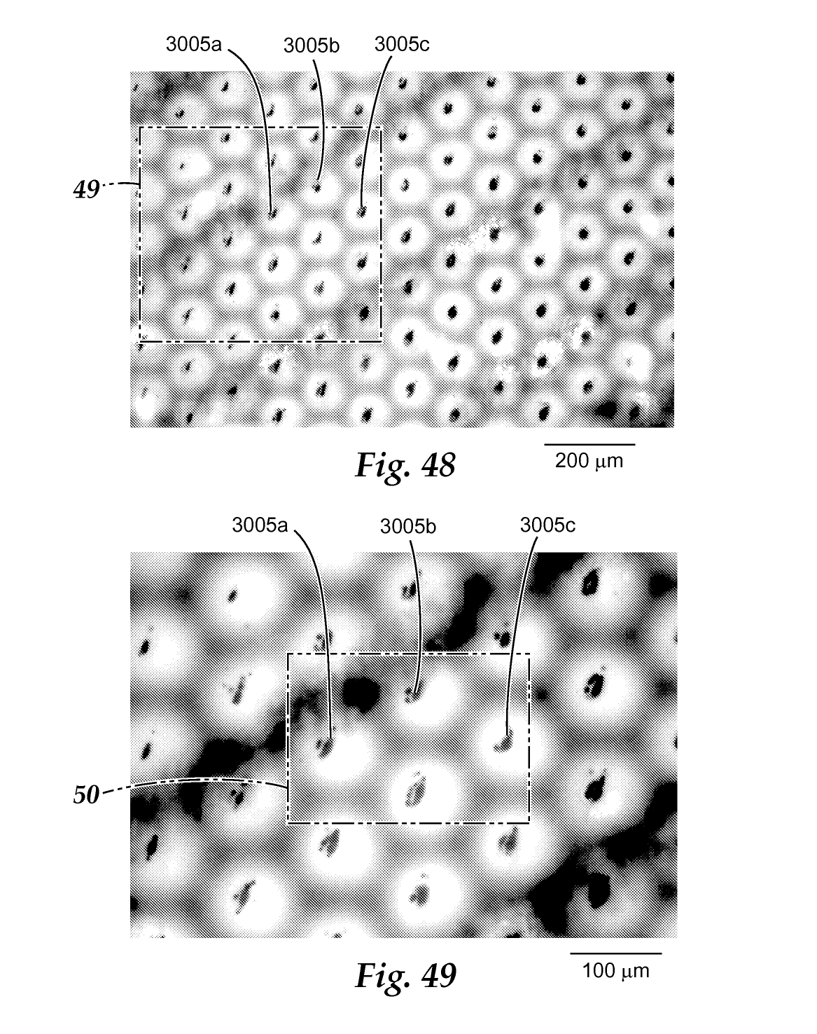

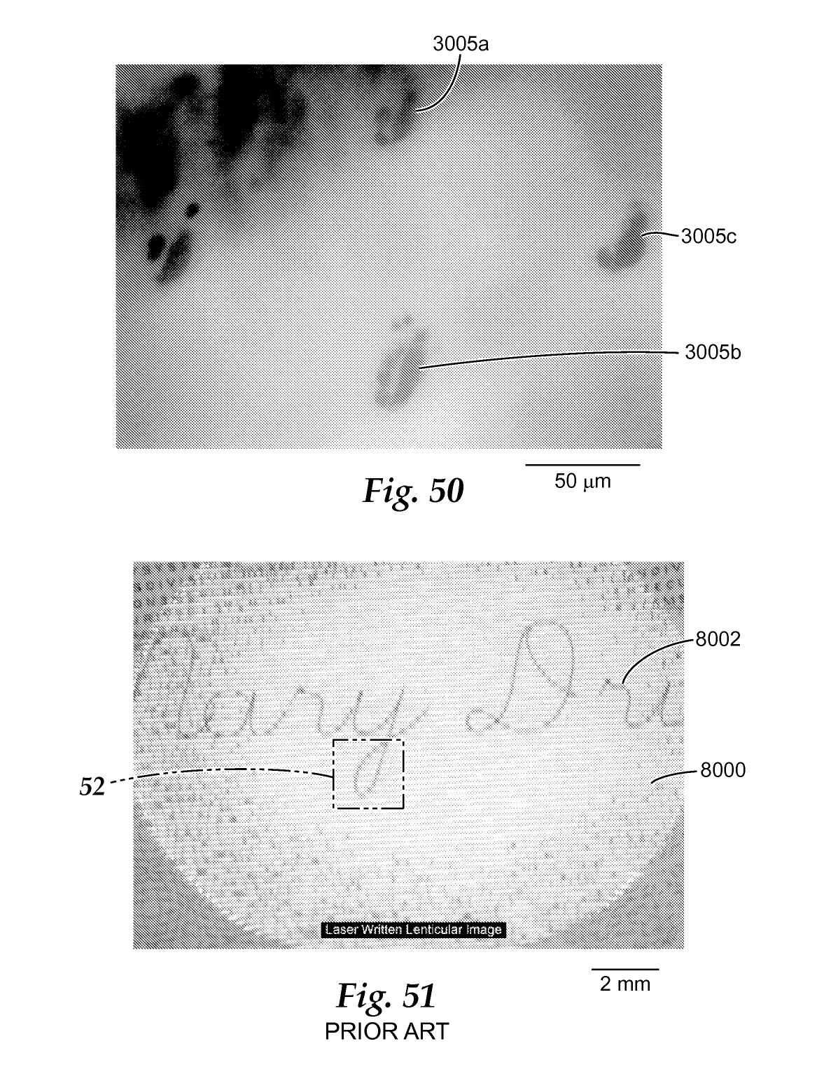

FIGS. 47-50 are useful for illustrating the use of partially complete images to create composite images. FIG. 47 illustrates a close up view of one composite image 6008 that is in the form of Mary Driver's signature on sheeting 6000, illustrated in FIG. 45a. FIG. 48 illustrates a magnified view of a portion of the sheeting, as illustrated on FIG. 47. FIG. 49 illustrates a more magnified view of the portion of the sheeting, as indicated on FIG. 48. FIG. 50 illustrates an even more magnified view of the portion of the sheeting, as indicated on FIG. 48. These figures are useful for showing that the bottom portion of the “loop” of the “y” in the composite image of Mary's signature is comprised of summing together multiple partial images 3005 to create a composite image. This aspect is discussed in more detail above relative to FIG. 5.

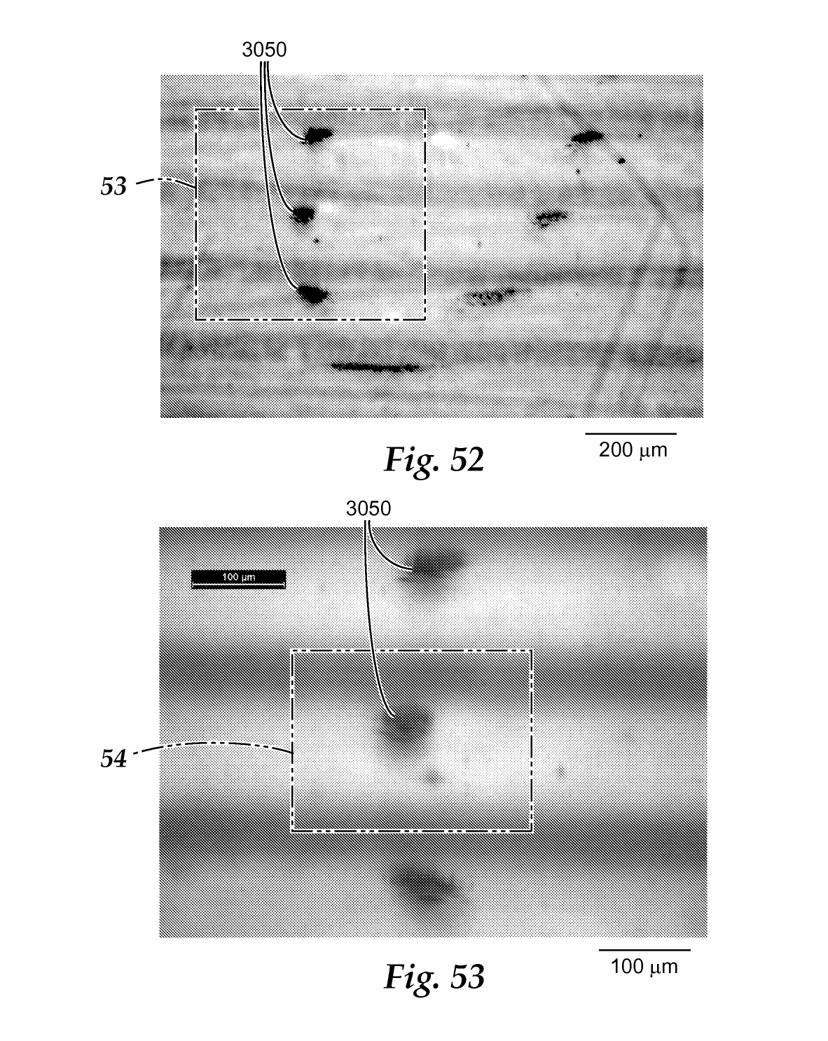

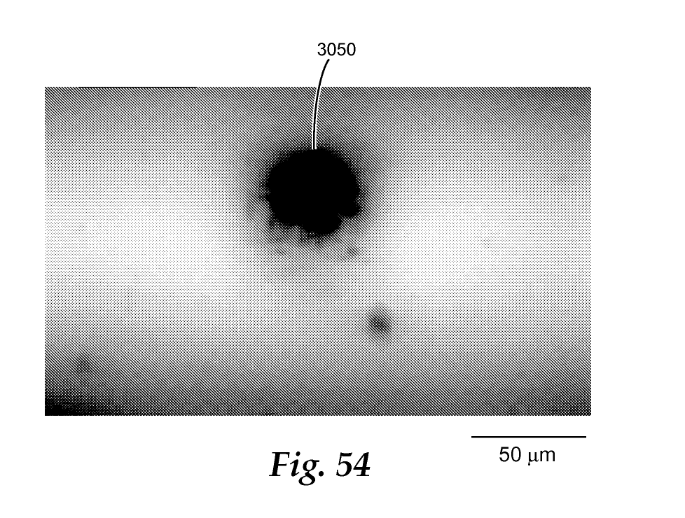

FIGS. 51-54 are useful for illustrating a security feature commonly known in the industry as “MLI/CLI” and for contrasting such with the partially complete images 3005 illustrated in FIGS. 47-50. MLI is a term commonly referred to in the prior art as a multiple laser image. CLI is a term commonly referred to in the prior art as changeable laser image. Examples of MLI and CLI are purportedly disclosed in European Patent No. 0216947 B1, European Patent No. 0219012 B1, and U.S. Pat. No. 4,765,656. FIG. 51 illustrates a close up view of one MLI/CLI image 8002 on sheeting 8000. FIG. 52 illustrates a magnified view of a portion of MLI/CLI sheeting, as illustrated on FIG. 51. FIG. 53 illustrates a more magnified view of the portion of the sheeting, as indicated on FIG. 52. FIG. 54 illustrates an even more magnified view of the portion of the sheeting, as indicated on FIG. 53. These figures are useful for showing the bottom portion of the “loop” of the “y” in Mary's signature, which is simply made up of an array of pixels of charred polycarbonate 3050 arranged in the pattern required to form the shape of the “y” in Mary's signature.

### Exemplary Embodiments

1. A personalized security article, comprising:
a sheeting comprising:
   at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material;
a first indicia;
a second indicia;
a first composite image, provided by at least one of the individual images, that appears to the unaided eye to float above, below, or in the sheeting, or any combination thereof; and
a second composite image, provided by at least one of the individual images, that appears to the unaided eye to float above, below, or in the sheeting, or any combination thereof;

wherein the first composite image is viewable at a first angle, and wherein the first composite image is related to the first printed indicia; and

wherein the second composite image is viewable at a second angle, and wherein the second composite image is related to the second printed indicia.

2. The personalized security article of Embodiment 1, wherein the sheeting includes a first portion, wherein the first composite image is viewable at the first angle at the first portion, and the second composite image is viewable at the second angle at the first portion.
3. The personalized security article of Embodiment 1, wherein the first composite image is a personalized composite image, and the first indicia is a personalized indicia.
4. The personalized security article of Embodiment 3, wherein the security article is authenticated by comparing the first personalized indicia and the first personalized composite image.
5. The personalized security article of Embodiment 3, wherein the bearer of the security article is verified by comparing the first personalized composite image to information about the bearer of the security article.
6. The personalized security article of Embodiment 4, wherein the second composite image is a personalized composite image, and the second indicia is a personalized indicia, wherein the security article is further authenticated by comparing the second personalized indicia and the second personalized composite image.
7. The personalized security article of Embodiment 5, wherein the second composite image is a personalized composite image, wherein the bearer of the security article is further verified by comparing the second personalized composite image and to information about the bearer of the security article.
8. The personalized security article of Embodiment 1, wherein if the first indicia correlates with the first composite image, the security article is genuine.
9. The personalized security article of Embodiment 8, wherein the first indicia is similar to the first composite image.
10. The personalized security article of Embodiment 9, wherein the first indicia matches the first composite image.
11. The personalized security article of Embodiment 1, wherein a user may authenticate the security article by matching the first indicia to the first composite image and matching the second indicia to the second composite image.
12. The personalized security article of Embodiment 1, wherein the personalized security article is an identification document.
13. The personalized security article of Embodiment 1, wherein the personalized security article is a value document.
14. The personalized security article of Embodiment 1, wherein the first printed indicia and first composite image include biographical data.
15. The personalized security article of Embodiment 1, wherein the first printed indicia and first composite image include biometric data.
16. The personalized security article of Embodiment 1, wherein the layer of material adjacent the first side of the partial layer of microlenses includes a first section and a second section, wherein the first indicia is laser engraved in the first section and the first composite image is laser imaged in the second section.
17. The personalized security article of Embodiment 1, wherein the microlenses comprise polycarbonate or acrylic, and wherein the layer of material comprises laser engraveable polycarbonate.
18. A laser-personalized security article,
a sheeting comprising:
   at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material;
a first personalized indicia;
a second personalized indicia;
a first personalized composite image, provided by at least one of the individual images, that appears to the unaided eye to float above, below, or in the sheeting, or any combination thereof; and
a second personalized composite image, provided by at least one of the individual images, that appears to the unaided eye to float above, below, or in the sheeting, or any combination thereof;

wherein the first personalized composite image is viewable at a first angle, and wherein the first personalized composite image matches the first personalized printed indicia;

wherein the second personalized composite image is viewable at a second angle, and wherein the second personalized composite image matches the second personalized printed indicia;

wherein the sheeting includes a first portion, wherein the first personalized composite image is viewable at the first angle at the first portion, and the second personalized composite image is viewable at the second angle at the first portion; and

wherein the layer of material adjacent the first side of the partial layer of microlenses includes a first section and a second section, wherein the first indicia is laser engraved in the first section and the first composite image is laser imaged in the second section.

19. A personalized security article, comprising:
a sheeting comprising:
   at least a partial array of microlenses and a material layer adjacent the partial array of microlenses; a first donor material in contact with the material layer, wherein the donor material forms individual, partially complete images on the material layer associated with each of a plurality of the microlenses,
a first printed indicia;
a second printed indicia;
a first composite image, provided by (at least one of) the individual images, that appears to the unaided eye to float above, below, or in the sheeting, or any combination thereof; and
a second composite image, provided by the individual images, that appears to the unaided eye to float above or below the sheeting, or both

wherein the first composite image is viewable at a first angle and is related to the first printed indicia; and

wherein the second composite image is viewable at a second angle and is related to the second printed indicia.

20. The personalized security article of Embodiment 19, wherein the sheeting includes a first portion, wherein the first composite image is viewable at the first angle at the first portion, and the second composite image is viewable at the second angle at the first portion.
21. The personalized security article of Embodiment 19, wherein the first composite image is a personalized composite image, and the first indicia is a personalized indicia.
22. The personalized security article of Embodiment 21, wherein the security article is authenticated by comparing the first personalized indicia and the first personalized composite image.
23. The personalized security article of Embodiment 21, wherein the bearer of the security article is verified by comparing the first personalized composite image to information about the bearer of the security article.
24. The personalized security article of Embodiment 22, wherein the second composite image is a personalized composite image, and the second indicia is a personalized indicia, wherein the security article is further authenticated by comparing the second personalized indicia and the second personalized composite image.
25. The personalized security article of Embodiment 23, wherein the second composite image is a personalized composite image, wherein the bearer of the security article is further verified by comparing the second personalized indicia and to information about the bearer of the security article.
26. The personalized security article of Embodiment 19, wherein if the first indicia correlates with the first composite image, the security article is genuine.
27. The personalized security article of Embodiment 26, wherein the first indicia is similar to the first composite image.
28. The personalized security article of Embodiment 27, wherein the first indicia is matches the first composite image.
29. The personalized security article of Embodiment 19, wherein a user may authenticate the security article by matching the first indicia to the first composite image and matching the second indicia to the second composite image.
30. The personalized security article of Embodiment 19, wherein the personalized security article is an identification document.
31. The personalized security article of Embodiment 1, wherein the personalized security article is a value document.
32. The personalized security article of Embodiment 19, wherein the first printed indicia and first composite image include biographical data.
33. The personalized security article of Embodiment 19, wherein the first printed indicia and first composite image include biometric data.
34. The personalized security article of Embodiment 19, wherein the layer of material adjacent the first side of the partial array of microlenses includes a first section and a second section, wherein the first indicia is laser engraved in the first section and the first composite image is laser imaged in the second section.
35. The personalized security article of Embodiment 19, wherein the microlenses comprise polycarbonate or acrylic, and wherein the layer of material comprises laser engraveable polycarbonate.
36. A laser-personalized security article, comprising:
a sheeting comprising:
   at least a partial array of microlenses and a material layer adjacent the partial array of microlenses; a first donor material in contact with the material layer, wherein the donor material forms individual, partially complete images on the material layer associated with each of a plurality of the microlenses,
a first printed indicia;
a second printed indicia;
a first composite image, provided by (at least one of) the individual images, that appears to the unaided eye to float above, below, or in the sheeting, or any combination thereof; and
a second composite image, provided by the individual images, that appears to the unaided eye to float above or below the sheeting, or both,

wherein the first personalized composite image is viewable at a first angle, and wherein the first personalized composite image matches the first personalized printed indicia;

wherein the second personalized composite image is viewable at a second angle, and wherein the second personalized composite image matches the second personalized printed indicia;

wherein the sheeting includes a first portion, wherein the first personalized composite image is viewable at the first angle at the first portion, and the second personalized composite image is viewable at the second angle at the first portion; and

wherein the layer of material adjacent the partial array of microlenses includes a first section and a second section, wherein the first indicia is laser engraved in the first section and the first composite image is laser imaged in the second section.

37. A method of authenticating a laser-personalized security article, comprising the steps of:
providing a personalized security article, comprising:
   a sheeting comprising:
      at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material;
   a first indicia;
   a second indicia;
   a first composite image, provided by at least one of the individual images, that appears to the unaided eye to float above, below, or in the sheeting, or any combination thereof; and
   a second composite image, provided by at least one of the individual images, that appears to the unaided eye to float above, below, or in the sheeting, or any combination thereof;
   wherein the first composite image is viewable at a first angle, and wherein the first composite image is related to the first printed indicia; and
   wherein the second composite image is viewable at a second angle, and wherein the second composite image is related to the second printed indicia; viewing the security article at the first angle and observing the first composite image;
observing the first indicia;
comparing the first composite image to the first indicia; and
if the first composite image matches the first indicia, authenticating the security article.
   38. A method of laser personalizing a security article, comprising:
providing a security article, comprising:
   a sheeting comprising:
      at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material, and wherein the layer of material adjacent the first side of the partial layer of microlenses includes a first section and a second section;
laser engraving a first personalized indicia in the first section of the material layer; and laser imaging a first personalized composite image in the second section of the material layer.
   39. A laser-engraving module for personalizing composite images may be used to create the sheeting illustrated in FIGS. 41-50.

The operation of the present invention will be further described with regard to the following detailed examples. These examples are offered to further illustrate the various specific and preferred embodiments and techniques. It should be understood, however, that many variations and modifications may be made while remaining within the scope of the present invention.

### Example 1

### Article Exemplifying the Invention

A laser engravable polycarbonate construction was made by laminating the following sheets of 3M™ Polycarbonate Security Film (available from 3M Co., St. Paul, Minn.) with a Carver Press at 163 degrees Celsius and 120 N/cm² for 30 minutes followed by 15 minutes of ramped cooling from 163 degrees Celsius to room temperature: 100 micron clear film/100 micron laser engravable film/150 micron white film/50 micron clear film/150 micron white film/100 micron laser engravable film/100 micron clear film. One of the 152 mm×152 mm polished metal plates (the plates were 152 by 152 mm) used in the Carver Press to apply force to the sheeting stack contained a microstructure consisting of depressions, positioned as a close-packed arrangement of hexagons, each hexagon having a diagonal dimension of 160 microns, and a spherical profile characterized by a radius of curvature of 64 microns and a conic constant of −0.868. During lamination, this microstructure formed microlenses on the laminate with a back focal length of approximately 150 microns. The resultant laminated construction was mounted to a variable angle rotational stage and then the microlens-containing area of the laminated construction was exposed to the output of an SPI fiber laser, expanded by a Lynos and Edmund Optics beam expander to a diameter of 25 mm. The expanded beam was input into a galvoscanner, which with the use of appropriate optics produced a focused beam having a numerical aperture of approximately 0.15. The focal point of the laser beam was located at approximately 8 mm above the surface of the laminate. Different composite images that appear to float above the microlens-containing portion of the laminate were written into the laminate via the laser beam, i.e. images were generated in the laminate as the laser charred the laser-sensitive laser engravable layer at different angles of incidence relative to the laminate normal, separated by 10°. The composite images formed into the microstructured portion of the laminate were viewable over a viewing angle range of approximately 20°, the angle determined by the numerical aperture of the beam delivered by the focusing optics. The different composite images in viewing were separated from each other due to the different angle of incidence used to write the different images. That is, as the laminate structure was rotated about the axis used to write the images into the laminate, the image viewed switched from one image to another.

### Example 2

### Security Documents Exemplifying the Invention

A laser engravable polycarbonate security sheeting was made by laminating sheets of 3M™ Polycarbonate Security Film (available from 3M Co., St. Paul, Minn.) with a Buerkle CHKR 50/100 lamination system using the following conditions:
Heating Cycle: 180° C. for 20 minutes at 250 N/cm²
Cooling Cycle: 18° C. for 19 minutes at 300 N/cm²

The 520 mm×300 mm laminated security sheeting included 100 micron clear film with twenty-four (24) OVD Kinegram generic holograms on the underside/100 micron laser engravable film offset printed with UV-visible Luminescence PC-specific inks using a Heidelberg Speedmaster on the top side/150 micron white film offset printed with visible Luminescence PC-specific inks using a Heidelberg Speedmaster in a rainbow Guilloche pattern on the top side/50 micron clear film/150 micron white film offset printed with visible Luminescence PC-specific inks using a Heidelberg Speedmaster in a rainbow Guilloche pattern on the underside/100 micron laser engravable film/100 micron clear film. The printing formed twenty-four (24) discrete card-shaped printed images in a 3×8 pattern with one Kinegram registered to each card-shaped printed image. One of the 520 mm×300 mm polished metal plates used in the Buerkle press to apply force to the sheeting stack contained 24 17.6 mm by 13.6 mm oval-shaped microstructure patches and twenty-four (24) 10 mm by 30 mm rectangular-shaped microstructure patches. The patches were registered such that each oval and rectangular set of microstructures was aligned to each card-shaped printed image. Each microstructure consisted of depressions, positioned as a close-packed arrangement of hexagons, each hexagon have a diagonal dimension of 160 microns, and a spherical profile characterized by a radius of curvature of 64 microns and a conic constant of −0.868. During lamination, this microstructure formed twenty-four (24) 17.6 mm by 13.6 mm oval-shaped patches of microlenses and twenty-four (24) 10 mm by 30 mm rectangular-shaped patches of microlenses in locations registered to the twenty-four (24) card-shaped printed structures with a back focal length of approximately 150 microns. The security sheeting was die-punched using a Muhlbauer CP 200/M card punching system to form cards, each with one oval-shaped patch of microlenses and one rectangular-shaped patch of microlenses. Several cards were then personalized using a Bowe Alpha² laser personalization system in regions of the card without lenses. The personalization data consisted of a digital gray-scale photo and text including name, ID card number, nationality, sex, date of issue and birth date. Cards were mounted to a variable angle rotational stage and then the microlens-containing ovals and rectangles were exposed to the same laser system as Example 1. Different composite images that appear to float above the microlens-containing portion of the security card were written into the card via the laser beam through the oval- or rectangle-shaped patches of microstructures, i.e. images were generated in the card as the laser charred the laser-sensitive laser engravable layer. A smaller, lower-resolution gray-scale digital composite image of the bearer was laser-engraved into the oval patch. Several composite images were laser-engraved into the rectangular patch at different angles of incidence relative to the laminate normal, each separated by 10°. The composite images formed under the rectangular patch of microstructures consisted of a signature of the same name used in conventional personalization (normal angle), the birth year (10° from normal with the card tilted in one direction), and the ID number (10° from normal with the card tilted in the other direction). These composite images were viewable over a viewing angle range of approximately 20°, the angle determined by the numerical aperture of the beam delivered by the focusing optics. The different composite images in viewing were separated from each other due to the different angle of incidence used to write the different images. That is, as the card was rotated about the axis used to write the images into the card, the image viewed switched from one image to another.

The tests and test results described above are intended solely to be illustrative, rather than predictive, and variations in the testing procedure can be expected to yield different results.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A personalized security article, comprising:
a sheeting comprising:
at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material;
a first indicia;
a second indicia;
a first composite image, provided by at least one of the individual images, that appears to the unaided eye to float above, below, or in the sheeting, or any combination thereof; and
a second composite image, provided by at least one of the individual images, that appears to the unaided eye to float above, below, or in the sheeting, or any combination thereof;
wherein the first composite image is viewable at a first angle, and wherein the first composite image is related to the first printed indicia; and
wherein the second composite image is viewable at a second angle, and wherein the second composite image is related to the second printed indicia.

2. The personalized security article of claim 1, wherein the sheeting includes a first portion, wherein the first composite image is viewable at the first angle at the first portion, and the second composite image is viewable at the second angle at the first portion.

3. The personalized security article of claim 1, wherein the first composite image is a personalized composite image, and the first indicia is a personalized indicia.

4. The personalized security article of claim 3, wherein the security article is authenticated by comparing the first personalized indicia and the first personalized composite image.

5. The personalized security article of claim 3, wherein the bearer of the security article is verified by comparing the first personalized composite image to information about the bearer of the security article.

6. The personalized security article of claim 4, wherein the second composite image is a personalized composite image, and the second indicia is a personalized indicia, wherein the security article is further authenticated by comparing the second personalized indicia and the second personalized composite image.

7. The personalized security article of claim 5, wherein the second composite image is a personalized composite image, wherein the bearer of the security article is further verified by comparing the second personalized composite image and to information about the bearer of the security article.

8. The personalized security article of claim 1, wherein if the first indicia correlates with the first composite image, the security article is genuine.

9. The personalized security article of claim 8, wherein if the first indicia is similar to the first composite image, the security article is genuine.

10. The personalized security article of claim 9, wherein if the first indicia matches the first composite image, the security article is genuine.

11. The personalized security article of claim 1, wherein a user may authenticate the security article by matching the first indicia to the first composite image and matching the second indicia to the second composite image.

12. The personalized security article of claim 1, wherein the personalized security article is an identification document.

13. The personalized security article of claim 1, wherein the personalized security article is a value document.

14. The personalized security article of claim 1, wherein the first printed indicia and first composite image include biographical data.

15. The personalized security article of claim 1, wherein the first printed indicia and first composite image include biometric data.

16. The personalized security article of claim 1, wherein the layer of material adjacent the first side of the partial layer of microlenses includes a first section and a second section, wherein the first indicia is laser engraved in the first section and the first composite image is laser imaged in the second section.

17. The personalized security article of claim 1, wherein the microlenses comprise polycarbonate or acrylic, and wherein the layer of material comprises laser engraveable polycarbonate.

18. The personalized security of claim 1, wherein the sheeting comprises as a single layer the layer of material and the layer of microlenses.

19. The personalized security article of claim 1, wherein the sheeting includes a window, and wherein at least one of the first or second composite images is viewable within the window.

20. A laser-personalized security article,
a sheeting comprising:
at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material;
a first personalized indicia;
a second personalized indicia;
a first personalized composite image, provided by at least one of the individual images, that appears to the unaided eye to float above, below, or in the sheeting, or any combination thereof; and
a second personalized composite image, provided by at least one of the individual images, that appears to the unaided eye to float above, below, or in the sheeting, or any combination thereof;
wherein the first personalized composite image is viewable at a first angle, and wherein the first personalized composite image matches the first personalized printed indicia;
wherein the second personalized composite image is viewable at a second angle, and wherein the second personalized composite image matches the second personalized printed indicia;
wherein the sheeting includes a first portion, wherein the first personalized composite image is viewable at the first angle at the first portion, and the second personalized composite image is viewable at the second angle at the first portion; and
wherein the layer of material adjacent the first side of the partial layer of microlenses includes a first section and a second section, wherein the first indicia is laser engraved in the first section and the first composite image is laser imaged in the second section.

21. A personalized security article, comprising:
a sheeting comprising:
a plurality of microlenses and a material layer adjacent the plurality of microlenses; a first donor material in contact with the material layer, wherein the donor material forms individual, partially complete images on the material layer associated with each of a plurality of the microlenses,
a first printed indicia;
a second printed indicia;
a first composite image, provided by at least one of the individual images, that appears to the unaided eye to float above, below, or in the sheeting, or any combination thereof; and
a second composite image, provided by the individual images, that appears to the unaided eye to float above or below the sheeting, or both
wherein the first composite image is viewable at a first angle and is related to the first printed indicia; and
wherein the second composite image is viewable at a second angle and is related to the second printed indicia.

22. The personalized security article of claim 21, wherein the sheeting includes a first portion, wherein the first composite image is viewable at the first angle at the first portion, and the second composite image is viewable at the second angle at the first portion.

23. The personalized security article of claim 21, wherein the first composite image is a personalized composite image, and the first indicia is a personalized indicia.

24. The personalized security article of claim 23, wherein the security article is authenticated by comparing the first personalized indicia and the first personalized composite image.

25. The personalized security article of claim 23, wherein the bearer of the security article is verified by comparing the first personalized composite image to information about the bearer of the security article.

26. The personalized security article of claim 24, wherein the second composite image is a personalized composite image, and the second indicia is a personalized indicia, wherein the security article is further authenticated by comparing the second personalized indicia and the second personalized composite image.

27. The personalized security article of claim 25, wherein the second composite image is a personalized composite image, wherein the bearer of the security article is further verified by comparing the second personalized indicia and to information about the bearer of the security article.

28. The personalized security article of claim 21, wherein if the first indicia correlates with the first composite image, the security article is genuine.

29. The personalized security article of claim 28, wherein if the first indicia is similar to the first composite image, the security article is genuine.

30. The personalized security article of claim 29, wherein if the first indicia is matches the first composite image, the security article is genuine.

31. The personalized security article of claim 21, wherein a user may authenticate the security article by matching the first indicia to the first composite image and matching the second indicia to the second composite image.

32. The personalized security article of claim 21, wherein the personalized security article is an identification document.

33. The personalized security article of claim 1, wherein the personalized security article is a value document.

34. The personalized security article of claim 21, wherein the first printed indicia and first composite image include biographical data.

35. The personalized security article of claim 21, wherein the first printed indicia and first composite image include biometric data.

36. The personalized security article of claim 21, wherein the layer of material adjacent the first side of the plurality of microlenses includes a first section and a second section, wherein the first indicia is laser engraved in the first section and the first composite image is laser imaged in the second section.

37. The personalized security article of claim 21, wherein the microlenses comprise polycarbonate or acrylic, and wherein the layer of material comprises laser engraveable polycarbonate.

38. The personalized security article of claim 21, wherein the personalized security article of claim 1, comprises as a single layer the layer of material and the layer of microlenses.

39. The personalized security article of claim 21, wherein the personalized security article of claim 1 includes a window, and wherein at least one of the first or second composite images is viewable within the window.

40. A laser-personalized security article, comprising:
a sheeting comprising:
a plurality of microlenses and a material layer adjacent the plurality of microlenses; a first donor material in contact with the material layer, wherein the donor material forms individual, partially complete images on the material layer associated with each of a plurality of the microlenses,
a first printed indicia;
a second printed indicia;
a first composite image, provided by (at least one of) the individual images, that appears to the unaided eye to float above, below, or in the sheeting, or any combination thereof; and
a second composite image, provided by the individual images, that appears to the unaided eye to float above or below the sheeting, or both,
wherein the first personalized composite image is viewable at a first angle, and wherein the first personalized composite image matches the first personalized printed indicia;
wherein the second personalized composite image is viewable at a second angle, and wherein the second personalized composite image matches the second personalized printed indicia;
wherein the sheeting includes a first portion, wherein the first personalized composite image is viewable at the first angle at the first portion, and the second personalized composite image is viewable at the second angle at the first portion; and
wherein the layer of material adjacent the plurality of microlenses includes a first section and a second section, wherein the first indicia is laser engraved in the first section and the first composite image is laser imaged in the second section.

41. A method of authenticating a personalized security article, comprising the steps of:
providing a personalized security article, comprising:
a sheeting comprising:
at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material;
a first indicia;
a second indicia;
a first composite image, provided by at least one of the individual images, that appears to the unaided eye to float above, below, or in the sheeting, or any combination thereof; and
a second composite image, provided by at least one of the individual images, that appears to the unaided eye to float above, below, or in the sheeting, or any combination thereof;
wherein the first composite image is viewable at a first angle, and wherein the first composite image is related to the first printed indicia; and
wherein the second composite image is viewable at a second angle, and wherein the second composite image is related to the second printed indicia;
viewing the security article at the first angle and observing the first composite image;
observing the first indicia;
comparing the first composite image to the first indicia; and
if the first composite image matches the first indicia, authenticating the security article.

42. A method of laser personalizing a security article, comprising:
providing a security article, comprising:
a sheeting comprising:
at least a partial layer of microlenses, the layer having first and second sides and a layer of material disposed adjacent the first side of the partial layer of microlenses; an at least partially complete image formed in the material associated with each of a plurality of the microlenses, wherein the image contrasts with the material, and wherein the layer of material adjacent the first side of the partial layer of microlenses includes a first section and a second section;
laser engraving a first personalized indicia in the first section of the material layer; and
laser imaging a first personalized composite image in the second section of the material layer.
